(19) United States
(12) Patent Application Publication
(10) Pub. No.: US 2015/0310687 A1
(43) Pub. Date: Oct. 29, 2015

(54) Synchronous and Asynchronous Electronic Voting Terminal System and Network

(71) Applicant: CrowdzSpeak Inc., Potsdam, NY (US)

(72) Inventors: Michael A. Morgia, Watertown, NY (US); John P. Gaus, Watertown, NY (US)

(21) Appl. No.: 14/736,955

(22) Filed: Jun. 11, 2015

Related U.S. Application Data
(63) Continuation-in-part of application No. 14/097,662, filed on Dec. 5, 2013.
(60) Provisional application No. 61/734,038, filed on Dec. 6, 2012.

(51) Int. Cl. G07C 13/00; H04L 29/08

(52) U.S. Cl. CPC G07C 13/00; H04L 67/10

(57) ABSTRACT

Among other things, participants who belong to a group/crowd or group of participants can provide indications of relative values of ideas that belong to a body of ideas. A rank ordering according to the relative values of at least some of the ideas of the body is derived based on the indications provided by the participants. The participants can provide the indications in two or more rounds. Each of at least some of the participants provide the indications with respect to fewer than all of the ideas in the body in each of the rounds. Between each of at least one pair of successive rounds, the set of ideas is updated to reduce the role of some of the ideas in the next round. Voting can by synchronous, i.e. more or less simultaneously, or asynchronous, i.e. where voting occurs as groups of voters are reaching a critical mass (min number) to allow distribution of ideas groups.

This application is entitled to the benefit of the filing date of U.S. patent application 61/734,038, filed Dec. 6, 2012; and relates to U.S. patent application Ser. No. 11/934,990, filed Nov. 5, 2007; 60/866,099, filed Nov. 16, 2006; 60/981,234, filed Oct. 19, 2007; and Ser. No. 12/473,598, filed May 28, 2009, US publication no. 20090239205 and U.S. Pat. No. 8,494,436, all of the above being entirely incorporated into this application by reference.

### BACKGROUND

This description relates to machines are specially constructed to handle massive voter input and produce, in real time, a consensus of opinion group/crowd except in simple cases, for example, a group or crowd on one side of the stadium at The Game cheering for Harvard or an unruly mob yelling for the King's head, group/crowd consensus typically is developed by repeated one on one or small group interactions and is achieved over a long time period, such as in a development group working out which ideas for a new product are the best ones.

Even in a New England town meeting format, where any voter can attend a meeting and have issues discussed and voted upon, in practice, it does not work. The most vocal have their opinions heard and there is never enough time or patience to cull through even a dozen ideas.

Now imagine having a national town meeting where all voters would be allowed to submit ideas and have them receive fair, biased consideration by all voters. Fair and unbiased means that the order in which the ideas are considered does not matters (i.e. early reviewed ideas are not promoted over others, and that all ideas are seen by at least some voters, i.e. none are excluded immediately). Building a machine which could solve this conundrum would make it possible for any voter to input a narrative idea (i.e. an idea which is more than a few words) and have it evaluated by the group in a way that the group would identify the most favored ideas, which could then be adopted by the citizenry. In addition, all of this would preferably happen in real time, i.e. while the voter was standing at the voting machine, so that the outcome could be known quickly, and without the voter having to return to the terminal another day for further rounds of voting.

Such a capability could revolutionize the democratic process and could further be applied to many other endeavors where large numbers of non uniform (narrative) input needs to be considered and equitably and rapidly considered by large groups of people. In addition to public elections, shareholder's meetings might be held on line, but with millions of shareholders it may not be possible to entertain all ballot initiatives of all users. Thus a means is needed to fairly and quickly cull through all ballot initiatives to see which are favored by the most number of users. Then only those, fewer, proposals need be considered by the stockholders. All of this could be accomplished in real time so that such meetings would not have to reconvene at a later time.

### SUMMARY

In general, in an aspect, participants who belong to a group/crowd of participants, such as voters in an election, can provide indications of relative values of ideas that belong to a body of ideas. A rank ordering according to the relative values of at least some of the ideas of the body is derived based on the indications provided by the participants. The participants can provide the indications in two or more rounds. Each of at least some of the participants provide the indications with respect to fewer than all of the ideas in the body in each of the rounds. Between each of at least one pair of successive rounds, the body of ideas is updated to reduce the role of some of the ideas in the next round. The machine which received their votes and allows user input must be specially designed to accommodate security requirements commensurate with the need. For example for elections of public officials and referenda, the security needs are quite high and the terminal will preferably be made to specifications approximating those for an ATM (automated teller machine) with physical access control to prevent modification of the circuity and electronic data transfer encryption to prevent modification of the data stream. For elections of boards of directors, or shareholder's meetings where issues can be put to company management, the security requirements may be lower, such as only data encryption because the voters have home terminals not subject to tampering.

Implementations may include one or more of the following features. The indications provided by the participants include explicit ordering of the ideas based on their relative values. The indications provided by the participants include making choices among the ideas. The indications provided by the participants include observations about the ideas. The participants include people. The participants include groups of people. The participants include entities. The values relate to the merits of the ideas. The values relate to the attractiveness of the ideas. The values relate to the costs of the ideas. The values relate to financial features of the ideas. The values relate to sensory qualities of the ideas. The values relate to viability of the ideas. The ideas include concepts. The ideas include online posts. The ideas include images. The ideas include audio items. The ideas include text items. The ideas include video items.

The body of ideas is provided by a party who is not one of the participants. At least some ideas in the body are provided by the participants. At least some ideas in the body are added between each of at least one pair of successive rounds. At least some of the ideas in the body are organized hierarchically. At least some of the ideas in the body include subsets of the body of ideas. At least some of the ideas in the body include comments on other ideas in the set. At least some of the ideas in the body include edited versions of other ideas in the set.

The rank ordering includes an exact ordering of all of the ideas in the body. The rank ordering includes an exact ordering of fewer than all of the ideas in the body. The rank ordering is determined by a computational analysis of the indications of the participants. The rank ordering is partially determined after each of the rounds until a final rank ordering is determined. Before each of the rounds, a set of one or more ideas from the body of ideas are selected to be provided to each of the participants for use in the upcoming round. The successive rounds and the updating of the body of ideas continue to occur without a predetermined end. The participants can provide the indications of relative values through a user interface of an online facility. The online facility includes a website, a desktop application, or a mobile app. The participants are enabled to provide the indications of relative values by a host that is not under the control of or related to any of the participants. The participants are enabled to provide the indications of relative values by a host that has a relationship to the participants. The host includes an employer and the participants include employees. The host includes an educational institution and the participants include students at the educational institution. The host includes an advertiser or its agent and the participants include targets of the advertiser. The participants are part of a closed group. At least some of the participants are engaged in the development of a product. At least some of the participants are engaged in the creation of an original work.

A second group/crowd of participants is enabled to provide indications of relative values of ideas that belong to a second body of ideas, and ideas that are high in the rank ordering of the group/crowd and in the rank ordering of the second group/crowd are treated as communications and the conversation between the group/crowd and the second group/crowd.

In general, in an aspect, facilities are exposed through a user interface by which participants who belong to a group/crowd of participants can provide indications of relative values of ideas that belong to a set of ideas. The participants can provide the indications in two or more rounds. Each of at least some of the participants provide the indications with respect to fewer than all of the ideas in the body in each of the rounds.

Implementations may include one or more of the following features. The set ideas for which each of the participants is enabled to provide the indications in each round are at least partly different from the set ideas for which that participant was enabled to provide the indications in a prior round. The group/crowd can initiate an activity among its participants that includes the rounds of providing the indications. The facilities are exposed to a predetermined set of participants on behalf of a predetermined host. The facilities are exposed in connection with a market study. The facilities are publicly accessible. The facilities are also exposed to at least some of the participants through the user interface information about current rankings of the ideas inferred from the indications provided by the participants. And administrator can choose among two or more different ways to expose the facilities to the participants for providing their indications of the relative values of the ideas. The participants are rewarded for their participation. The indications given by the participants relate to development of a product. The user can administrate the activity by defining the number of ideas in the sets that are to be presented the participants in a given round. The user can administrate the activity by defining a number of sets of ideas to be presented to each participant in a given round.

In general, in an aspect, a voting machine, which can be an interactive terminal device having security features commensurate with the requirements for security for the venue, through a user interface facilities are offered by which a user can administer an activity to be engaged in by participants who belong to a group/crowd of participants to enable the administrator to obtain a rank ordering of ideas that belong to a body of ideas. The activity is implemented by exposing the ideas to the group/crowd of participants, enabling the participants to provide indications of relative values of ideas that belong to the body of ideas, and processing the indications of the relative values of ideas to infer the rank ordering. The ideas are exposed to the participants in successive rounds, each of at least some of the participants providing the indications with respect to a set of fewer than all of the ideas in each of the rounds. The body of ideas is updated before each successive round to reduce the total number of ideas that are exposed to the participants in the successive round.

Implementations may include one or more of the following features. The user can administrate the activity by defining the ideas that are to be presented to the participants. The user can administrate the activity by defining the number of rounds. The user can administrate the activity by defining the number of participants. The user can administrate the activity by specifying the identities of the participants. The user can administrate the activity by specifying metrics by which the values are to be measured. The user can administrate the activity by specifying the manner in which the ideas are presented to the participants. The user can administrate the activity by defining the number of ideas that are to be presented the participants in a given round. The user can administrate the activity by defining a number of sets of ideas to be presented to each participant in a given round.

In general, in an aspect, a body of ideas to be ranked by a group/crowd of participants is received from a first entity. A score is calculated for each idea in the body of ideas over the course of multiple rounds. At least some of the rounds include sorting the body of ideas into subsets (we sometimes refer to subsets simply as sets); providing each subset to one of the participants. A ranking of the ideas belonging to a subset is received from a respective participant. A contribution is made to the calculation of the score for a respective idea based on the received rankings of subsets that include the idea. Identities of all the participants of the group/crowd of participants are known before a first round of the multiple rounds begins. The identities of at least some of the participants of the group/crowd of participants are not known before a first round of the multiple rounds begins. A subset is generated when an identity of a new participant becomes known and the generated subset is provided to the new participant. Receiving a ranking of the ideas belonging to a subset from a respective participant includes receiving an indication to eliminate an idea from the subset. Receiving a ranking of the ideas of a subset from a respective participant includes receiving a numerical ranking for at least some of the ideas. Receiving a ranking of the ideas of a subset from a respective participant includes receiving an identification of a best idea in the subset. Receiving a ranking of the ideas of a subset from a respective participant includes receiving an identification of a worst idea in the subset. Receiving a ranking of the ideas of a subset from a respective participant includes receiving an indication that two ideas represent substantially the same concept. At least some of the rounds include receiving, from a participant, an addendum to an idea, and providing the addition to subsequent participants when the idea is provided to those subsequent participants. Data is collected describing the actions of at least some of the participants. The score of at least one idea is calculated based on the collected data describing the actions of a participant. The collected data includes time spent by the participant on performing an action. Participants are identified whose selection of ideas is dissimilar from other participants, and those participants are designated as potential scammers. Participants are assigned to participant groups based on characteristics of the respective participants and the subsets are provided to the participants based on the participant groups. Calculating a score for a respective idea includes determining a local winner for each subset, and calculating the number of times an idea is determined to be a local winner. For at least one of the rounds, no participant is assigned a subset containing an idea submitted by the participant. For at least one of the rounds, no two subsets each contain the same two ideas. For a subsequent round to the at least one of the rounds, at least two subsets each contain the same two ideas. The scores of an idea are calculated based on a relationship between the idea and scores of other ideas in subsets to which the idea was assigned. The scoring for an idea includes calculating a win rate for an idea, the calculation based on the number of times the idea was chosen over other ideas. Calculating the score for an idea includes calculating an implied score based on the scores of other ideas over which the respective idea was chosen in favor of Calculating the score for an idea includes calculating a corrected score by averaging a first quartile and a third quartile score, subtracting fifty percent, and adding the original score. The ideas are assigned to the subsets based on a Mian-Chowla sequence. Assigning ideas to subsets includes numbering each idea, generating a series of Mian-Chowla numbers for a first subset, assigning ideas each numbered as one of the respective Mian-Chowla numbers in the series to a first subset, incrementing each number in the series of Mian-Chowla numbers for subsequent subsets, and assigning ideas each numbered as one of the respective Mian-Chowla numbers in the incremented series to the subsequent subsets.

These and other aspects, features, and implementations and combinations of them can be expressed as apparatus, systems, methods, methods of doing business, program products, components, mean and steps for performing functions, and in other ways.

In addition to the synchronous mode described herein, it is possible to use the concept in an asynchronous mode. Synchronous in this context generally meaning that the participants vote in each round generally at the same time, and the ideas are distributed also generally at the same time. In asynchronous mode, the accumulation and distribution of ideas does not require that all ideas be available at the start, but distribution may commence as soon as sufficient ideas exist for a group of participants to consider them.

For example, in an asynchronous voting machine there may be a computer connected to a plurality of linked voting terminals capable of rating voting responses to a massive number of ideas flowing into the various terminals in an asynchronous manner as these ideas are being created.

To insure that the effect of an individual rater's bias is minimized while minimizing the effect of individual rater bias affecting overall ratings and with processing throughput being substantially time independent on the number of ideas to be rated, the number of ideas being numbered 1 to N, N being the last idea, the voting machine performs any or all of the following tasks, in this order, or in any other order:

a. the terminals receive participant input in the form of ideas. The system waits until a minimum number of ideas have been entered into the terminals and then the voting computer/server electronically distributing at least this minimum number of ideas, divided into idea sets, to participants as they access a plurality of terminals, or arrive at the same terminals serially. Then asynchronously, a next group of participants that arrives at said terminals to vote and/or submit more ideas, an idea set is distributed to each participant at a terminal until each of the minimum number of ideas has been equally distributed. Eventually the minimum number of ideas are divided so that the number of ideas has a substantially equal and fair probability of being viewed and voted on by a generally equal number of participants;

b. the participants are offered the opportunity to rank the ideas from the idea set received, such as, at least one highest ranking idea;

once a predetermined target set allocation is reached the ranking votes are allowed to be tabulated by the sever;

c. the voting computer/server has a predetermined threshold win rate (i.e. hurdle rate) against which said participant ranking for each idea are compared; and the ideas which exceed said predetermined number as considered winning ideas and are segregated by the server in a first subgroup of ideas which exceed said predetermined number;

This set of actions continues as new ideas/posts to terminals as new participants show up. Every time the target set allocation, i.e. the predetermined numbers of ideas is reached, voting is tabulated as above.

d. so for example, in a second level of voting (filtration), again the system waits until a minimum number of ideas have entered the first subgroup, the voting computer electronically distributing this minimum number of ideas, divided into idea sets, to the next group of participants that arrive at said terminals or logon to terminals, to vote and/or submit more ideas, one idea set is distributed to each arriving participant at a terminal. The ideas may be intermingled/intermixed with the ideas from the first round/level according a predetermined number until each of the minimum number of first subgroup ideas has been equally distributed. This is a way to make up for an idea shortfall at any time. A minimum number of sub group ideas are divided so that the number of ideas has a substantially equal and fair probability of being viewed and voted on by a generally equal number of participants;

e. the participant input from the terminals is received by the participant selecting from their idea set, via an input device, at least one highest ranking idea;

Once the target set allocation is reached the votes are allowed to be tabulated by the server/computer.

f. based on the predetermined threshold hurdle win rate which comprises a predetermined number against which said participant ranking for each idea are compared; segregating the ideas which exceed said predetermined number as winning ideas and creating a second subgroup of ideas which exceed said predetermined number;

This set of actions continues as new winning (round 1 or level one) ideas/come into the terminals and as new participants access terminals, every time the target set allocation is hit, we tabulate the votes.

Note: it is possible to have participants rank order all the ideas best to worst then we give a point for every idea that another idea beats—this is almost mandatory as we are using smaller idea sets (5 ideas each) and we may need the extra data. Then the winning score becomes the highest percent of the max available points.

Participants can do many functions:

Submitter: Any user who submits a post to the forum stream. Note that submitters also see and rank other submissions, just as a viewer would.

Viewer: Any user who simply views the forum stream but does not submit a post.

Participant: a submitter or a viewer.

Note that forums usually have more participants than submitters—it will be easy to intermix round 2 (or 3) level ideas into the line-up.

This can continue beyond two rounds as desired.

Another aspect of the system is that the voting computer electronically distributes the first subgroup of ideas divided into second idea sets to all participants at terminals in parallel wherein each participant receives at least one second idea set; wherein the universe of ideas are divided so that the number of second idea sets generally equals the number of participants and wherein each idea has a substantially equal and fair probability of being viewed and voted on by a generally equal number of participants; whereby the number of ideas is reduced while the number of participants is generally not reduced, thereby more participants are applied to the remaining ideas.

The server receives input at said terminals from participant's selection from their second idea set, at least one highest ranking idea;

The voting computer having establishing a second threshold hurdle win rate which comprises a second predetermined number against which the participant rankings for each idea are compared; the voting computer segregating the ideas which exceed said second predetermined number as winning ideas and creating a second subgroup of ideas which exceed said second predetermined number;

wherein each of actions (a) and (d) comprises steps for dividing plurality of ideas into groups, each groups of ideas to be distributed to each of a plurality of participants by;

the voting computer, using a sequence of integers method of assigning a sequence of idea numbers 1 to N distributing the ideas to said first sub-group into non-exclusive subsets

whereby the voting computer terminates further distribution to terminals and rating or proceeds to subsequent rounds of redistributing ideas to further increase the accuracy and throughput to find the group preferred idea and whereby effectively a large number of ideas is distillable by a mass participant group and the computer generates an output of a distilled consensus of ideas.

Another way to describe this action is as follows:

The Asynchronous engine does not have the luxury of being able to redistribute, as the only participants that can be conscripted are those that happen to show up. Of course, participants that engage the forum multiple times per day can be prompted more than once to rank sets. Also most forums have a greater number of viewers than submitters, which makes the ranking task easier. For now let us consider the worst case scenario (all participants are submitters) before entertaining our options when viewers are plentiful.

Because we use discreet ranking, the Round 1 results may garner enough data and granulation such that the administrator is confident enough to stop here. No further rankings may be necessary. If however the decision is made generate even more robust data, multiple voting rounds might be preferred. If we wish to use Mod MC templates for Round 2 ranking the logistics would be as follows:
The top 4 posts from Set Group 1 (13 posts total) could be earmarked for Round 2 voting, as would the top 4 posts from Set Groups 2 and 3. A wildcard post could also pass to Round 2. It would be the next highest ranking post from any of the 3 Set Groups and is necessary because we need a minimum of 13 posts for a Mod MC template.
With Mod MC method for Round 2 (R2), the resulting scores would be very nuanced and have a high confidence level. The problem is that this method necessitates many participants and as such is best suited for high traffic forums and/or forums with a high viewer to submitter ratio. The soonest that participants could start voting on Round 2 level posts would be Participant 53. By Participant 65 we would have the first R2 level posts selected i.e. we would have double filtered some posts.
An alternative could be used for lower traffic forums.
   The top X posts (say 4) from Set Group 1 could be given to Set Group 2 participants as a second set to rank.
   Each participant would get the same posts, as there would only be 3 to 5 in total (they were the winners from set group 1's rankings. The best 1 or 2 posts would be selected and could eventually compete in a Round 3.
   When enough R2 winning posts are available, the next Set Group could be bifurcated such that half of the participants get R1 winning posts from the previous Set Group while the other half is allocated R2 winning posts for ranking in a Third-level round (perhaps the final ranking).

Another aspect of the disclosure is a voting machine and network connecting like voting machines. The voting machine is especially designed or configured to rapidly manage ranking of mass narrative user inputs and to interactively rank such user input. Furthermore, it preferable to have the system “hardened” against data tampering. Thus the typical off the shelf pc without hardware or software modification will maximally exploit this disclosure. The speed at which this must happen and the complexity of this process make manual execution of this concept impossible without a computer network configured for this purpose.

The voting machine is preferably specially configured to allow the voter continuously interact with a terminal in ways that are not typical for voting machines. In the preferred embodiment, a voter would appear at an electronic terminal and cast a ballot from a selection of choices. In this case, the voter is also and perhaps offered the opportunity input narrative suggestions which he/she wants to be considered by the group. An example might be at a shareholder's meeting where the voters (shareholders) may want to put proposals to the board of directors or the shareholders themselves. Because large group meetings, which may also be virtual, cannot possibly consider many suggestions fairly and quickly, this inventive disclosure is implemented. The voting terminal therefore must have a narrative entry field where a participant/user can enter a proposal for consideration. Such proposal must then be sent to the server to be added to proposals from other user. Preferably the user has a time limit for data entry, in order that all proposals can be tallied and redistributed without late entries. As in the case of a shareholder's meeting, the user would log in before or at the outset of the meeting, and enter any proposals. At some time, the proposal data entry would be blocked and all proposals would be grouped at random into a data table. The proposals would then be divided into subgroups and distributed amongst the participants by various unbiased methods described herein. To do this, the server stores all proposals in a data file in memory, preferably random access memory and then generates a sequence of numbers to know how to parse/divide the proposals into groups of proposals to be distributed. The number of users who can receive proposals is a known number, which is also typically less than the number of user, since some or many will not submit proposals. A known sequence of integers method, such a Mian-Chowla, is generated in memory and then applied against the proposals data to parse the data into finite numbers of proposals/ideas which are distributed to the users/participants. Typically each user will have the same amount of ideas to consider, but there can be an odd lot which is greater or less than the other lots. An odd lot is distributed as well as it has no effect on the outcome. The users, still at their terminals, if done in real time, perhaps during a break in the shareholder's meeting, would now be presented with a plurality of proposals/ideas to consider and rank by inputting a vote for or a preference score (say 1-10). These score are computed and ideas re-ranked and then distributed again the users, with lowest ranking ideas below a predetermined number, dropped. This must happened rapidly since the users are preferably still at their terminals. The users receive a portion of the winning ideas parsed to the by the server using a known number sequence for parsing.

The server preferably follows an instruction set with some or all of the following elements:

a network for interconnecting input terminals;

a plurality of input participant terminals, said terminals including data encryption of data of signals transmitted to and from the network;

said terminals include participant verification capability to ascertain that the identity of the participant can be verified to a predetermined level of security;

said terminals each configured to:

enable participants who belong to a group of participants to provide indications of relative values of ideas that belong to a body of ideas,

deriving a rank ordering according to the relative values of at least some of the ideas of the body based on the indications provided by the participants,

the participants being enabled to provide the indications in two or more rounds, each of at least some of the participants providing the indications with respect to sets of fewer than all of the ideas in the body in each of the rounds, and

between each of at least one pair of successive rounds, updating the body of ideas to reduce the role of some of the ideas in the next round;

ranking the ideas according to highest cumulative relative values;

distributing the highest ranked ideas to the terminals of the participants and receiving inputs from the participants at said terminals, where the participants rank the ideas;

after a predetermined number of rounds,

transmitting a listing of highest ranking ideas to at least some of said terminals.

Some other aspects of this disclosure are as follows:

A voting machine and network in which the indications provided by the participants comprise explicit ordering of the ideas based on their relative values.

A voting machine and network in which the indications provided by the participants comprise making choices among the ideas.

A voting machine and network in which the indications provided by the participants comprise observations about the ideas.

A voting machine and network in which the participants comprise people.

A voting machine and network in which the participants comprise groups of people.

A voting machine and network in which the participants comprise entities.

A voting machine and network in which the values relate to the merits of the ideas.

A voting machine and network in which the values relate to the attractiveness of the ideas.

A voting machine and network in which the values relate to the costs of the ideas.

A voting machine and network in which the values relate to financial features of the ideas.

A voting machine and network in which the values relate to sensory qualities of the ideas.

A voting machine and network in which the values relate to viability of the ideas.

A voting machine and network in which the ideas comprise concepts.

A voting machine and network in which the ideas comprise online posts.

A voting machine and network in which the ideas comprise images.

A voting machine and network in which the ideas comprise audio items.

A voting machine and network in which the ideas comprise text items.

A voting machine and network in which the ideas comprise video items.

A voting machine and network in which the body of ideas are provided by a party who is not one of the participants.

A voting machine and network in which at least some ideas in the body are provided by the participants.

A voting machine and network in which at least some ideas in the body are added between each of at least one pair of successive rounds.

A voting machine and network in which at least some of the ideas in the body are organized hierarchically.

A voting machine and network in which at least some of the ideas in the body comprise subsets of the set of ideas.

A voting machine and network in which at least some of the ideas in the body comprise comments on other ideas in the body.

A voting machine and network in which at least some of the ideas in the set comprise edited versions of other ideas in the body.

A voting machine and network in which the rank ordering comprises an exact ordering of all of the ideas in the body.

A voting machine and network in which the rank ordering comprises an exact ordering of fewer than all of the ideas in the body.

A voting machine and network in which the rank ordering is determined by a computational analysis of the indications of the participants.

A voting machine and network in which the rank ordering is partially determined after each of the rounds until a final rank ordering is determined.

A voting machine and network in which, before each of the rounds, selecting a set of one or more ideas from the body of ideas to be provided to each of the participants for use in the upcoming round.

A voting machine and network in which the successive rounds and the updating of the body of ideas continue to occur without a predetermined end.

A voting machine and network in which the participants are enabled to provide the indications of relative values through a user interface of an online facility.

A voting machine and network in which the online facility comprises a website, a desktop application, or a mobile app.

A voting machine and network in which the participants are enabled to provide the indications of relative values by a host that is not under the control of or related to any of the participants.

A voting machine and network in which the participants are enabled to provide the indications of relative values by a host that has a relationship to the participants.

A voting machine and network in which the host comprises an employer and the participants comprise employees.

A voting machine and network in which the host comprises an educational institution and the participants comprise students at the educational institution.

A voting machine and network in which the host comprises an advertiser or its agent and the participants comprise targets of the advertiser.

A voting machine and network in which the participants are part of a closed group.

A voting machine and network in which at least some of the participants are engaged in the development of a product.

A voting machine and network in which at least some of the participants are engaged in the creation of an original work.

A voting machine and network in which a second group/crowd group of participants is enabled to provide indications of relative values of ideas that belong to a second body of ideas, and ideas that are high in the rank ordering of the group/crowd group and in the rank ordering of the second group/crowd group are treated as communications in a conversation between the group/crowd group and the second group/crowd group.

A voting machine and network having a network for interconnecting input terminals;

a plurality of input participant terminals, said terminals including data encryption of data of signals transmitted to and from the network;

said terminals include participant verification capability to ascertain that the identity of the participant can be verified to a predetermined level of security;

said terminals each configured to:

exposing through a user interface facilities by which participants who belong to a group/crowd group of participants can provide indications of relative values of ideas that belong to a body of ideas,

enabling the participants to provide the indications in two or more rounds, each of at least some of the participants providing the indications with respect to a set of fewer than all of the ideas in this set in each of the rounds,

the ideas for which each of the participants is enabled to provide the indications in each round being at least partly different from the ideas for which the participant was enabled to provide the indications in a prior round.

A voting machine and network including enabling the group/crowd group to initiate an activity among its participants that includes the rounds of providing the indications.

A voting machine and network including exposing the facilities to a predetermined set of participants on behalf of a predetermined host.

A voting machine and network including exposing the facilities in connection with a market study.

A voting machine and network in which the facilities are publicly accessible.

A voting machine and network comprising also exposing to at least some of the participants through the user interface information about current rankings of the ideas inferred from the indications provided by the participants.

A voting machine and network including enabling an administrator to choose among two or more different ways to expose the facilities to the participants for providing their indications of the relative values of the ideas.

A voting machine and network in which the participants are rewarded for their participation.

A voting machine and network in which the indications given to by the participants relate to development of a product.

A voting machine and network comprising:

a network for interconnecting input terminals;

a plurality of input participant terminals, said terminals including data encryption of data of signals transmitted to and from the network;

said terminals include participant verification capability to ascertain that the identity of the participant can be verified to a predetermined level of security;

said terminals each configured to:

expose through a user interface facilities by which a user can administer an activity to be engaged in by participants who belong to a group/crowd group of participants to enable the administrator to obtain a rank ordering of ideas that belong to a body of ideas, and

implement the activity by exposing the ideas to the group/crowd group of participants, enabling the participants to provide indications of relative values of ideas that belong to the body of ideas, and

process the indications of the relative values of ideas to infer the rank ordering,

the ideas being exposed to the participants in successive rounds, each of at least some of the participants providing the indications with respect to fewer than all of the ideas in the setting each of the rounds, and

update the body of ideas before each successive round to reduce the total number of ideas that are exposed to the participants in the successive round.

A voting machine and network in which the user can administrate the activity by defining the ideas that are to be presented the participants.

A voting machine and network in which the user can administrate the activity by defining the number of rounds.

A voting machine and network in which the user can administrate the activity by defining the number of participants.

A voting machine and network in which the user can administrate the activity by specifying the identities of the participants.

A voting machine and network in which the user can administrate the activity by specifying metrics by which the values are to be measured.

A voting machine and network in which the user can administrate the activity by specifying the manner in which the ideas are presented to the participants.

A voting machine and network having:

a network for interconnecting input terminals;

a plurality of input participant terminals, said terminals including data encryption of data of signals transmitted to and from the network;

said terminals include participant verification capability to ascertain that the identity of the participant can be verified to a predetermined level of security;

said terminals each configured to:

receive, from a first entity, a body of ideas to be ranked by a group/crowd group of participants; and

calculate a score for each idea in the body of ideas over the course of multiple rounds, at least some of the rounds comprising:

sort the body of ideas into subsets;

provide each subset to one of the participants;

receive a ranking of the ideas of a subset from a respective participant; and

contribute to the calculation of the score for a respective idea based on the received rankings of subsets that include the idea.

A voting machine and network in which identities of all the participants of the group/crowd group of participants are known before a first round of the multiple rounds begins.

A voting machine and network in which identities of at least some of the participants of the group/crowd group of participants are not known before a first round of the multiple rounds begins.

A voting machine and network comprising generating a subset when an identity of a new participant becomes known and providing the generated subset to the new participant.

A voting machine and network in which receiving a ranking of the ideas of a subset from a respective participant comprises receiving an indication to eliminate an idea from the subset.

A voting machine and network in which receiving a ranking of the ideas of a subset from a respective participant comprises receiving a numerical ranking for at least some of the ideas.

A voting machine and network in which receiving a ranking of the ideas of a subset from a respective participant comprises receiving an identification of a best idea in the subset.

A voting machine and network in which receiving a ranking of the ideas of a subset from a respective participant comprises receiving an identification of a worst idea in the subset.

A voting machine and network in which receiving a ranking of the ideas of a subset from a respective participant comprises receiving an indication that two ideas represent substantially the same concept.

A voting machine and network, at least some of the rounds comprising:

receiving, from a participant, an addendum to an idea, and

providing the addition to subsequent participants when the idea is provided to those subsequent participants.

A voting machine and network comprising collecting data describing the actions of at least some of the participants.

A voting machine and network comprising calculating the score of at least one idea based on the collected data describing the actions of a participant.

A voting machine and network in which the collected data comprises time spent by the participant on performing an action.

A voting machine and network comprising, based on the collected data, identifying participants whose selection of ideas is dissimilar from other participants, and designating those participants as potential scammers.

A voting machine and network comprising assigning participants to participant groups based on characteristics of the respective participants and providing the subsets to the participants based on the participant groups.

A voting machine and network in which calculating a score for a respective idea comprises determining a local winner for each subset, and calculating the number of times an idea is determined to be a local winner.

A voting machine and network in which, for at least one of the rounds, no participant is assigned a subset containing an idea submitted by the participant.

A voting machine and network in which, for at least one of the rounds, no two subsets each contain the same two ideas.

A voting machine and network in which, for a subsequent round, at least two subsets each contain the same two ideas.

A voting machine and network comprising calculating the scores of an idea based on a relationship between the idea and scores of other ideas in subsets to which the idea was assigned.

A voting machine and network in which calculating the score for an idea comprises calculating a win rate for an idea, the calculation based on the number of times the idea was chosen over other ideas.

A voting machine and network in which calculating the score for an idea comprises calculating an implied score based on the scores of other ideas over which the respective idea was chosen in favor of.

A voting machine and network in which calculating the score for an idea comprises calculating a corrected score by averaging a first quartile and a third quartile score, subtracting fifty percent, and adding the original score.

A voting machine and network in which the ideas are assigned to the subsets based on a Mian-Chowla sequence.

A voting machine and network in which assigning ideas to subsets comprises:

numbering each idea,

generating a series of Mian-Chowla numbers for a first subset,

assigning ideas each numbered as one of the respective Mian-Chowla numbers in the series to a first subset,

incrementing each number in the series of Mian-Chowla numbers for subsequent subsets, and assigning ideas each numbered as one of the respective Mian-Chowla numbers in the incremented series to the subsequent subsets.

A voting machine and network in which the user can administrate the activity by defining the number of ideas that are to be presented the participants in a given round.

A voting machine and network in which the user can administrate the activity by defining a number of sets of ideas to be presented to each participant in a given round.

A voting machine and network in which an administrator defines a number of ideas that are to be presented to each participant in a given round.

A voting machine and network in which an administrator defines a number of sets of ideas that are to be presented to each participant in a given round.

Other aspects, features, implementations, and advantages will be apparent from the description, the figures, and the claims. Note that is summary is provided only to assist the reader in understanding remainder of the specification which follows and is not intended to define the scope of the invention. The claims perform that function.

### DESCRIPTION

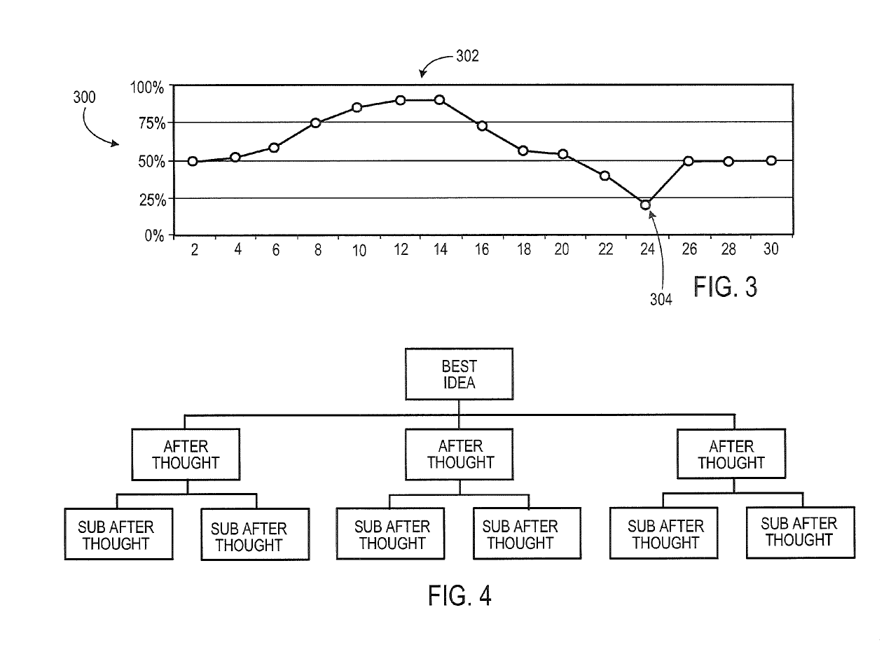

FIGS. 3-7, and 60-103 are screen shots.

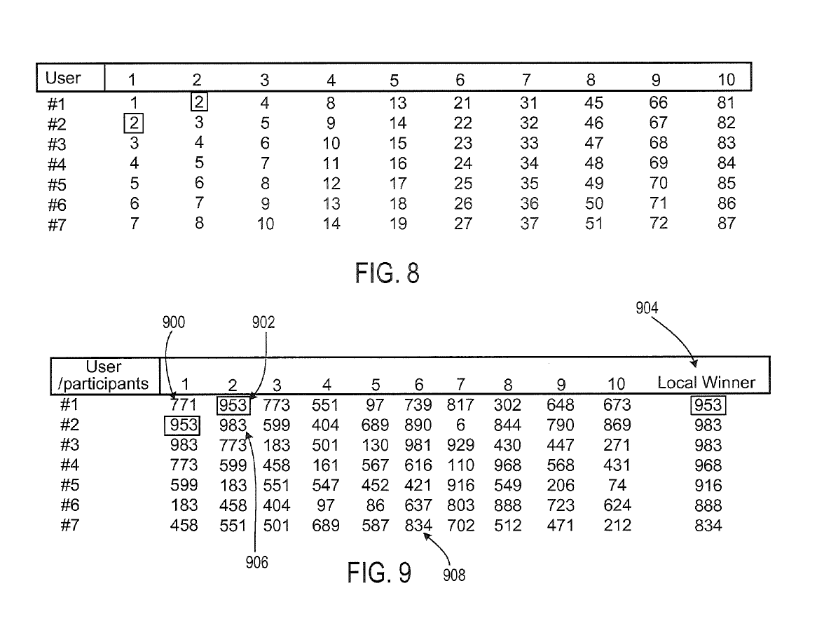

FIGS. 8-46 and 49-58 are tables.

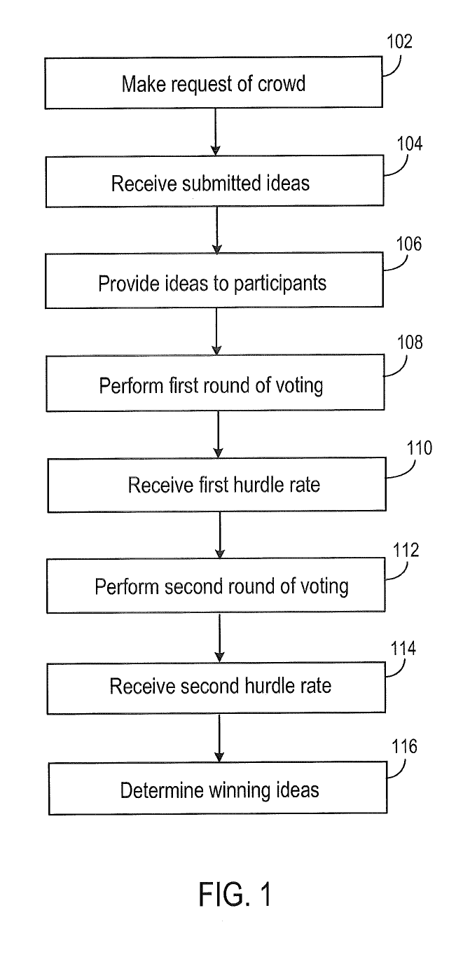

FIGS. 1, 48, and 59 are flow charts.

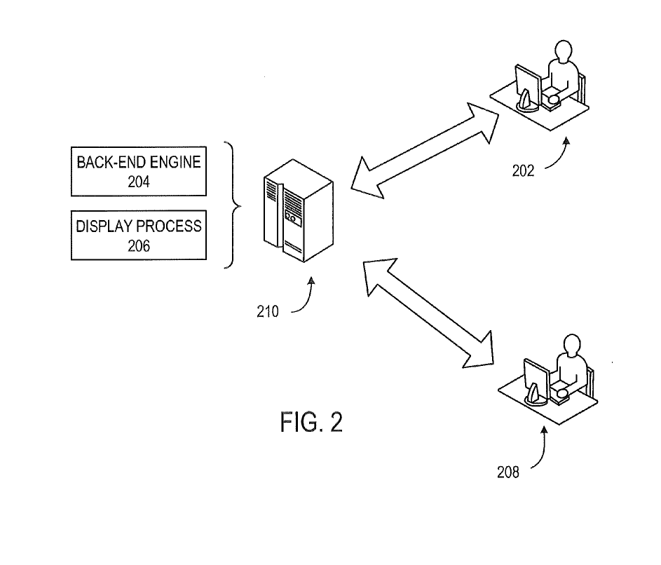

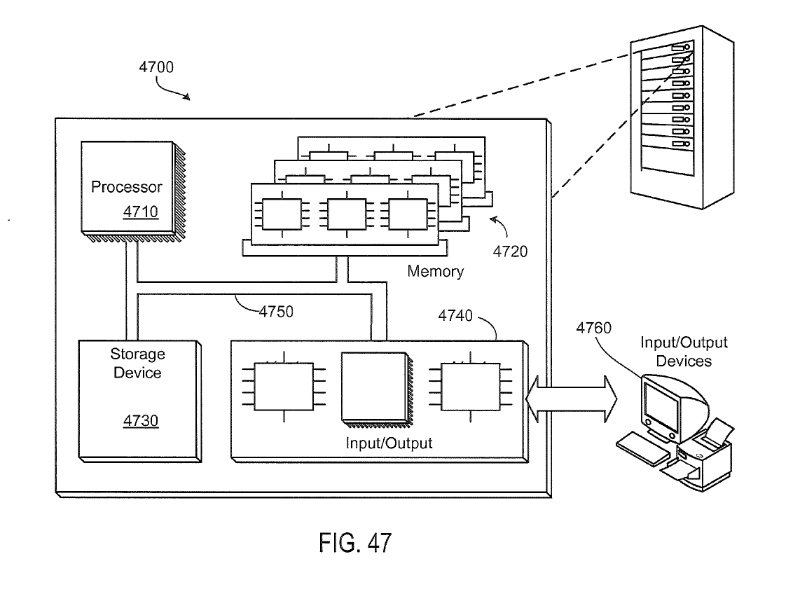

FIGS. 2 and 47 are block diagrams.

Here we describe systems and techniques that involve communication within a group and between or among groups. Among other things, we discuss how an individual or two or more individuals or subgroups of the group can use this system to his or their advantage within a group, how individuals or entities can encourage group participation, the benefits to the individual, the group and others of using this system, and the many and wide ranging potential applications of this system. In part, the system and techniques that we describe distill knowledge, in some cases in real time, from a group/crowd, so that “the few” can hear “the many.” Among other things, the systems and techniques that we describe here enable determining a consensus of a group.

We use the words “communication,” “speaking,” “collaboration,” and other similar terms interchangeably and broadly. All refer to types of communication. We use each of these words in its broadest possible sense to include, for example, the transmission, conveyance or exchange of any information or the system or process of transmission, conveyance, or exchange of any information of any kind, at any place, and in any way. This includes, for example, sharing any audio, text, scents or images, proposing ideas, and responding to comments, among a wide range of others. Communication can be done by individuals or by groups.

We use the words “knowledge,” “consensus,” “group consensus,” “consensus opinion,” “consensus ordering,” “good ideas,” “best ideas,” “important information,” “useful input,” “top picks,” “ordering,” “alignment,” “best wisdom,” “the group/crowd speaking with one voice,” “most preferred idea,” “agreement,” “full power of the group/crowd,” “value of the group's brainpower,” “findings,” “conclusions,” “the best the group/crowd has to offer,” “collective offer,” “favorites,” “the will of the people,” and other similar terms interchangeably and broadly. All refer to the outcomes or goals of using our system, with potentially many outcomes and goals for any given use of our system. We use the terms “outcomes” and “goals” in their broadest possible senses to include, for example, any group decision or goal, any useful or interesting data developed or discovered within the group, or any knowledge or opinions possessed by members of a group, including the best (or worst) customer ideas or suggestions, group feedback on any project or idea, group consensus, group bargaining, experiences of group members, and a group's rankings of ideas, among others. We note here that group communication as we describe it includes, for example, true nuanced qualitative idea formation by a mass of people.

We use the words “group/crowd,” “masses,” “the many,” “groups” and other similar terms interchangeably and broadly. All refer to groups. We use the term “group” in its broadest sense to include, for example, two or more (including potentially hundreds or thousands or millions of) individuals or entities, including group/crowds, masses, the many, and audiences, among others.

Among other things, as a result of using this system, corporations, online forums, group/crowd sourcing, collaborations, governments and individuals another introduce can operate efficiently, quickly, and with insight.

In some instances, the system is implemented as a software application, website, mobile app, a computerized system, or any combination of them. For example, one such system, called the Group/crowd Speaker Platform, is a communications platform being developed by Group/crowd Speak Inc., that allows organizations to solicit, collect, vet, and even augment ideas while rapidly weeding out the noise from the group/crowd.

Humankind generally communicates one speaker at a time. Whether you are using a cell phone, reading someone's blog or listening to a speech—communication is typically serial. For example, a conversation can be described using terms like “she talks,” “he talks,” “I talk,” “you talk.” A group/crowd is generally not described as talking unless, for example, an individual spokesperson has been delegated the task of communicating, or a decision-maker (e.g., a CEO or Executive Director) evaluates the communication from the individuals in making decisions.

Sometimes, a group/crowd of people can communicate. Some examples of information communicated by a group/crowd could be the daily activity of a stock market, or quarterly activity of a national economy, or the result of an election for a President or Member of Parliament. In these examples, the aggregation of individual communications (e.g., buy/sell, Democrat/Republican) could be said to be communication made by a group/crowd, without any spokesperson or decision-maker, but it is a rudimentary communication.

The system generally described here (an example of which is the Group/crowd Speaker platform) can also uncover (that is, infer or derive or filter) a group/crowd's otherwise hidden or not explicitly articulated consensus opinion (or other information) using individual communications as input and without a spokesperson or decision-maker managing the process or speaking for the group/crowd.

With this system, a group/crowd of participants (be it 20 or 20 million or any other number) can communicate using one voice.

We use the “members,” “members of the group/crowd,” “audience members,” “group members,” “users,” “voters,” “contributors,” “commenters,” “choosers,” “participants,” “people,” “citizens,” “communicators,” “judges,” and other similar terms interchangeably and broadly. All refer to participants. We use the term “participant” and any of the other terms in its broadest sense to include, for example, any individual or entity participating in this system, including a customer, employee, company, fan, or other group, or combinations of them, among others.

We use the words “idea,” “concept,” “innovation,” “choice,” “argument,” “alternative,” “possibility,” “suggestion,” “thought,” “posting,” “solution,” “post,” “submission” and other similar terms interchangeably and broadly. All refer to ideas. We use the term “idea” and each of the other terms in its broadest sense to include, for example, any item, entity, object, expression, indicia, icon, audio or visual item, or other thing that can be approved or ranked or ordered or discussed or joined, or any combination of those, including comments in forums, potential products or services, political candidates, memberships, possible goals, and selections of music, videos and text, among others.

Some examples of our concepts can cut through the clutter and marginal thoughts to get straight at what the participants would find most useful if some or all of them had time to go through each and every item (we sometimes use the term item interchangeably with any of the terms listed above). In addition, a filter (we use the term filter broadly to include uncovering, inferring, or deriving, or any combination of them) can sort through countless ideas and surface only the good ones.

In some uses of our system, the communication occurs in what we sometimes call a session. A session can be, for example, an isolated or discrete use of our system to achieve a specific goal or gather a specific group consensus on a specific issue. For example, as described below, a session can be the use of the system by an automobile company to determine what features its customers would like to see on the next pick-up truck. A session can also be the application of our system in a particular setting, for instance, the use of our system in a given online discussion forum to determine the most useful or best ideas posted over time. A session can be directed internally, to the group itself or outwards, towards other groups, a person, a company, a politician, a CEO, etc. In some cases, a session is defined by a beginning and an end or by a purpose or a goal or project or by a defined group of participants or in other ways and combinations of them.

In some examples, the system can use an algorithm that achieves what we call geometric reduction. This term can refer to a result of applying the system in which the number of ideas is reduced over time or bad ideas are abandoned and/or group consensus is found with limited participation from each participant (for example, each participant does not need to view and rank each and every idea) or any combination of those. The system can achieve this by divvying up the job of filtering ideas, adding to ideas, and editing ideas among the individuals of the group/crowd. Because each participant is allocated only a small share of the workload, the cumbersome tasks become simpler.

That is, one of the main difficulties of understanding what a group/crowd is thinking about a very large number of ideas is to understand the view of each individual participant in the group/crowd about the relative ranking of the ideas under some measure of value, and then to understand how those relative rankings of all of the participants would interplay to produce a relative ranking of the ideas under the measure of value for the group/crowd as a whole. When the number of ideas and the number of participants in the group/crowd are small, the tasks of understanding each individual's view of the relative rankings and then have aggregating the views is tractable. But when the number of ideas or the number of participants grows large, the problem becomes potentially intractable. We propose a way to address this by dividing the job into many small pieces and distributing the pieces to the participants of the group/crowd for completion. We use an algorithm then to reduce the number of ideas that could possibly represent the view of the group and then we repeat the process of dividing up the task of dealing with those ideas, again among the participants in the group/crowd. By performing the sequence iteratively, our system can very rapidly reduce the number of candidate ideas and quickly uncover the group/crowd's views (which then become, in effect, a communication of the group/crowd as a whole).

This method of communicating applies the benefits of collaboration software and internet based social networking. As a result, in a commercial context, for example, companies can “hear” all their customers. In this way, a conversation can occur in which one participant of the conversation is a group/crowd of many people, perhaps millions.

This system can enable fair communication in groups and among groups, and/or enable each participant to actively participate in group discussions and choices.

Using the strategies described here, large groups of people can communicate at once. For instance, many individual customers can directly speak to the CEO of a company, and many audience members can ask a question of the speaker.

The system described here can also enable information sharing. There are many motivations for sharing information. Some of them include reward (e.g., monetary), recognition, and altruism. Our strategy can underscore and capitalize on each motivation. For instance, for people who are altruistic with their time/ideas, this system can ensure that their ideas are actually heard and their efforts make a difference. Furthermore, this system can be used to fairly compensate and fairly recognize those who contribute or participate.

Reward and recognition may be a matter of trust. In some implementations, this system provides a standardized methodology for compensating or recognizing individuals who contribute good ideas. For instance, customers who give suggestions to a company on a product that happens to produce a dramatic sales increase can get rewarded or recognized for supplying that valuable information. One example of this is a system that pays a fractional amount of the benefit back to the information provider(s) or source(s) of an idea, which in turn may raise information flow and generate more ideas and participation. Reward and recognition are important in increasing information flow, and require proportional credit and trust. The system described here can be transparent and visible, so that satisfying answers can be provided for the following questions: In a mass collaboration, who gets rewarded and recognized and to what degree? How does one trust that the system and the bureaucracy will treat them fairly? How does one trust that fellow group/crowd members will treat them fairly? With visibility (e.g., providing transparency across the system/platform) reward and recognition can be used as powerful motivators.

This system enables filtering. Some examples of this system can sort and filter potentially massive amounts of qualitative data quickly. In some implementations, we consider the process of filtering to be related to the notion of ranking a set of ideas; by ranking a large number of ideas in an order of their value under some measure of value, one can filter out the less valuable ideas quite easily by excluding the ones below a certain item in the rank ordering. Broadly speaking, our system is able to derive a ranking that a group/crowd that includes a very large number of participants would apply to a very large number of ideas and to do that quickly and efficiently. Once the ranking is obtained, the filtering step is simple.

Let us use the specific example of a group of 10,000 people with 10,000 ideas that need to be ranked. In a group/crowd of 10,000 people, everyone has his/her own ideas, opinions about the value and ranking of his or her own ideas, as well as opinions on appropriate values and rankings of all of the other group/crowd member's ideas (if they had the time to hear them all). The techniques described here can allow that enormous amount of information to be collected and filtered. For example, suppose a collection of ideas, items of text, audio, pictures or video is found or generated. In some examples, to find the group/crowd's consensus opinion or ranking of those ideas, each of the 10,000 participants would typically need to review, judge, and rank the submissions of the other 9,999 participants (order them best to worst). At that point, an averaging of the 10,000 ranking lists could take place. The result would be the group/crowd's consensus ordering, i.e., their favorite submissions/ideas would be known. This would be an example of the group/crowd deciding on which members of the group/crowd had ideas that were worth following up on. Participants can also add an addendum to each idea as they are exposed to and think about the ideas, e.g., further develop the idea, or add a new idea. Therefore, the body of ideas that are under consideration in being rank ordered can grow.

If that process were automated and replicated for all the addendums that each idea would “pick up” (or generate) throughout the process and all of the possible edits to each idea (staggering numbers involved) then that particular group/crowd's consensus opinion would be known. In this way, the system will have “heard the group/crowd.” The system described here reaches this result faster.

In some implementations, our system can rapidly filter through subjective data points (ideas) and put them in a rank order. This rank order could match the order that would result from a technique in which each participant evaluates each idea individually. In some cases, numbers can be used as proxies/identifiers for ideas so that the correct ordering could be known and compared to the ordering generated by our system.

One goal for this system is to enable each group/crowd member (or participant) to do minimal work and still allow our system to, as a whole, find the best ideas as if each participant had taken the time to view every idea individually and then agreed as to a collective preference.

The following is an example technique for understanding the system. A number (e.g., one to one thousand) can be randomly assigned to each idea. In this example, we assume that 1 was the worst idea and 1000 was the best idea (i.e., the higher the number, the better the idea).

We scramble/randomize the known ordering (numbers) which puts them into a condition similar to a set of ideas being considered by participants in a group. That is, we can assume that the ideas being considered by participants in the group are in a substantially random order and the goal is to him for a reordering in which the ideas are ordered from best to worst or worst to best. The system realigns the random ordering using limited inputs. Because the ideas are represented by numbers, this is a “blind” realignment. Using numbers as proxies for ideas allows test results to be measured.

To test the system, we then simulated decision making (or individual choosing). We use the words “decision-making,” “ranking,” “voting,” “individual choosing,” “contributing,” “picking,” “commenting,” “participating,” “selecting,” “judging” and other similar terms interchangeably. All refer to participating. We use the term “participating” in many of the other words in its broadest possible sense to include, for example, any action or contribution of any participant or any attempt to communicate, including contributing, inputting, ranking, voting, commenting, approving, and sharing, among others.

In this example technique for testing and evaluating the system, limited inputs are allowed, for example, each participant can only provide ranking or value information that is limited relative to the total amount of input that the participant might provide in a brute force system.

We then randomize the entire list of numbers/ideas and present a thousand simulated users with a random sample of 10 choices. Each participant is allowed to “vote” for X numbers of winners (here we usually allow only a single vote—for the “best” idea). In this example, an idea “wins” as to a participant when it is selected by that participant. Generally, a voter (or participant) is an individual or entity—in our simulation/test, we allow 10 randomly selected numbers/ideas to be “voted” on by allowing the maximum number/idea to be calculated for each scrambled set of 10. This simulates a chooser picking (or participating) his/her favorite(s) from his given list of 10 choices (numbers/ideas). That is the only “local calculation” or input that we allow. Using this data, we can determine whether we can replicate the known order, and whether we can put the entire sequence back in the proper order (from best to worst or worst to best).

So far, we have assumed that the input from the participants is accurate. The example could be tweaked, however, to expect an error rate of some percentage (e.g., X %) in order to simulate fraud (or lying, cheating, accident, incorrectness, etc.). For example, 15% of the voters may be frauds (or just off-consensus). Our simulation then forces 15% of our voting sets (voted upon sets of ideas) to return a minimum or median value (e.g., the worst or average idea) instead of the maximum (e.g., the best idea).

We also tested the ability of the system to handle individual preferences. For example, some participants will choose what the group/crowd as a whole may deem as an inferior choice. To simulate this, the system can force X % of our voters to return a preferred number over a higher number (within a certain adjustable spread). For example, we can make 20% of the voters “prefer” numbers that end in 6 or 7 over all others, as long as the number is within X % (e.g., 15%) of any higher number. In a one thousand participant example, if one thousand is our highest number, then any number over 850 (within the 15% limit) that ends in a 6 or a 7 will be chosen over even the number 1000 itself (our representative of the group/crowd's “most preferred idea”). We then simulate other sub-groups (or subsets of groups) having differing preferences.

The system can then run its algorithm using information obtained from the first round of voting (some of which we forced to be wrong, as described above). A round of voting in this example means that each participant voted once, choosing one of the ten ideas presented to the participant. The system does not take into account the numbers assigned to the idea (e.g., the system does not take into account the notion that idea 1000 is “better” than idea 3).

All that is known to the system in this testing example is which idea which other ideas and which idea won each set (sometimes called voting set or competition set), and thus the percent of each “idea's” ten competitions that the idea won—if any (termed the win-rate for that idea).

We then judge the results. For example, it can be determined how closely the system returned the number sequence (our mock “ideas”) to the correct order. Next, another voting round is allowed to proceed, using only the “ideas”/numbers that the system predicted were the best from the previous round. Each subsequent round of voting has a lower number of surviving ideas, yet the same number of participants/choosers/members. We sometimes refer to this as a type of geometric reduction, which can refer to the number of ideas being reduced after each round of voting and/or finding group consensus with limited participation from each participant (for example, each participant does not need to view and rank each and every idea). Thus, a greater and greater percentage of the group/crowd will be coalescing around the best ideas as the session progresses.

We also have features that allow afterthoughts (or sub-ideas or related ideas or attachments) to be appended to the main ideas—if the group/crowd/group as a whole agrees. Furthermore, we have editing features that let very large numbers of participants make collective edits to the ideas, in some cases in real time.

As an analogy, the brain of a child builds far more neural connections than it needs. It then prunes out the unused pathways. Some examples of our system also do this. In some examples of our system, each group/crowd member has an equal (or good) chance to be heard (either in the sense of that member's idea finding its way to the upper part of the rank ordering, or in the sense of that member's rankings of ideas presented to her are taken as more valuable than rankings provided by other members), but must earn the right to an amplified voice (either because her ideas are ranked high by other participants or because her rankings of ideas are similar to rankings given by other participants in the group). If an idea does not garner enough attention or support, like the child's neural connection, it will be pruned immediately, resulting in a natural selection of sorts. The “best wisdom” (or consensus) of the group/crowd is what is left.

An important feature of this system is that the process is done by giving each user (participant) relatively simple local tasks (e.g., review ten ideas and pick the best). Our algorithms can do the difficult work using the relatively easy to produce individual tasks—and the full power of the group/crowd is utilized.

An example is shown in FIG. 1, where the system is used by a company.

In step 102, a company asks a group/crowd of a thousand customers to give advice on “what our customers want.” To motivate the participants, product coupons can be given to all participants and larger prizes/cash for the best ideas. The company designates a two day window for the session's completion.

As we will discuss later, our system can be used with a fixed initial number or set of ideas and/or a fixed time frame (sometimes called a “synchronous implementation”), or it can be used in an ongoing conversation such as a forum that has no distinct endpoint and/or continually incorporates new ideas (sometimes called an “asynchronous implementation”). In some cases, the asynchronous implementation never reaches and ending time or point. Instead, new ideas are constantly being taken on, low value ideas are constantly being dropped, and a ranking of the currently relevant ideas is constantly being updated.

The example that we are now discussing is a type of synchronous implementation. In the sense used in this example, a “session” can include the following notions: the use of the system for the stated specified goal (here, using the system to find “what our customers want”) and/or the period of time from when participants begin using the system, for example by submitting an idea, to when the group reaches consensus.

In step 104, some or all of the participants submit ideas to the system.

In step 106, ideas are randomly mixed and divvied up for peer review—10 ideas per participant—with no participant evaluating his own idea. This way, each idea is viewed by 10 other users and compared to 90 other ideas.

In step 108, each participant views ten ideas from other participants and chooses the one he/she most agrees with (or the top 2 or 3 ideas).

In this first voting round, no idea is paired in competition with any other idea more than once (that is, as presented to a given participant). This avoids the potential for, say, the second best idea being eliminated by having the misfortune of getting paired with the best idea multiple times (while a marginal idea passes on, through the dumb luck of being paired with 9 bad ideas.)

In step 110, a first hurdle rate is specified to the system. A hurdle rate can refer to the percentage or number of “wins” necessary to move on to the next round of voting/commenting, or the top percentage or top number of ideas that move on to the next round. In this example, the sponsor of the session (the company in this example) specifies the hurdle rate for an idea to pass to the next round—let's say, those ideas that won 30% or more of the 10 distinct competitive sets they were in, get to move on. The sponsor can also specify a certain number (top 100 or top 10%) that get to move on. Ideas that do not move on can be discarded, abandoned, saved for another session, inserted in another voting round (for example, inserting these ideas in small numbers to verify that the group consistently rates the idea as poor), etc.

We use the words “sponsor,” “administrator,” “organizer,” and other similar terms interchangeably. They all refer to “administrators.” We use the term “administrator” in the broadest possible sense to include any individual or entity initiating a particular use of our system, paying for the particular use of our system or setting the ground rules or default settings for a particular use of our system. These include, for example, any companies or individuals initiating a session, and anyone specifying the hurdle rate or number of choices voted on by any individual participant, among others.

In step 112, the system performs another round of voting. Suppose the top 100 ideas, out of the initial one thousand, move on to the next round. They are re-randomized and divvied out to the group/crowd once again—in sets (or competition sets) of 8 this time. This time each idea is seen by 80 participants (as opposed to 10 in prior round). In this second round, each idea may be in competition with another idea more than once, but never more than 10 times in the 80 competitions (and 10 pairings are extremely unlikely).

In step 114, the sponsor again specifies the hurdle rate. For instance, for an idea to pass beyond this second round, say, the top 5 ideas are requested. In step 116, the five ideas with the highest win records (percentage or number of wins) are determined to be the best ideas.

Thus, in two steps (for the participants) the best ideas of the group/crowd are revealed to the sponsor, the group/crowd and any other party that can view the results. Because our platform can limit the time commitment necessary for any given participant, sessions can be as quick as a sponsor wishes. If all participants committed to a specific time to be online, a session such as the one above could be completed in minutes (regardless of the number of participants). Our system uses algorithms and processes that have the ability to shortcut the work involved in screening through a thousand ideas (or 1 million ideas) in an accurate manner. These methods will be described below.

There are many examples of the flexibility of our system. For instance, sessions can be tailored in terms of number of participants, number of rounds, ideas per set, hurdle rates, and even selective groups of participants. Furthermore, those who contribute ideas can be distinct from those who vote.

Many other possible features in our system can allow the group/crowd to have hands-on control of the process described above, such as collective editing and idea augmentation/amplification (described below). Also, our system can include feedback mechanisms to allow our system to be a true two-way communication tool.

Some implementations of our system can be tailored to display and process ideas in any medium (including text, music, video, images, graphs, among others), so that any possible idea can be a handled by our system.

Conversations involving more than two participants are often characterized by exponential compounding of communication complexity. In a two person conversation of only three statements each, the two parties are able to express an idea, get a response from the other party and then re-respond in kind. This could be described as a give and take or a back and forth.

1 statement garners 1 response which in turn garners 1 response, etc. until the conversation is complete.

The following is an example of a 3 round conversation between two people (6 ideas expressed total):

1+(1×1)+(1×1)+(1×1)+(1×1)+(1×1)=6 ideas expressed. (i.e., 1 statement+(1 response to 1 statement)+(1 re-response to 1 response)+ . . . )

As an example, if an idea were given twenty seconds to be expressed, in our two person conversation, the total time involved would be 6 ideas×20 seconds, or two minutes.

The following example is of three people in a give and take conversation:

1+(2×1)+(2×2)+(2×4)+(2×8)+(2×16)=63 ideas (i.e., 1 statement+(2 responses to 1 statement)+(2 re-responses to 2 responses)+(2 remarks to 4 re-responses)+ . . . )

In this three person conversation, the total time involved would be 63 ideas×20 seconds, or 21 minutes.

An eleven person conversation would have 111,111 ideas to express and entail 25.7 days of nonstop speaking

Geometric compounding (more people, many more ideas) can be addressed by our system. For instance, our system can use algorithms that achieve what we sometimes call geometric reduction, which can refer to the number of ideas being reduced over time or bad ideas being abandoned and/or finding group consensus with a reduced (limited) participation from each participant (for example, each participant does not need to view and rank each and every idea).

A selection of the many possible uses of this system is described below.

Some examples of our system can be used by companies. Potential inter-company applications include sourcing, supply chain improvement, collaboration, product development, and many others. Potential intra-company applications include software development, process improvement, six sigma, ISO, performance management, and many others.

Specific Examples Include:

(1) Employees to Company:

Some examples of our system can be used to help companies efficiently communicate and act. For example, one such system, called Bureaucracide, is a communications platform being developed by Group/crowd Speak Inc., for corporate use.

Some examples of our system can be used to help management hear its employees. For instance, sometimes employees have a better local knowledge than “corporate” (management), and this system can help employees share and communicate this knowledge.

Some examples of our system can help giant businesses act like startups in some ways. This can enable a large company to, for example, have the benefit of a large company's resources and the benefit of a startup's high level of communication amongst employees.

(2) Product Development:

Some examples of our system can tap into the knowledge of an organization or population, in some cases in real time.

To enable and encourage collaboration, our system can recognize and/or compensate the source of useful ideas or contributions. For example, a solution-root payment method can be used, which can identify the “root” (or participant who was the source of the good idea or solution) and recognize or compensate that participant. In some cases, this will encourage the freer flow of ideas.

An example: Suppose there is a need for a product that does not yet exist—say it's an offshoot of the Post-it note made by 3M. If I knew that I could enter my idea using a version of the system described here that was sponsored by 3M, and if I trusted that if my idea was voted to a winners list, that I would be fairly compensated, I may be motivated to share my idea using this process.

Some examples of this system can help generate good ideas (including potential products or services) to be used in a company's fixed cost infrastructure. This can enable companies to be more productive without incurring substantial additional costs.

Some examples of our system can let companies conduct test marketing on products as they have their customers source (find or come up with) and choose and collaborate on potential new ideas. From a business perspective, this could dramatically lower the risk of a new product launch. 10,000 (pick a number) of a company's customers could “tell” that business exactly what they want in a group sense. A company may even request order commitments as a condition for them to tool-up for the manufacturing process (e.g., on higher risk products).

The payments to the group/crowd can be based on future sales! In this example of the system, the company may have motivated the group/crowd to (a) buy and (b) promote others to buy. In some cases, this could be a very valuable advertising mechanism.

(3) Innovation:

Some examples of our system can enable product creation. For instance, multiple group/crowds of innovators could collaborate on the conception, design, marketing and/or sales of a new product or service, a form of group/crowd sourcing in the extreme. For example a group/crowd of potential customers with the help of a company's research and development department (ALL of them), or a group/crowd of legal experts and a group/crowd of engineers, might use this system to bring a product from conception to market, possibly in record time.

(4) Labor Negotiations:

Some examples of our system can be used to assist labor negotiations. For instance, the system can be used to determine the priorities of employees and enable direct and open dialog.

Some examples of our system could focus on the customer.

Potential applications of our system include advertising, customer communication with the company (for example, product enhancement and development), and communication with and to the general public.

Specific Examples Include:

Customers to Companies: Listening to customers is a crucial ingredient in building customer loyalty. In some examples, our system allows companies access to their customers' consensus-driven best ideas.

Some examples of our system also allow customers access to the “ears” of the top executives in an organization—those who can actually effect change (unfiltered through the bureaucracy).

In some examples, our system can be used as a model for generating advertising revenue and evaluating the success of advertising. For example, this system can determine if a potential customer actually thought about a company's product or service—enough to form a valid idea or suggestion—and then viewed other people's thoughts and chose the best. The system can also, for example, determine the quantity of time the potential customer was involved (for example, the session length, measured in minutes over X hours or X days). We have a method (described later) to determine fraud.

Our system also has the capability to allow the sponsor to incorporate targeted advertising (during any down time in the session).

Some examples of our system can be used to determine a group/crowd's thoughts. In some examples, our platform can be used spontaneously by group/crowds that gather to deliberate on an issue, problem or idea. Normal targeted ads (tailored by the group/crowd's subject matter) can be displayed.

Much work has been done that shows that under the right circumstances, group/crowds can come up with very sophisticated solutions to problems or questions. In some examples, this system can tap the value of the group's brainpower.

Some examples of our system can also archive group/crowd thoughts. In some examples of our system, after any given session is complete, the findings/conclusions can be, for example, posted on a website, archived by topic. Similar archiving can be done on a running basis as an asynchronous use of the system progresses over time.

These valuable insights may draw others who wish to tap into the conclusions. Advertisers can post targeted ads in normal fashion, but, in some examples, the payments could be split between the host website and the participants that came up with the ideas. Our system can pay different percentages to different participant/users based on a determination of contribution level (measurable with our algorithms/system).

In some situations, each session or application of the system can contain vast amounts of information (more information than makes it through to the end of the session/application). In some examples of our system, this can be archived or saved for all to view. The “roots” of the entire session (e.g., all ideas and comments generated) can be explored for many reasons, in many ways. Perhaps a participant wants to look for a sub-group, with concerns that more closely match her own. That sub-group can be tracked down, contacted if they choose to be, and band together. Perhaps the session's sponsor wants to dig deeper into the ideas of all the participants—even those that did not end up as the consensus's choice.

Other potential applications of our system abound. Users themselves will undoubtedly create many uses for our system that we have not thought of yet. Ironically, they could use our system to decide on how best to use our system. Some potential applications include:

(1) Conversations Between Groups or Between a Group (or Groups) and Individuals:

In some examples of our system, one or more group/crowds can speak to or communicate with one or more other group/crowds or individuals. One specific example of this is the platform called Group/crowd Versations™, a group communications tool being developed by Group/crowd Speak Inc. In some examples of our system, a large group of people (or a modest size group) is able to hold a literal conversation with another group—group/crowd to group/crowd. Or group/crowd to individual.

In some examples, we let the group/crowd decide on each line of a conversation with another group/crowd (or individual) answering back. For example, using two levels of geometric reduction (or two voting rounds to generate a group consensus on a line of conversation), we can lob lines of conversation back and forth between huge group/crowds, and this can be done quickly in some cases. The speed of group communication can depend, for example, on how fast you want to make the group/crowd members think/type/record audio—1 minute rounds of conversation could be possible.

In specific examples, Harvard (ALL of it) might debate Yale, or Princeton's economic majors could have a conversation with the ex-Fed Chairman Alan Greenspan. Remember, this is not any individual group/crowd member doing the talking—it's everybody at once in the aggregate, as a group/crowd. It's the best the group/crowd has to offer, and all get a say.

In other specific examples, this system could enable a reconciliatory mega-chat (conversation involving a large group) between 1 million Republicans and 1 million Democrats. Or all the members of the U.S. Congress could collaborate on a bi-partisan bill such as health-care reform—with the help of 100,000 doctors able to speak with one voice.

In some examples, communications or conversations involving group/crowds can be archived and replayed later—using text or audio/video read-backs of the transcripts.

(2) Smart Forums:

Forums (e.g., online message boards, chat, listserv's, customer feedback, rating systems, and wide variety of others) abound on the internet. Using some examples of our system, forum sponsors can go from normal forum mode to a quality filtered forum and back again—rapidly filtering out the marginal ideas during the filtered forum mode.

(3) Pop Culture:

Using some examples of our system, cultural sessions or experiments could take place.

One example of an application of our system involves music. For instance, a group/crowd could—line by line—submit and filter lyrics to a song that the group/crowd would eventually create. A thousand different musicians/garage bands could then attach music to the lyrics and the group/crowd could vote to pick their favorite (possibly in very short order). In effect, in this example, the entire group/crowd will have written the song. If this session was sponsored by a major record label, this whole session could act like a giant interactive, multi-day commercial.

(4) Collective Bargaining:

With some examples of our system, it would be possible to assemble a large group of people to use their numerical strength to bargain for goods. For instance, a group/crowd of car enthusiasts could collaborate and communicate with each other, decide on a collective offer to present to one of the major car companies and get a major discount in return for 50,000 orders.

(5) Governmental Usage:

Some examples of our system can be used by the government, including for emergency coordination efforts, and military communication.

Some of the examples of our system can be used for community involvement, including use by or for city councils, and philanthropic collaborations.

(a) Municipalities:

Some examples of our system can encourage citizens to interact with local government and municipalities, even if they have limited time or resources, and can ensure that those citizens with the most useful or helpful input (e.g., those with business savvy or special talents) are heard. Furthermore, local advertisements could be sold on such a site, or the system could be deployed under license.

(b) Emergency Coordination Efforts:

When speed is mandatory, some examples of our system can let all parties communicate rapidly. For instance, everyone at FEMA could literally talk to everyone at the Red Cross. Coordinated prioritization and action is also possible with this system.

(c) Soldiers to General:

Using some implementations of our system, the soldiers on the front lines can communicate critical insights to their commanders. For example, the system can be used to determine what is working, what is not and what is dangerous. This system could allow an entire army to develop new tactics and practices and then share these insights with each other.

Public examples of this system could generate advertising revenue in a model where customers interact with sponsors (corporate, social networks or otherwise). When users interact with sponsors through the platform, captured proof of mindshare (for instance, that customers are paying attention to the sponsor or its message) could be used as a metric on which to pay for advertising. Examples of this system could include options to engage the group/group/crowd. In some examples, since participants could be given coupons and rewards, at the end of the exercise it could be clear how many products were sold as a result of the session as those coupons or rewards were redeemed.

Private examples of this system may be tailored for group problem solving and group communication. Business models for this system could be license-based. Private examples of this system could be used by corporations, government agencies, municipalities, private groups, etc.

Some examples of our system could be delivered via an internet site or mobile app or a combination of the two or through other platforms with different environments/sections. Other examples of our system could be plug-ins that could be usable by any party that hosts any sort of conversation or communication among a group on any kind of platform, including social network engines, email systems, blogs, online publications with comments, etc. For instance, the plug-in could be delivered in a software-as-a-service (SaaS) model or as an application to be installed, or in any other practical way.

As shown in FIG. 2, an example of our system could provide the following features: (a) a user interface 202 that enables users to input ideas and indicate choices among presented items, and can present to users a current rank ordering of items based on the group/crowd's choices, along with a lot of other possible features, (b) a back-end engine 204 that could receive input representing the choices, crunch it to derive information about the group/crowd's rankings, update a current rank ordering, and output the rank ordering to various parties for various purposes (e.g., using the algorithms described later) (c) a process 206 that can build the choice displays and provide them to be exposed to the users (e.g., using the algorithms described later) and (d) an administrative interface 208 to enable authorized parties to control the operation of the engine and the appearance of the user interface. The back-end engine 204 process 206 can run on a server 210 or other computational facility (or collection of servers or other facilities).

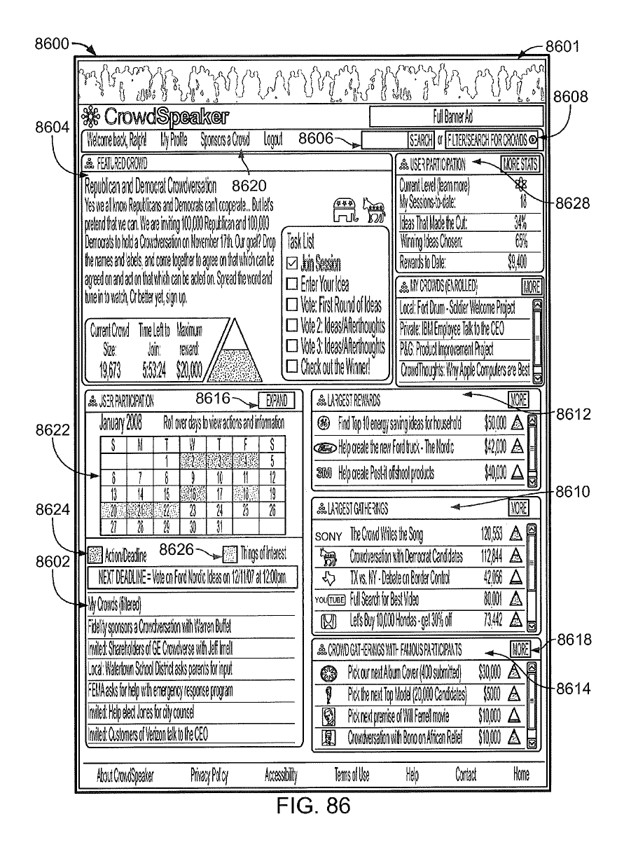

For example, FIG. 86 shows a screenshot 8601 of a user interface (here, a main page of an internet site exposing our system to users). In some examples, for instance in some internet site examples, different forms of our system (e.g., product development, generating a song, conversations between group/crowds, etc.) can be accessible from the main page. For instance, the main page can show the different sessions in which a particular user is participating (or enrolled) 8600. It can also show sessions in which a user may interested or to which the user has been invited 8602. In some examples, group/crowds that happened to be gathering that had a common interest with a user could be displayed. In some examples, there can be a tailorable interface for individual users. A featured group/crowd 8604 could be displayed. The page could also have a search field 8606 allowing for site searches or a group/crowd search button 8608 allowing for searches for group/crowds. Some examples could also have an indicator showing the “hottest” group/crowds such as fastest gathering, largest gathering 8610, least available % of free seats, largest rewards 8612, group/crowds with famous participants or sponsors 8614, etc.

A button, such as an “expand” button 8616 or a “more” button 8618, could be available to expand lists or get more information. In some examples, a “Sponsor a Group/crowd” button 8620 could be available, allowing users to sponsor a new session or gather a new group. In some examples, a calendar 8622 could be shown, which could include reminders or notices about upcoming deadlines 8624 and/or possible things of interest 8626. Individual user participation statistics 8628 could also be available for view.

In some examples, our system can include a gathering phase to gather or attract participants. In some examples, participants are already assembled or known, or individual participants come and go over the course of voting and communication. If gathering is necessary, the system could include, for example, an explanation of why a particular group/crowd is being assembled or what ideas will be requested. There could also be a list of rewards for different levels of participation—from coupons for all participants to rewards (such as new cars, nationwide recognition, etc.) for contributing the best ideas or for contributing to the best ideas.

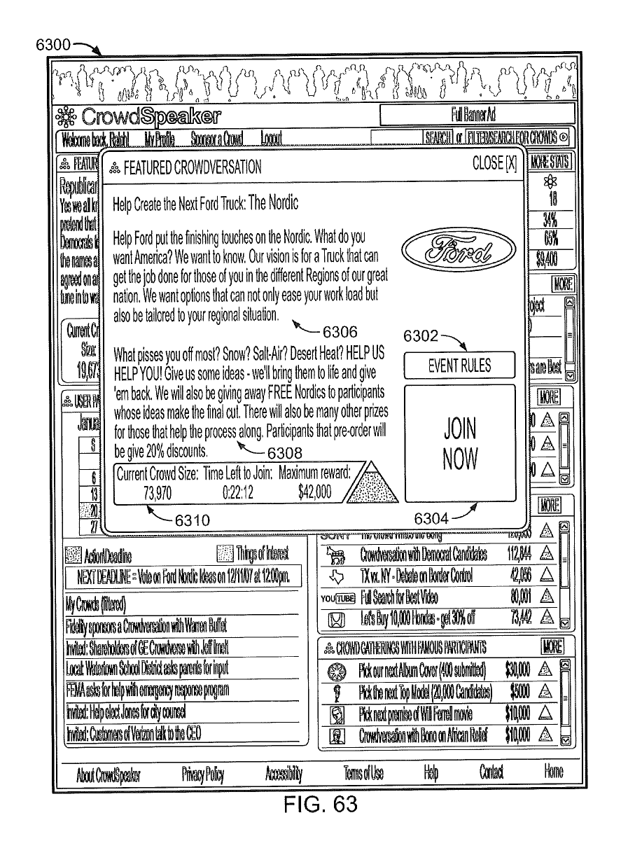

For example, FIG. 63 shows a screenshot 6300 of a featured session during a gathering phase. An “Event Rules” button 6302 could be available to explain the rules chosen by the sponsor. A “Join Now” button 6304 could be available to allow the participant to join the group. Explanations of the group/crowd goals 6306 and/or explanations of the rewards 6308 could be shown. Group/crowd statistics 6310 could also be available for view, including, for example, information on the current group/crowd size, the time left to join the group and the maximum reward available.

In some cases, the next step would be for each participant to enter an idea (including audio, video, text, or other media). In other examples, only some of the participants enter ideas, or the ideas are already generated or gathered by the sponsor or other parties.

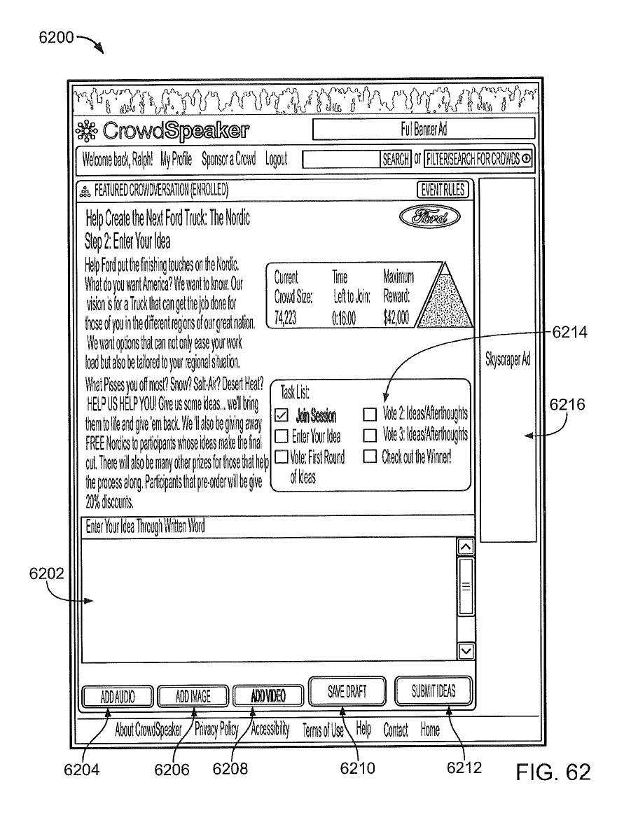

For example, FIG. 62 shows a screenshot 6200 of a session at the stage in which a participant enters his/her idea. A text box 6202 is available for the participant to enter his idea using the written word. An “add audio” button 6204, an “add image” button 6206 and/or an “add video” button 6208 could be available for the participant to input or supplement his idea with an audio file, an image or a video, respectively. A “save draft” button 6210 could be available so that the participant could finish inputting his idea at a later time. A “submit ideas” 6212 button would allow the participant to submit his idea. A task list 6214 could be shown that outlines the steps needed to complete the session, and which steps have been completed. Advertising 6216 could be displayed.

In some examples, each participant (or some of the participants) views a certain subset of ideas. For instance, each participant can view 10 other users' ideas. Each participant can, for example, choose a winner (or loser). Some sessions may request additional rankings, for example 1^{st}, 2^{nd} and 3^{rd} place. In some examples, the viewing and selecting of ideas can be done using the Rapid Decision software being developed by Group/crowd Speak Inc.

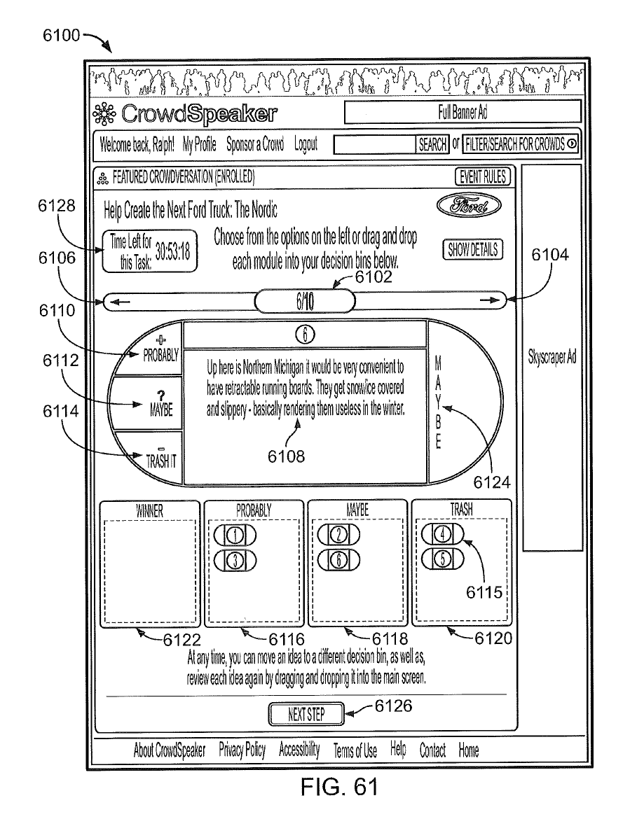

FIG. 61 shows a screenshot 6100 of a specific example of our system during an initial viewing and voting step. Each of the ten ideas can be presented individually. A progress label 6102 can show which of the ten ideas is currently being viewed, and a forward arrow 6104 and backward arrow 6106 could be clicked to move between ideas. Each idea 6108 could be presented individually, with option buttons such as a “probably” button 6110, a “maybe” button 6112 and a “trash it” button 6114. When one of these options is selected, the idea's number 6115 can be placed, for example, in an appropriate organizing-bin (including a “probably” organizing-bin 6116, a “maybe” organizing bin 6118 and a “trash” organizing-bin 6120), and the next idea can displayed for review. Drag and drop features can also be enabled. This tool can allow for the rapid screening and selection of ideas. In some examples, the user can re-evaluate and change the ranking for the ideas, either by clicking the arrows 6104 and 6106 to move between ideas and select a new option button, or by dragging and dropping ideas within the various organizing-bins 6116, 6118, 6120 and 6122. A status indicator 6124 can show the current voting option selected by the participant. Once an idea is placed in the “winner” organizing-bin 6122, the user may press the “next step” button 6126 to submit his/her vote and move to the next step. A timer 6128 can show how much time is left for the task (e.g., the choosing of a winning idea) to be completed.

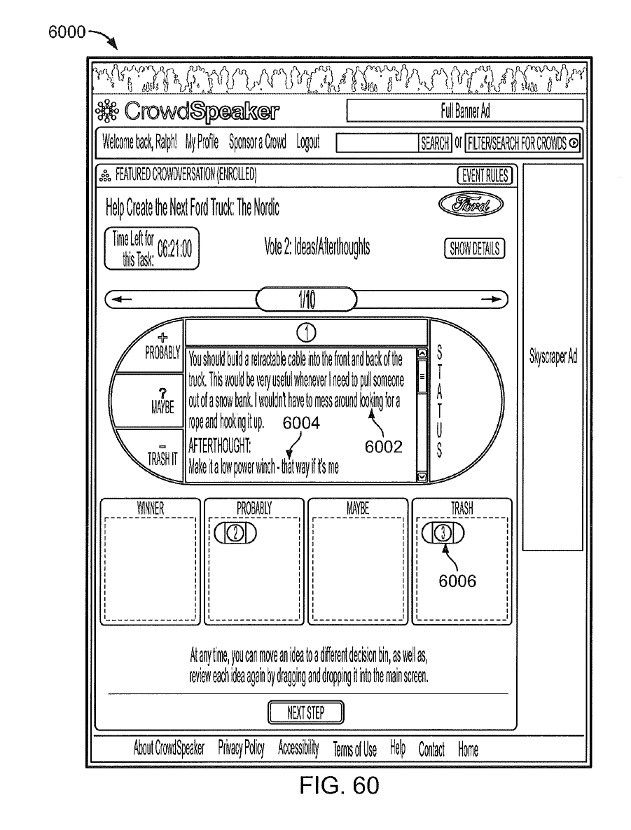

FIG. 60 shows a screenshot 6000. In some examples, participants can also group/crowd-edit and/or add an afterthought 6004 to any idea 6002. Group/crowd-editing and adding afterthoughts are described below. Some versions of this system may ask a participant if he/she wants to group/crowd-edit or add an afterthought only to the participant's top ranked idea(s).

In some examples, a participant who chooses a particular idea can be allowed to attach an afterthought to that idea. Using algorithms that achieve geometric reduction, many afterthoughts (or related ideas or sub-ideas or attachments) can be processed quickly, with only the group/crowd's favorite few attaching to the idea. It is possible to operate the system in such a way that participants can also add new ideas that are at the same level hierarchically as the ideas that they are judging. Afterthoughts can be considered ideas of the hierarchically lower level than the original set of ideas. The processing of afterthoughts can be focused on only those ideas that are afterthoughts for a given higher-level idea. Conversely, the processing of additional top-level ideas can proceed in the same way as the processing of the original top-level ideas.

This augmentation of ideas can be crucial in building a group/crowd consensus because it can help ensure fair and equal presentation and selection of afterthoughts representing the group's consensus.

Another critical component of any communication is the ability of one party to ask for clarification from the speaking party. In some examples of our system, a participant can, for example, ask for clarification from the source of the idea. Furthermore, for the communication and ideas to be truly shared ideas, each communicator (each group member) must have the ability to edit a given idea. In most cases, only agreed upon edits are allowed. In some examples of our system, an unlimited number of users can have an equal voice in suggesting edits and choosing amongst all of those suggestions. In some situations, this can be done in extremely rapid fashion.

Therefore, in addition to top-level new ideas and afterthoughts, participants can engage in clarifications and ranking of edits of existing ideas. In the broadest sense, any structure or hierarchy of ideas, new ideas, and supplementations of ideas can be allowed and can be the subject of the processing sequences.

An example of group/crowd editing is as follows:

If a participant has voted on an idea, he or she may recommend an edit. In other examples, participants can recommend an edit even if they do not vote on the idea.

Multiple options exist for signaling an opinion or a question or a ranking about a given word, phrase or section of an idea. For instance, in some examples, a participant may simply click on an edit-tool icon, and then “paint” or “swipe” the sentence or section or words on which they wish to comment. In other examples, the participant may be able to edit directly or add a comment in a comment box.

In some cases, a participant may have liked the idea, but wishes for the user/author to clarify a specific sentence. Some examples of our system can allow a participant to click a “please clarify” icon (such as a question mark) and click near or swipe over the sentence (or any part of the idea) in question. In some examples, if a critical number or percentage of users ask a question on that phrase (or section of video, audio or graphic), that section of the idea can be highlighted or flagged for all to see.

In some examples, the user who submitted the idea can be given a chance for a redo, and then the group/crowd can decide if it is better or worse than the original. That is, a revised idea can be ranked or judged as part of a set of ideas, including the original idea from which the revision was made.

Alternatively the group/crowd may be allowed to submit possible edits to the section. Then, using an algorithm that achieves geometric reduction to lighten the work load, the group/crowd can choose which correction to run with. In other examples, the final conclusions can include the original idea with some (e.g., the best) or all proposed edits. In other words, the ranking and judging of ideas and the geometric reduction can itself be done hierarchically, sometimes at a high level and sometimes at lower levels.

All sorts of icons/edit-tools could be included that a participant could use to provide feedback, such as: Clarify, Elaborate, Too Strong, Too Wishy-washy, Too Vulgar, Tone it Down, Tone it Up, Boring, I Like This, I Don't Like This, I Think This is Wrong, I Know This is Wrong.

Other tools or options could also be included. The icons could be question marks, up and down arrows, emoticons, thumbs up, thumbs down, crosses, etc. Any device, mechanism, procedure, software, app, control, or user interface feature by which a participant can indicate a value of an idea alone or relative to other ideas can be used.

In some examples, if a given percentage of the group/crowd swipes a section, it is apparent to other users and/or the sponsor. Furthermore, in some instances, the higher the percentage of the group/crowd that swipes, the “louder” the indicators become (e.g., faster pulsing, brighter color, larger indicator, etc.).

For any submitted idea there may be many edits that the group/crowd deems necessary. The following demonstrates several possible options that can be accommodated using examples of our system. For example, if some of the group/crowd decides a word is too vulgar, it can be indicated. If others in the group/crowd (e.g., more than a certain specified percent) think it too strong, that may also show up. To avoid overlap, some examples of our system may show the idea (say a paragraph) and show the icons (or other indicators) that were activated by the group/crowd's edits. In some examples, when the author (or others viewing the idea) clicks an icon, just that “problem” shows up. We can also use colors to denote severity of opinions. As the text or idea gets changed—if for the better—the icons can disappear as the group/crowd signs off on or agrees to the changes. Or the group/crowd may vote in their own edits using the method described above.

For other types of media, including video, images, graphs, and audio, among others, the group/crowd editing features may be a bit different. In some examples, users could have the ability to click the same icons, and indicate, for example certain time periods on which they wish to comment. For example, if X % of the group/crowd depresses the “Too Vulgar” icon during a sequence of the video, it can get flagged—a transparent icon can get embedded in the video, such that all can see the group/crowd opinion. Also, there could be a time graph for any relevant variables. For example, if the video was 30 seconds long, the group/crowd could give some nuance to when it was exciting/boring or when they collectively agree/disagree. FIG. 3 shows an example of a time graph 300 for a 30 second period in which the group collectively felt positively (e.g., liked, agreed, found exciting) during seconds ˜6-15 302, and then felt negatively (e.g., disliked, disagreed, found boring) during second 2-26 304. In the beginning (seconds ˜2-4) and end (seconds ˜25-30), the group/crowd was neutral.

In some examples of our system, participants may be able to use fragmenting or snippet capabilities. For instance, participants may be able to strip off fragments of ideas from the submissions they see (e.g., by highlighting those fragments). The fragments may then run through a ranking engine of the kind we describe (combined into voting sets, ranked, etc.). In some examples, a group of top fragments may be reordered or reorganized (e.g., in a logical time sequence, irrespective of the ultimate quality rank) and recombined to form higher level ideas for ranking.

In some examples, after one round of voting and/or commenting, each participant (or some participants) could get a new set of ideas on which to vote (this could be 5 minutes later, 2 days later or 2 years later). In some examples, these would be only the filtered good ideas—the ones that “passed” the previous round's voting hurdle. These could also be mostly good ideas, with a handful of “losers.” In some cases, after a participant chooses a new favorite from his/her new list, he can be presented with a further choice of 3 (or more or less) afterthoughts or edits that have been attached to their selected idea (these afterthoughts can be the ones submitted during the previous voting round). These 3 afterthoughts may, for example, be presented at random to any individual participant.

There may be any number of submitted afterthoughts for the chosen idea, but each participant only needs to choose from the three (or some limited number) that were presented. In some cases, they also may choose “None of the above.” Thus, the group/crowd of users who chose an idea may get to decide on the afterthoughts or attachments. The same algorithm can be used to divvy up the initial ideas can be used to divvy up the work of choosing attachments. After this round of voting on afterthoughts, the ideas that pass the hurdle into the third round can have the top afterthoughts appended.

In some examples, after each participant has chosen his/her favorite idea/afterthoughts, he/she can again be allowed to submit further afterthoughts (sometimes called sub-afterthoughts, illustrating a third level of the hierarchy) and use the group/crowd edit features. These sub-afterthoughts and edits can be voted upon by the group/crowd in the next voting round. With a greater and greater percentage of the group/crowd coalescing around the remaining ideas, a true and fair consensus begins to form. The group/crowd can once again be presented with the top ideas from the last round. In some examples, these ideas are the best of the best, as are the afterthoughts. Again the participants can choose.

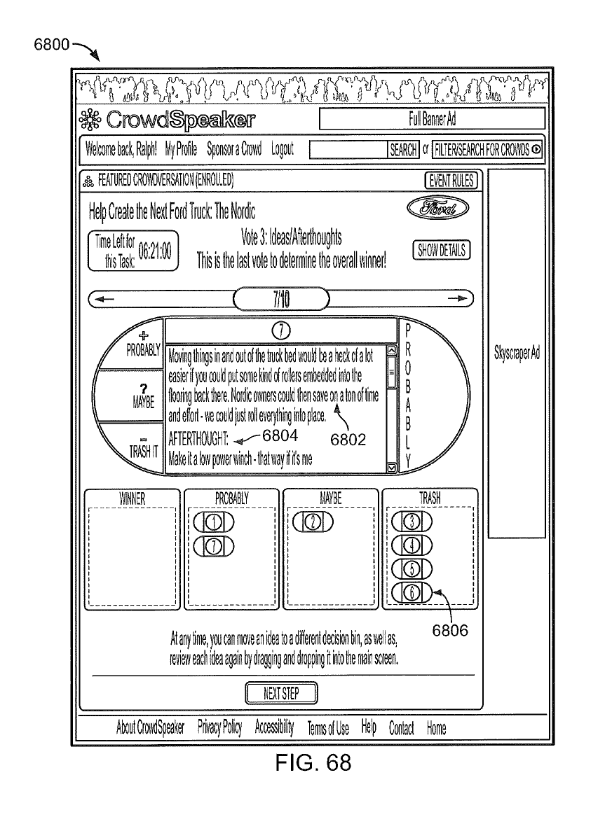

For example, FIG. 68 shows a screenshot 6800 of a third and final voting round. The participant is presented with ten top ideas (ten ideas that have made it through the two previous rounds of voting). Each top idea 6802 is presented individually along with the afterthoughts 6804 agreed upon by the group/crowd. These top ideas (with their afterthoughts) can be voted on and/or sorted in organizing-bins by dragging and dropping the numbers representing the top ideas. Many of the same features from FIG. 61 are available here.

Finally, the group/crowd has been heard—fairly and completely. The best ideas can be known, the originators can be known, and the contributors can be known. In some examples, everyone who had a hand in the idea creation can get proportional credit and/or payment.

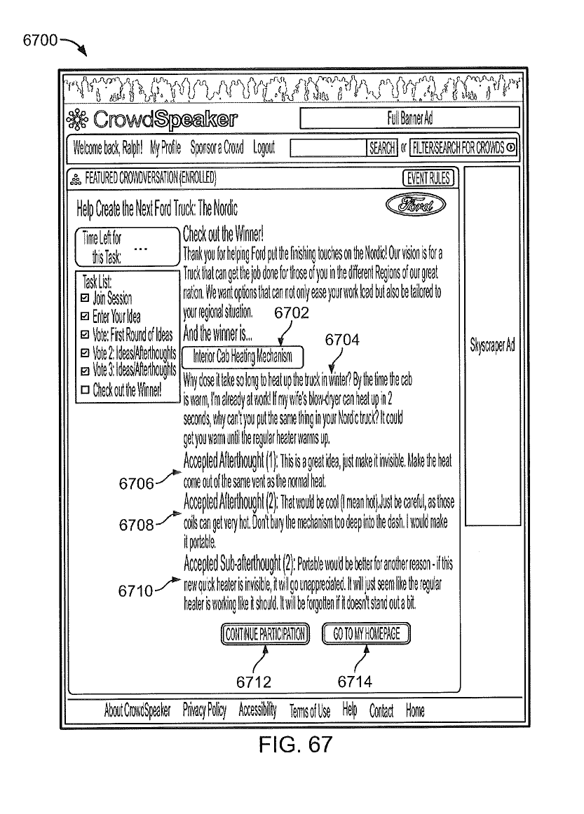

FIG. 67 shows a screenshot 6700 displaying the selected winner. The winning idea's title 6702 and description 6704 are presented, along with the top two winning afterthoughts (the first place accepted afterthought 6706 and the second place accepted afterthought 6708). In this example, a group/crowd-chosen sub-afterthought, appended to the second place afterthought, is also shown 6710. The participant has the option of either pressing the “continue participation” button 6712 (and, for example, being part of an action group/crowd (described below)) or pressing the “go to my homepage” button 6714 to return to the participant's homepage.

The end result is one (or a few) best ideas that can be discerned, in some cases, with the high speed collaboration of an unlimited number of people. The process above is only exemplary, and that for specific applications the process may be different. For instance, for a group/crowd to write a song, the source of ideas may be different for lyrics and for music. In assessing new military operations, the sponsors may wish to be able to flag and remove specific ideas manually without having them go through the voting process. Certain applications may not allow the group/crowd to edit or add afterthoughts.

Furthermore, as discussed in more detail below, asynchronous examples of our system can constantly incorporate new ideas (at one or more levels of hierarchy) throughout the process and do not need to have a specific end. Individual participants may also come and go as the process proceeds. This could, for example, be applied in a typical online forum or feed, such as the Facebook news feed, a Twitter feed, or an ongoing online discussion of any kind Instead of ending with one final set of ideas, asynchronous examples of our system can present the current, changing group consensus.

In some examples of our system in which a set of top ideas is developed, the session may end or it can continue on as an “action group/crowd” (described below) with, for example, the top handful of contributing users acting as the group/crowd's elected action committee. Other individuals or entities could also be on the action committee (described below).

FIG. 4 shows one possible make-up of the action committee. The participants who contributed the best ideas, best afterthoughts, and best sub-afterthoughts could go on to be members of the action committee. In some examples, the leader of the action committee can be the person who contributed the best idea. Those who contributed the best afterthoughts, in the second tier of FIG. 4, could direct those who contributed the best sub-afterthoughts, in the third tier of FIG. 4.

The action group/crowd may serve one of several functions.

In some examples, an agenda can be written up by the action committee. Depending on the particular application, this agenda could be posted and could be group/crowd edited continuously. In some examples, each member of the group/crowd (now an action group/crowd that is implementing, using or developing the group consensus from the voting rounds) could be given a toggle switch that denotes his/her opinion of the group/crowd's direction. For example, you may have voted for the winning idea, but disagree with the current direction of the group.

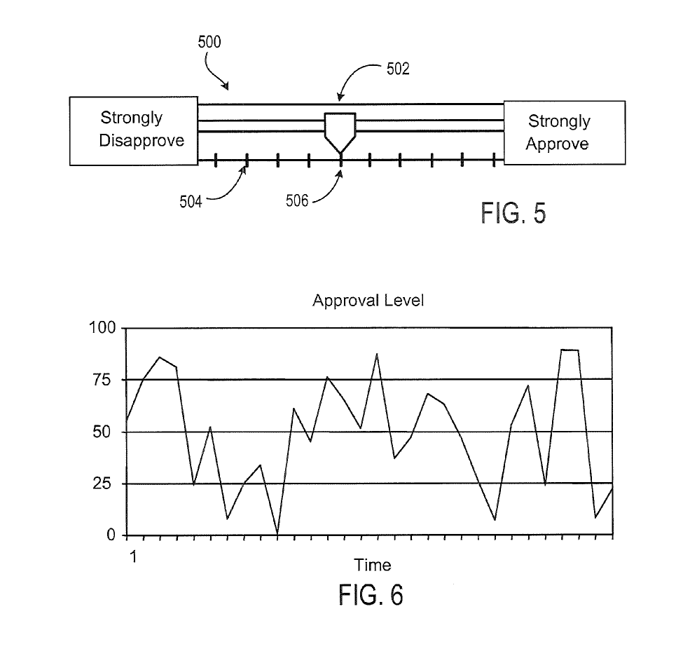

FIG. 5 shows one example of a toggle switch 500 that could be used to denote the opinion of a participant. The participant could slide the toggle 502 to the right or the left depending on his/her opinion. As the tick marks 504 get farther from the middle position 506, they indicate stronger opinions.

The collective opinion of the group/crowd can be collected and shown on a timeline graph. In some instances, this can be available for all to see. In some examples, the system can be tuned so that the action committee needs to keep the group/crowd on board or risk losing some of the reward money or other consideration.

FIG. 6 shows one example of an approval level graph. The x-axis represents time and the y-axis represents percent approval. In this example, as time goes by, the group/crowd's approval of the action committee varies considerably.

In some cases, a priority list can be generated that describes the most important actions and considerations.

In some examples, the group/crowd can prioritize the list (e.g., using the Group/crowd Prioritizer tool being developed by Group/crowd Speak Inc.). In some cases, the action committee's priority list can be shown three different times, showing (1) the action committee's ordered priorities, (2) the group/crowd's preferred ordering of this to-do list and (3) the individual user's list (in which the line items can be moved up or down). Each user can alter the ordering of the third list according to his/her personal opinion of priorities. The collective average of the individual user lists can be displayed as the group/crowd's version of the priority list. In some examples, any differences between the group/crowd's list and the action committee's list could require a valid rationale from the action committee.

Simpler voting tools can also be applied, such as simple yes/no votes or polling.

More advanced group abilities such as decision markets could be used. In some cases, this requires assembling enough people and giving them some incentive.

In general, our system could be delivered via many different user interfaces with many different options. For instance, any button on any screen could be voice activated, clicked with a mouse, or touched on a touch screen, among other mechanisms. In addition to those user interfaces described above, there are many other examples.

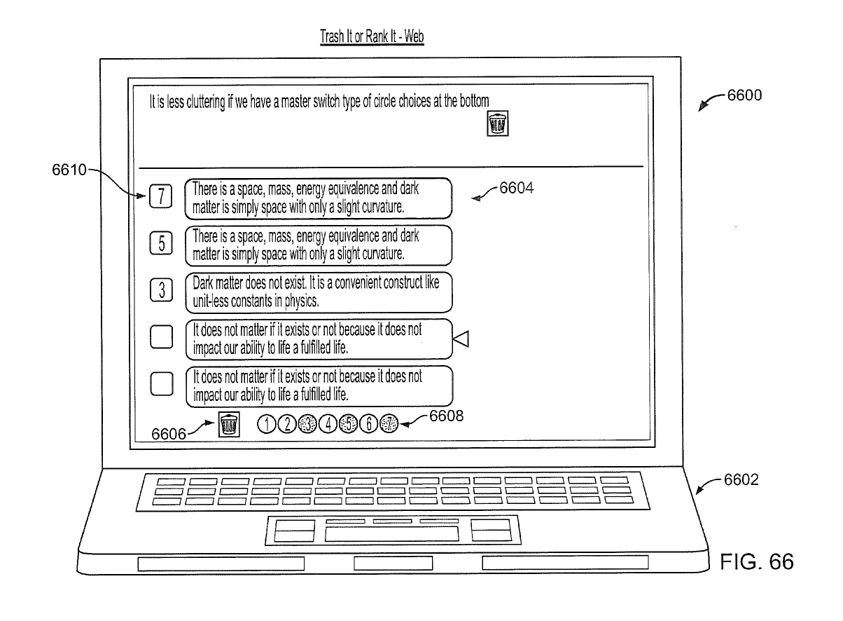

For instance, like FIG. 61 above, FIG. 66 shows a screenshot 6600 of a voting round conducted on a computer 6602. In this example, a participant is presented with a list 6604 of several ideas at once and is asked to rank the ideas on a scale of 1 to 7 (with 7 being the best), or trash ideas that are really poor. A trash button 6606 can be used (or pressed or clicked) to trash ideas. Here, ranking numbers 6608 represent the participant's opinion about the ideas, with 7 being the highest (or best idea) and 1 being the lowest (or worst idea). Once one ranking number 6608 is assigned to one idea, that number becomes gray so that it cannot be assigned to another idea. Once a participant ranks an idea, the idea's rank 6610 appears next to the idea. The ideas are listed in the order they are ranked, with top ranked ideas appearing higher on the list.

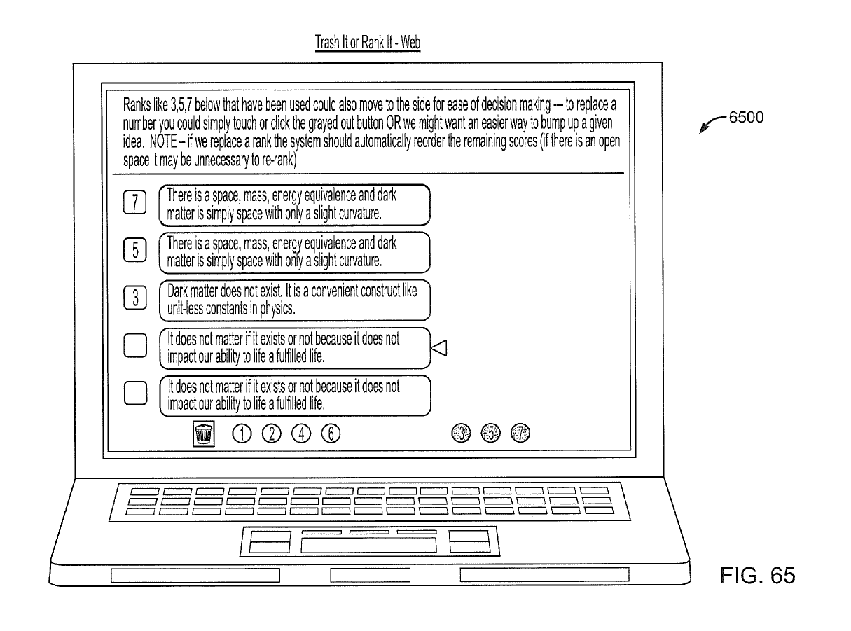

FIG. 65 shows another screenshot 6500 of a voting round. This screenshot is similar to FIG. 66, but the ranking numbers 6608 turn gray and move to the side once they are assigned to a particular idea.

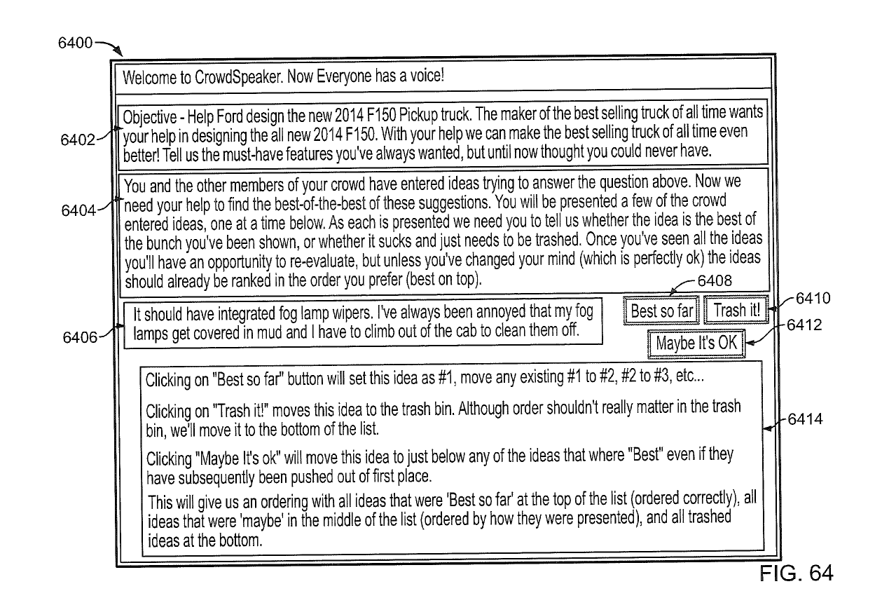

FIG. 64 shows another screenshot 6400 of a voting round. In this example, the objective of the session 6402 appears at the top, and instructions on voting 6404 appear below. Each idea 6406 is presented one at a time to the participant. For each idea 6406, the participant has several options: (1) the participant can press the “best so far” button 6408 to set the idea as #1 (bumping all previous ideas down, so any existing #1 becomes #2, any existing #2 becomes #3, etc.), (2) the participant can press the “Trash it!” button 6410 to move the idea to the bottom of the list or (3) the participant can press the “Maybe it's OK” button 6412 to move the idea to just below any of the ideas that were the “Best.” A button instruction section 6414 explains the outcome of pressing each of the buttons 6408, 6410 and 6412.

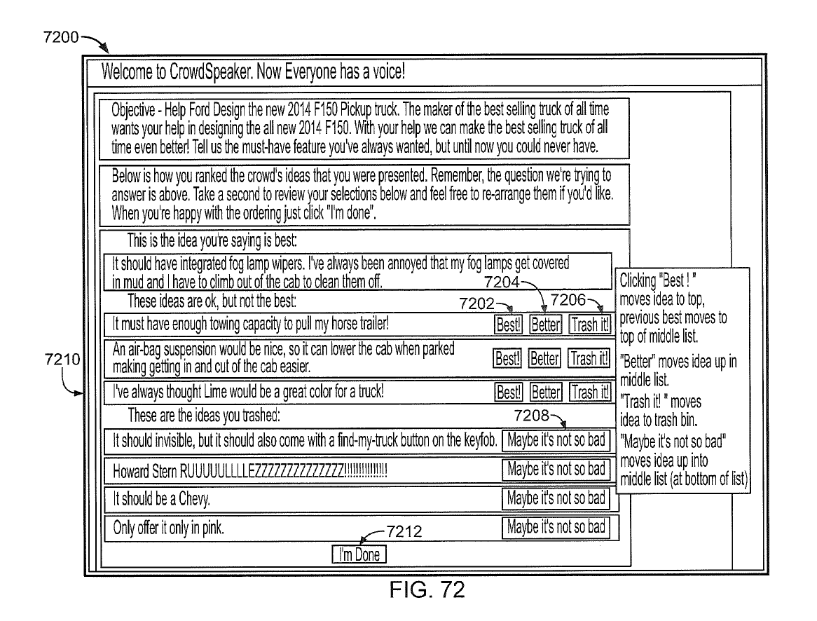

FIG. 72 shows a screenshot 7200 of a voting round after the participant has initially ranked each idea using the method shown in FIG. 64. The options in this screen allow the participant to reorder the ranking of ideas before submitting. To reorder, a participant can press a “best” button 7202 to move the idea to the top of the list, a “better” button 7204 to move the idea up one rank, a “trash it” button 7206 to move the idea to the trash bin, or a “maybe it's not so bad” button 7208 to move the idea from the trash bin to the bottom of the middle list 7210. Once the ideas are ranked to the participant's satisfaction, he/she can press the “I'm done” button 7212 to submit the ranking and move to the next screen.

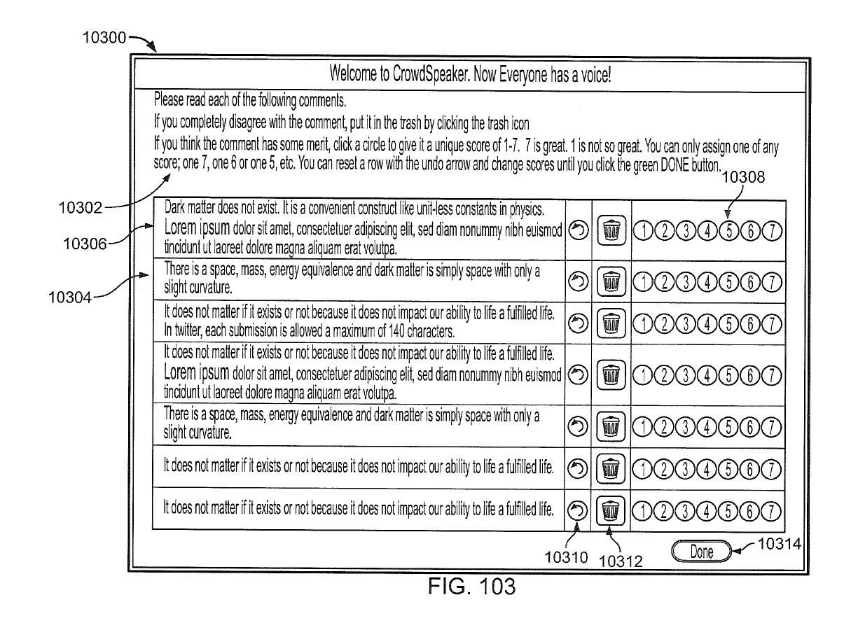

FIG. 103 shows a screenshot 10300 of another voting round. Instructions for voting 10302 are displayed at the top. A participant is presented with all the ideas in a list 10304, and is asked to rank each idea on a scale of 1-7 (with 7 being the best). A participant can rank an idea 10306 by pressing a ranking number 10308 (here, one of the numbers 1, 2, 3, 4, 5, 6, and 7) to the right of the idea. To remove a rank for a given idea, the participant can press the undo arrow 10310 to the right of the idea. If an idea is really poor or if the participant completely disagrees with the idea, he/she can press the trash icon 10312 to the right of the idea, and send the idea to the trash. When the participant is finished ranking, he/she can press or click the “done” button 10314 to move to the next screen.

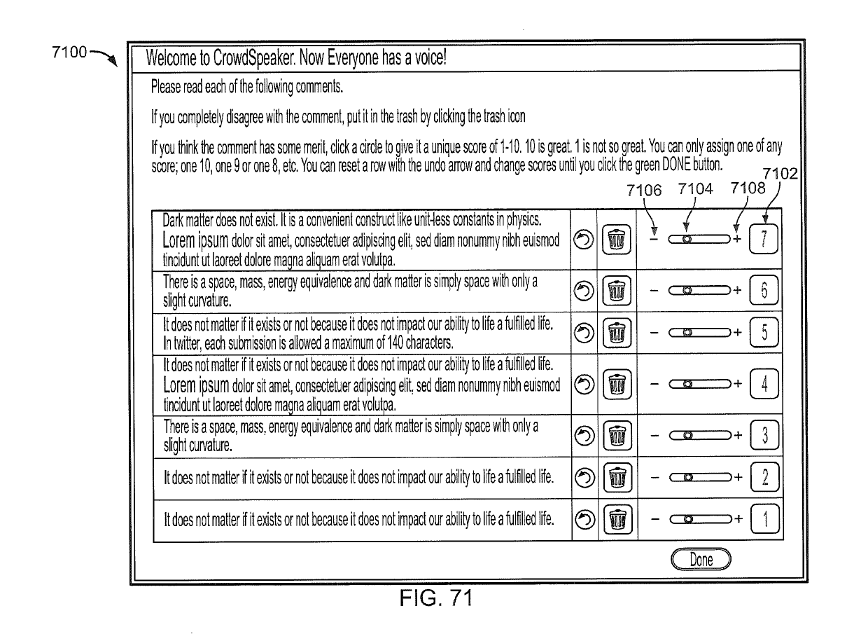

FIG. 71 shows another screenshot 7100 of a voting round. In this example, the participant can select a ranking number 7102 by adjusting a toggle 7104. The minus signs 7106 indicate that moving the toggle to the left lowers the ranking number, and the plus signs 7108 indicate that moving the toggle to the right raises the ranking number. In some examples, when a new ranking number 7102 is chosen, the ideas can automatically rearrange in the list to reflect the participant's new ranking order.

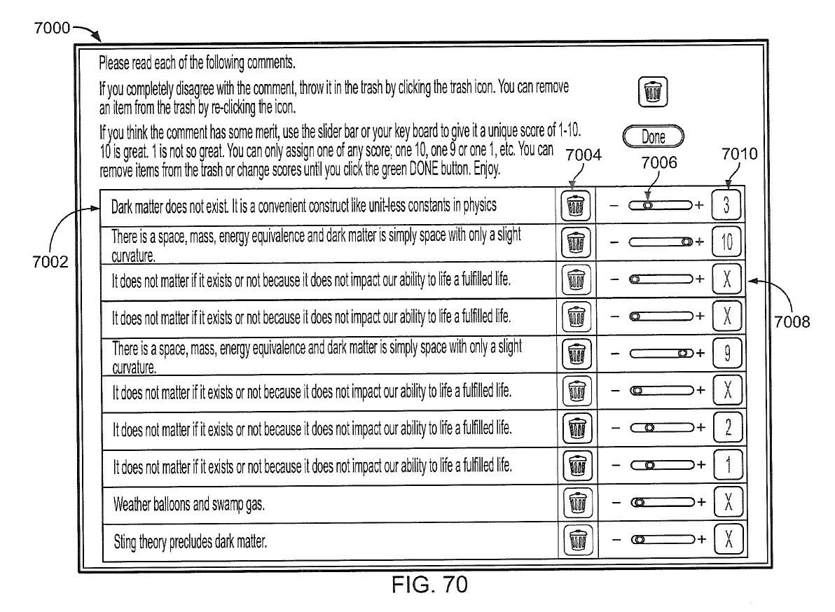

FIG. 70 shows another screenshot 7000 of a voting round. Here, to send an idea 7002 to the trash, the participant can either press the “trash” icon 7004, or move the toggle 7006 all the way to the left. Here, an “X” 7008 indicates that the idea 7002 has been sent to the trash. Once an idea is sent to the trash, the participant can click the “trash” icon 7004 or move the toggle 7006 to the right to remove the idea from the trash. In this example, the ranking numbers 7010 range from 1 to 10. The ideas here do not automatically rearrange into a new order when the participant ranks or trashes the ideas.

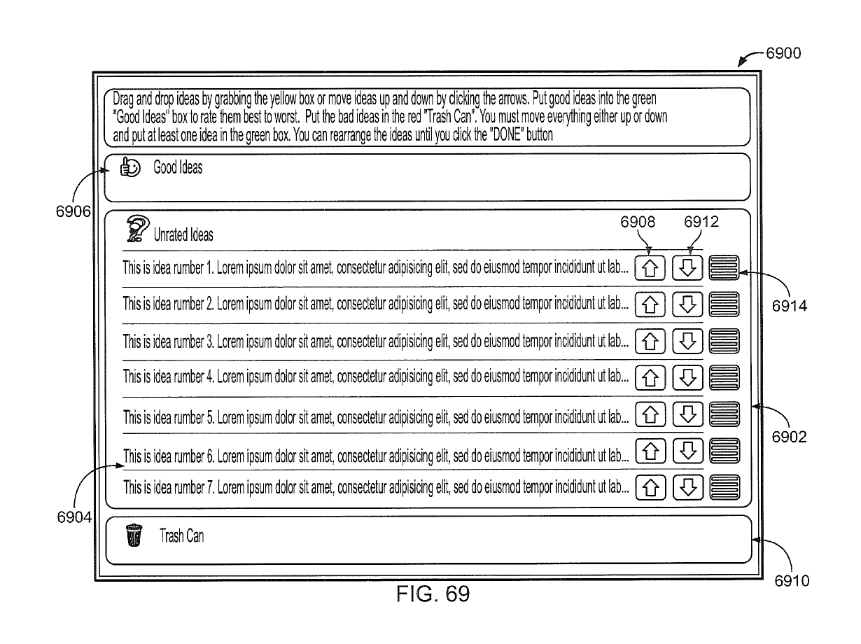

FIG. 69 shows another screenshot 6900 of a voting round. The participant is presented with a list of unrated ideas in the “unrated ideas” box 6902. The participant can move an idea 6904 to the “good ideas” box 6906 by pressing the up arrow 6908, or, to indicate that an idea is a bad idea, the participant can move an idea 6904 to the “trash” box 6910 by pressing the down arrow 6912. Alternatively, the participant can drag and drop an idea 6904 by grabbing the sort button 6914 and moving it into either the “good ideas” box 6906 or the “trash” box 6910. In some examples, ideas placed in the “good ideas” box 6906 can be ranked from best to worst. In some examples, the participant will not be able to move to the next screen until at least one idea is placed in the “good ideas” box 6906, and every idea has been moved to either the “good ideas” box 6906 or the “trash” box 6910.

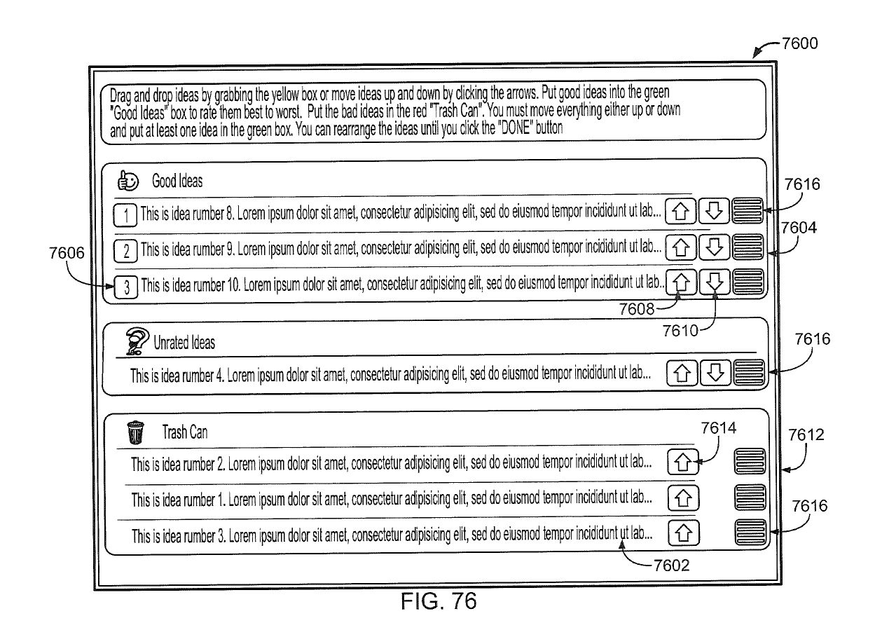

FIG. 76 shows another screenshot 7600 of a voting round. This voting round is similar to that shown in FIG. 69. Here, some ideas 7602 have been placed in the “good ideas” box 7604. Those ideas have been ranked within the “good ideas” box 7604. The ranking number 7606 indicates the idea's rank. Once an idea 7602 is placed within the “good ideas” box 7604, it can be ranked higher by pressing the “rank higher” arrow 7608, or it can be ranked lower by pressing the “rank lower” arrow 7610. Once an idea is ranked lowest in the “good ideas” box 7604, pressing the “rank lower” arrow 7610 will send the idea to the “trash” box 7612. An idea can be moved out of the trash by pressing the “out of trash” arrow 7614. As in FIG. 69, ideas can be dragged and dropped into different boxes (i.e., the “good ideas” box 7604 or the “trash” box 7612) by grabbing the sort button 7616 to the right of the idea.

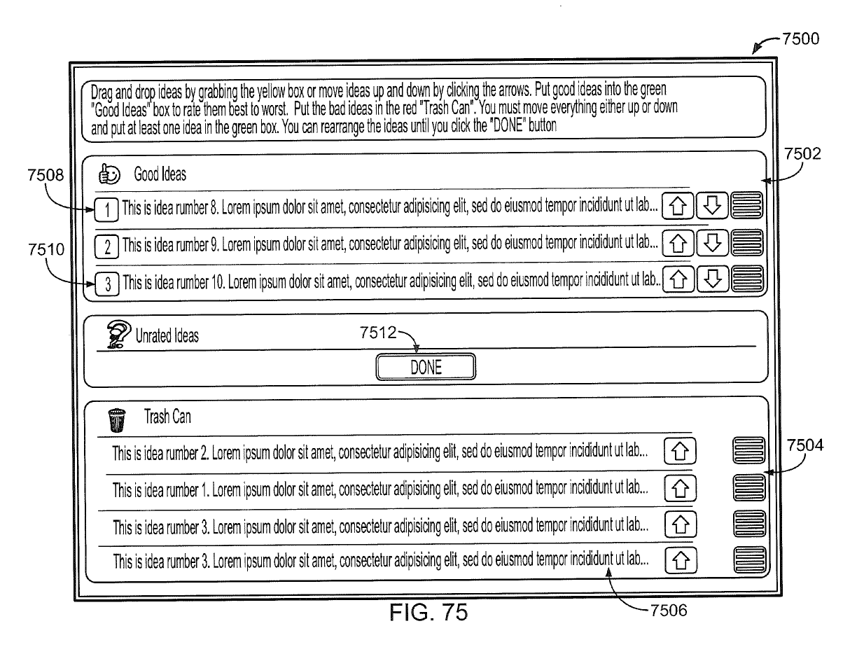

FIG. 75 shows another screenshot 7500 of a voting round similar to those shown in FIGS. 69 and 76. Here, each idea 7506 has either been moved into the “good ideas” box 7502 or the “trash” box 7504. Each idea 7506 in the “good ideas” box 7502 has been ranked (here, from [1] 7508 to [3] 7510, with [1] 7508 being the best). The participant is now presented with a “done” button 7512 to submit the rankings and move to the next screen. Until the participant presses the “done” button 7512, he/she can continue to move and rank ideas.

Our system can also be used on mobile devices. In some examples, user interfaces can provide similar voting arrangements to the ones shown above on the website.

In some implementations, our system can be used on mobile devices to assign a unique score or rank to each idea presented to a participant. For example, FIG. 74 shows a screenshot 7400 of a voting round on a mobile device 7402. Each idea 7404 is presented with a toggle 7406. The participant can adjust the ranking number 7408 by adjusting the toggle 7406 up and down. The plus signs 7410 indicate that moving the toggle up increases the ranking number, and the minus signs 7412 indicate that moving the toggle down decreases the ranking number. A “done” button 7414 can be pressed to move to the next screen.

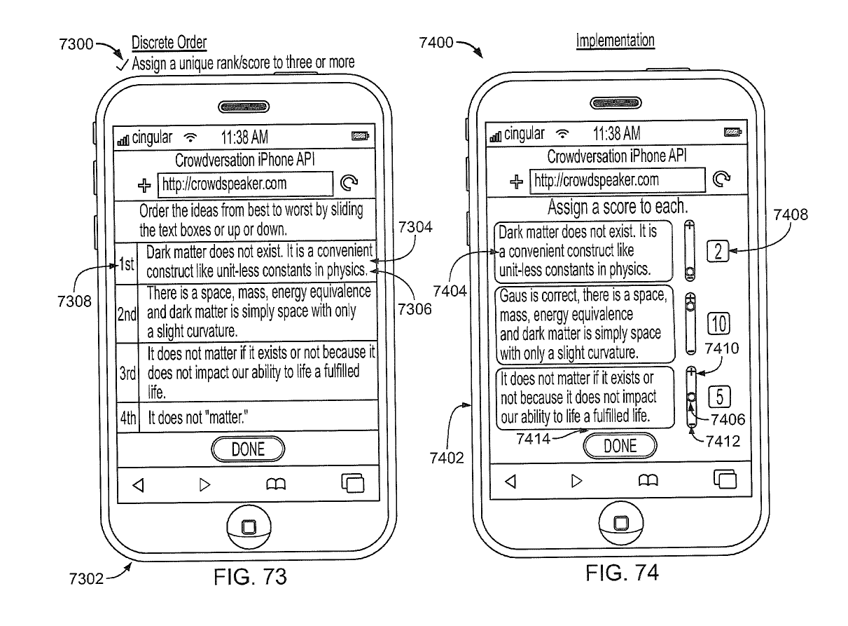

FIG. 73 shows another screenshot 7300 of a voting round on a mobile device 7302. Here, the participant can rank the ideas by sliding text boxes 7304 up or down. Each text box 7304 contains an idea 7306. Sliding a text box 7304 up will rank the idea higher, and sliding a text box 7304 down will rank the idea lower. A label 7308 indicates the current rank of each idea.

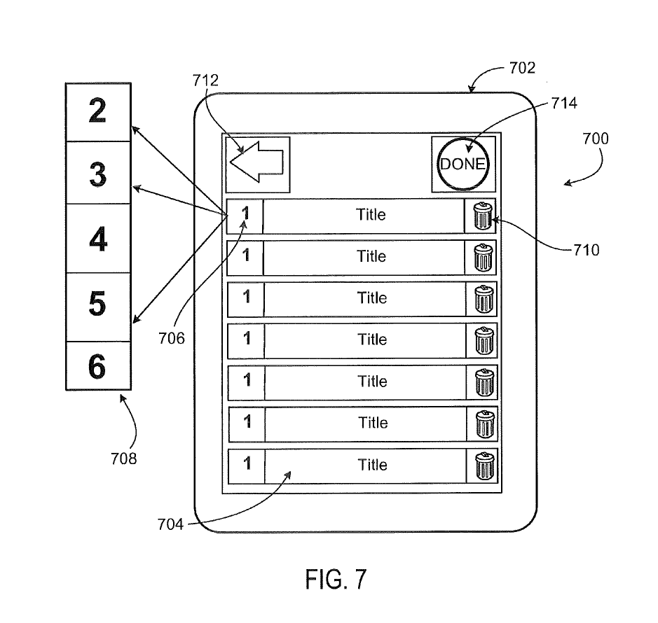

FIG. 7 shows another screenshot 700 of a voting round on a mobile device 702. A list of ideas is presented to the participant. The participant can click on an idea 704 and more detailed information will pop up (e.g., a more detailed description of the idea). Pressing the ranking number 706 to the left of an idea 704 will cause a pop-up number wheel 708 to appear (note that the pop-up number wheel 708 is depicted outside the mobile device for clarity in FIG. 7). The participant can select a new ranking number 706 by spinning the pop-up number wheel 708 and choosing the desired ranking number. If the participant thinks that an idea is extremely poor, he/she can send that idea to the trash and remove it from the list by pressing the “trash” icon 710. To undo an action (e.g., to retrieve an idea just sent to the trash), the participant can press the “undo” arrow 712. In some examples of our system, the list will rearrange as items are ranked, placing the best ideas at the top of the list and the worst ideas at the bottom of the list. To submit the rankings or to move to the next screen, the participant can use the “done” button 714.

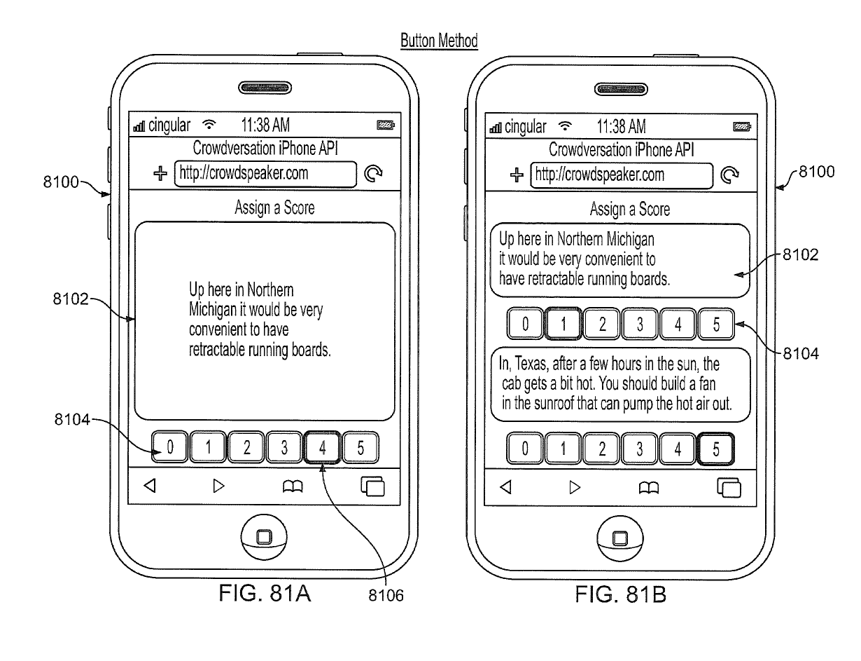

FIGS. 81A and 81B show other screenshots 8100 of voting rounds on a mobile device. In FIG. 81A, the participant is presented with one idea 8102 at a time and is asked to assign a score or rank. This can be achieved by pressing a ranking number 8104. A box 8106 appears around the ranking number selected. In FIG. 81B, multiple ideas 8102 are presented at once, and an individual idea can be ranked by pressing a ranking number 8104 under that idea.

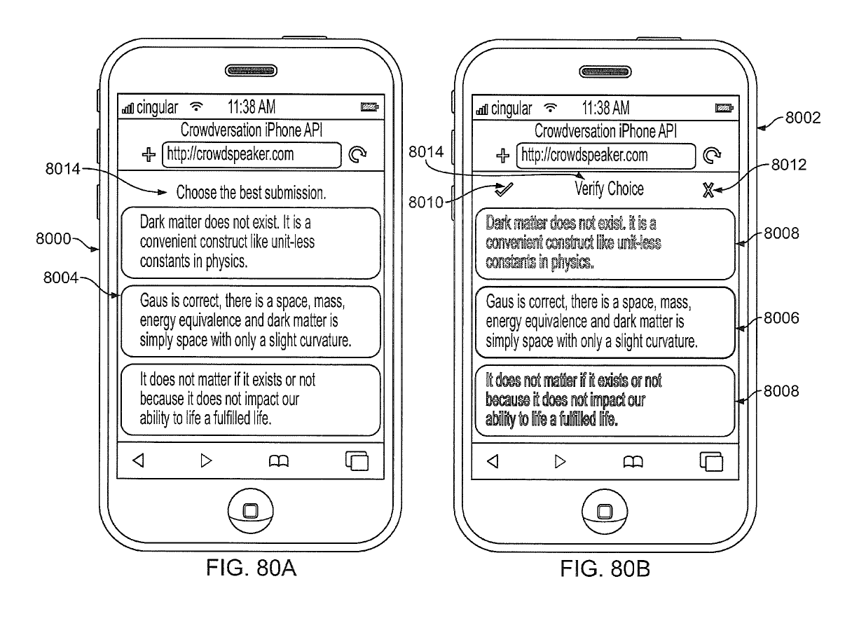

In addition, other examples of our system can allow the participant to simply pick the best (or worst) idea from a set, without ranking each or multiple ideas. For example, FIGS. 80A and 80B show screenshots 8000 of a voting round on a mobile device 8002. In FIG. 80A, a list 8004 of ideas is presented to the participant, and the participant can touch or otherwise select the idea that he/she thinks is the best. As seen in FIG. 80B, when the participant chooses the best idea 8006, the less good ideas 8008 partially fade. The participant is given the option to press (or click) the “Check” button 8010 to verify his choice and move to the next screen, or the “X” button 8012 to go back to the list as shown in FIG. 80A and choose another idea. Instructions at each step 8014 can appear on the screen.

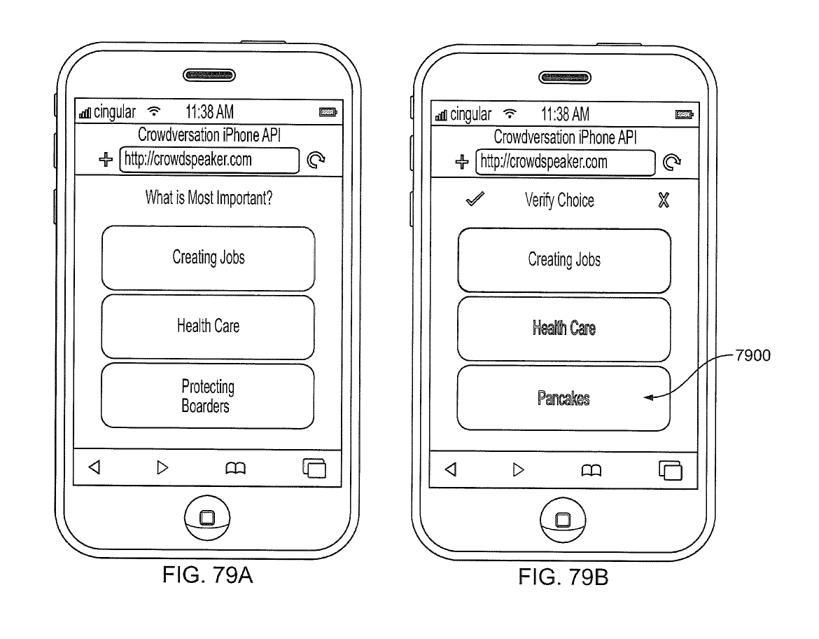

FIGS. 79A and 79B show screenshots 7900 that are similar to FIGS. 80A and 80B, respectively. FIGS. 80A and 80B show screenshots 8000 in which the participant is asked to pick the best idea or best submission. In FIGS. 79A and 79B, the participant is asked to choose the most important idea.

FIG. 78 shows another screenshot 7800 of a voting round on a mobile device 7802. A list 7804 of ideas is presented to the participant, and the participant can select one idea 7806 as the best idea. Once an idea is selected, the participant can press/click the “done” button 7808 to move to the next screen.

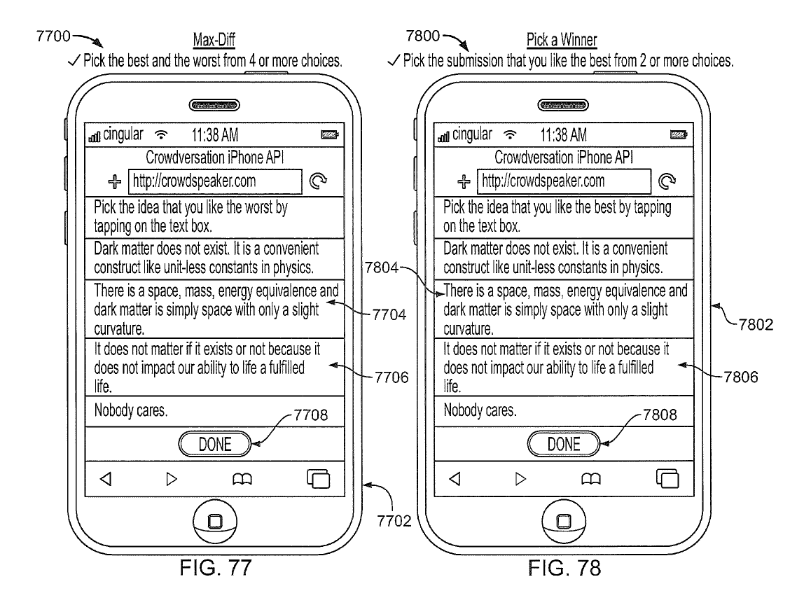

FIG. 77 shows another screenshot 7700 of a voting round on a mobile device 7702. A list 7704 of ideas is presented to the participant, and the participant can select one idea 7706 as the worst idea. Once an idea is selected, the participant can press the “done” button 7708 to move to the next screen. In some examples, this example can be used in combination with the voting example shown in FIG. 78, so that the participant can identify both the best and the worst ideas.

FIG. 98 shows a screenshot 9800 of a presorting option that can be used by itself as a voting round or in combination with one of the examples. For instance, the participant can select one or several ideas 9802 he/she likes (or agrees with) by pressing the up arrow 9804 to the idea's left, and/or the participant can select one or several ideas 9802 he/she dislikes (or disagrees with) by pressing the down arrow 9806 to the idea's right. The “done” button 9808 can be clicked/pressed to move to the next screen. In some examples, the ideas that the participant liked could then be displayed as a list for further ranking, for instance as shown in FIGS. 73, 74, 77, 78, 80, etc.

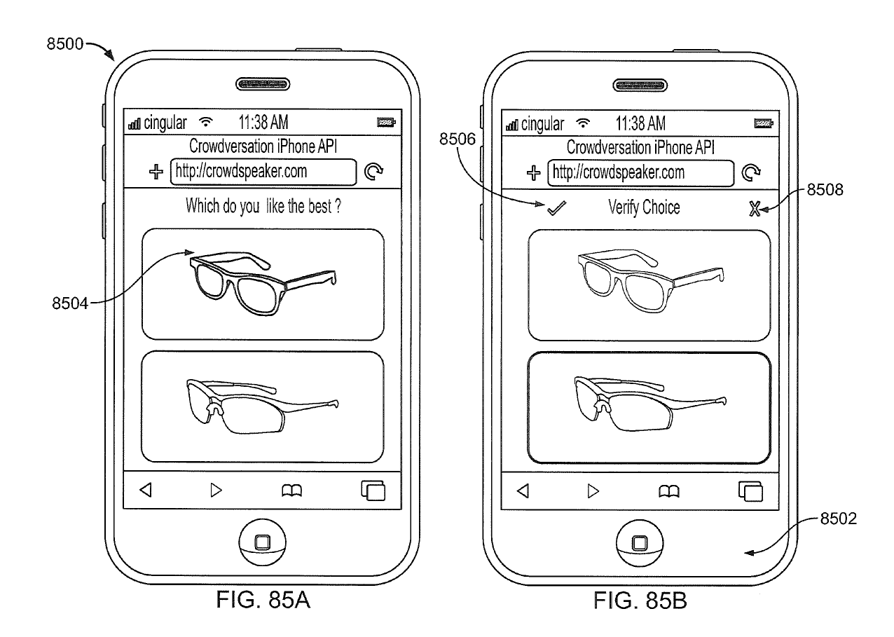

FIGS. 85A and 85B show other screenshots 8500 of a voting round on a mobile device 8502. In this example, each idea is an image 8504. In FIG. 85A, the participant is presented with two or more ideas and is prompted to choose the best. Once the best idea is selected, the other idea(s) partially fade, as show in FIG. 85B. The participant is then asked to verify his choice by pressing the check button 8506, or return to the list of ideas shown in FIG. 85A by pressing the “X” button 8508.

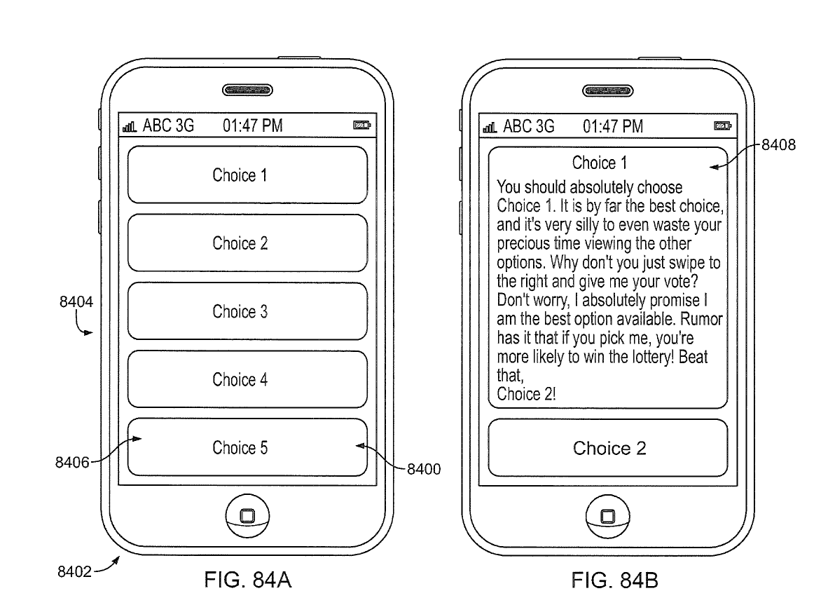

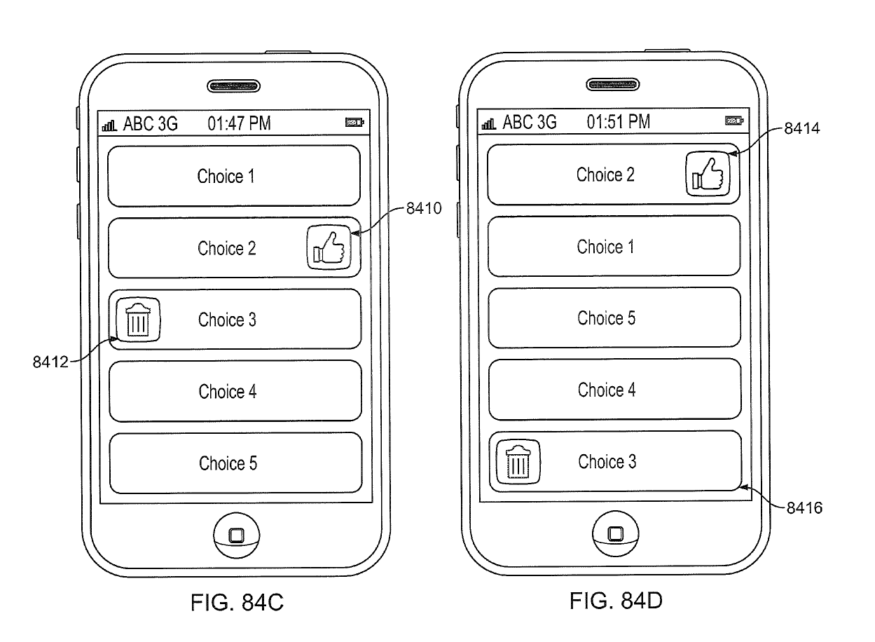

FIGS. 84A-D show alternative screenshots 8400 of a voting round on a mobile device 8402. In FIG. 84A, the participant is presented with a list 8404 of ideas 8406. To expand an idea 8406 and view its details, the participant can click the idea. FIG. 84B shows an expanded idea 8408. To hide the details, the participant can click the expanded idea 8408 again. At any time, the participant can swipe an idea to the left to indicate that the idea is a bad idea, or swipe to the right to indicate that it is a favored idea. FIG. 84 shows icons appearing next to ideas that have been swiped, with a thumbs up icon 8410 appearing next to an idea that has been swiped to the right and a trash icon 8412 appearing next to an idea that has been swiped to the left. In some examples, as seen in FIG. 84D, the list 8404 of ideas rearrange with favored ideas 8414 (those ideas swiped to the right) appearing at the top, and disfavored ideas 8416 (those ideas swiped to the left) appearing at the bottom.

A wide variety of other ranking and sorting schemes are possible including combinations of two or more of the features described above.

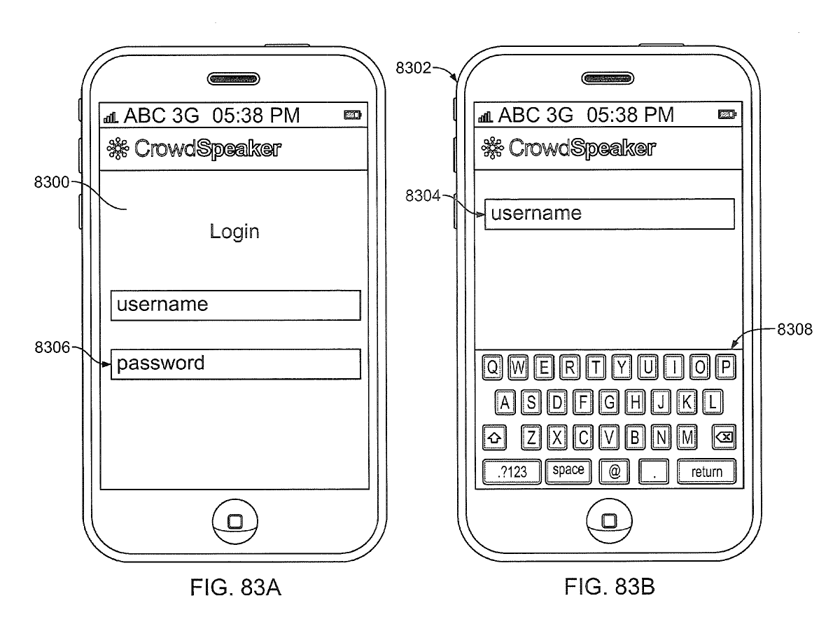

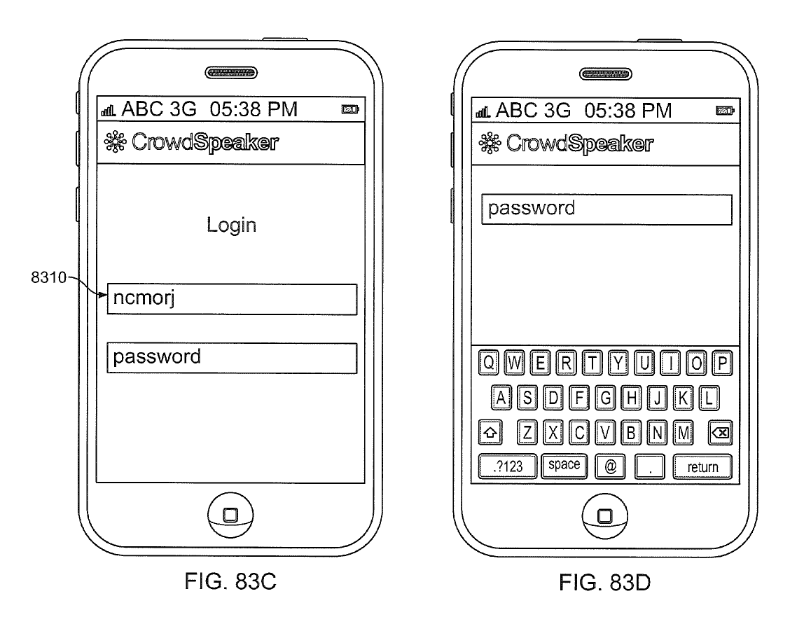

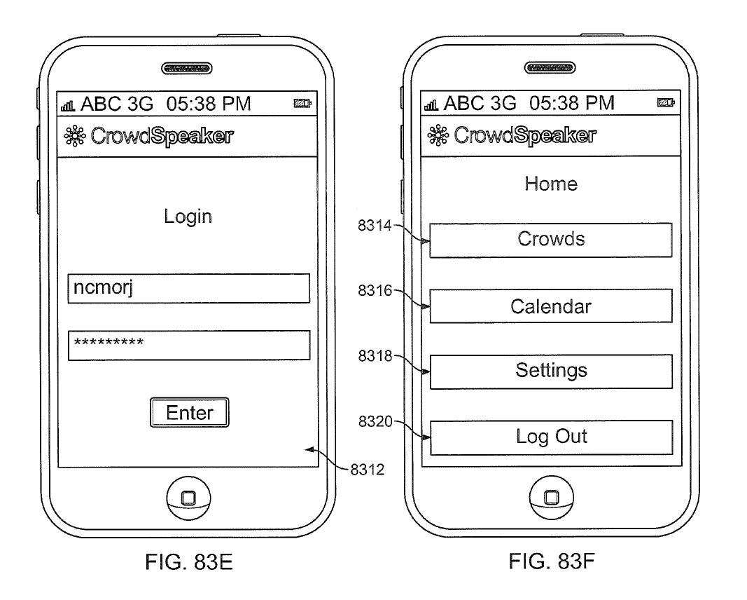

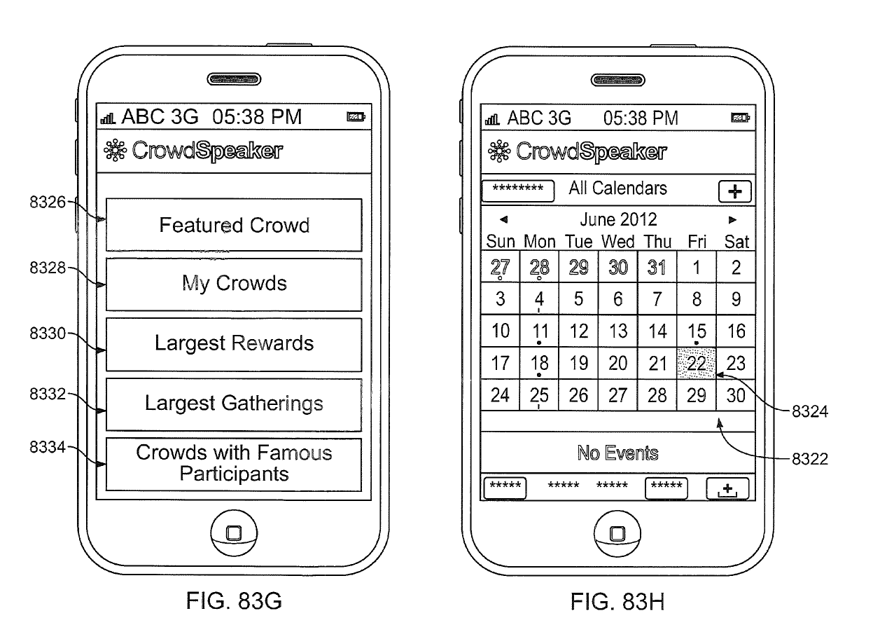

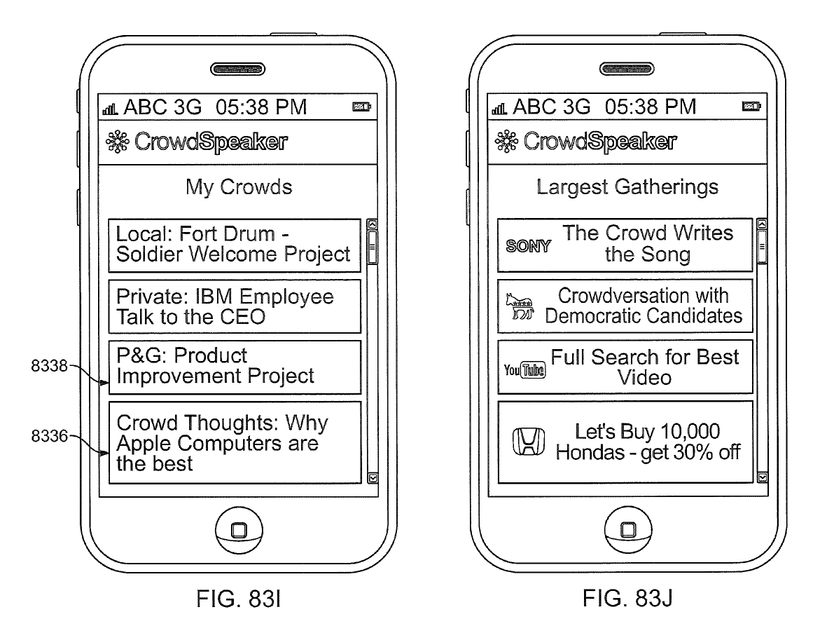

FIG. 83A-J show an example of part of our system on a mobile interface. FIG. 83A shows a screenshot 8300 of a login screen on a mobile device 8302, with a username field 8304 and a password field 8306. As shown in the screenshot 8300 in FIG. 83B, the participant can begin logging into the system by, for example, typing his username into the username field 8304 using a touch keyboard 8308. FIG. 83C shows a screenshot 8300 with the participant's username 8310 inputted into the username field 8304. As shown in the screenshot 8300 in FIG. 83D, the participant can then input his password into the password field 8306 by, for example, typing his password using a touch keyboard 8308. FIG. 83E shows a screenshot 8300 of the completed username field 8304 and password field 8306. The participant can then press the “Enter” button 8312 to enter the system. FIG. 83F shows a screenshot 8300 of the participant's home screen. The participant can select to view group/crowds with the “group/crowds” button 8314, to view his/her calendar with the “calendar” button 8316, to view and/or change his/her settings with the “settings” button 8318 or to log out with the “log out” button 8320. If the participant selects the “group/crowds” button 8314, he/she can be presented with a list of various types of group/crowds, as shown in the screenshot 8300 in FIG. 83G. Alternatively, if the participant selects the “calendar” button 8316 shown in FIG. 83F, the participant is presented with a calendar showing, for instance, a monthly view 8322. The participant can see, for instance, the voting deadlines on any particular day by selecting a date 8324. If the participant selected the “group/crowds” button shown in FIG. 83F, the participant can explore and/or participate in various types of groups. For example, as seen in the screenshot 8300 in FIG. 83G, the participant can view the featured group/crowd by using the “featured group/crowd” button 8326, the group/crowds he/she has already joined by using the “my group/crowds” button 8328, the group/crowds with the largest rewards by using the “largest rewards” button 8330, the largest group/crowds by using the “largest gatherings” button 8332 or the group/crowds with famous participants by using the “group/crowds with famous participants” button 8334. Other types of groups may be available or visible in other examples. If the participant selects the “my group/crowds” button 8328 shown in FIG. 83G, the participant can be brought to a screen that looks like the screenshot 8300 shown in FIG. 831. The screenshot 8300 in FIG. 831 shows the groups 8336 that the participant has joined. The participant can select a particular group by pressing on the group button 8338 for that group, and, for instance, see more information or vote. If the participant chooses the “largest gatherings” button 8332 shown in FIG. 83G, the participant can be shown a list of the largest groups, as seen in the screenshot in FIG. 83J. If the participant selects the group button 8338 for a particular group, he/she will be able to, for instance, get more information or join the group.

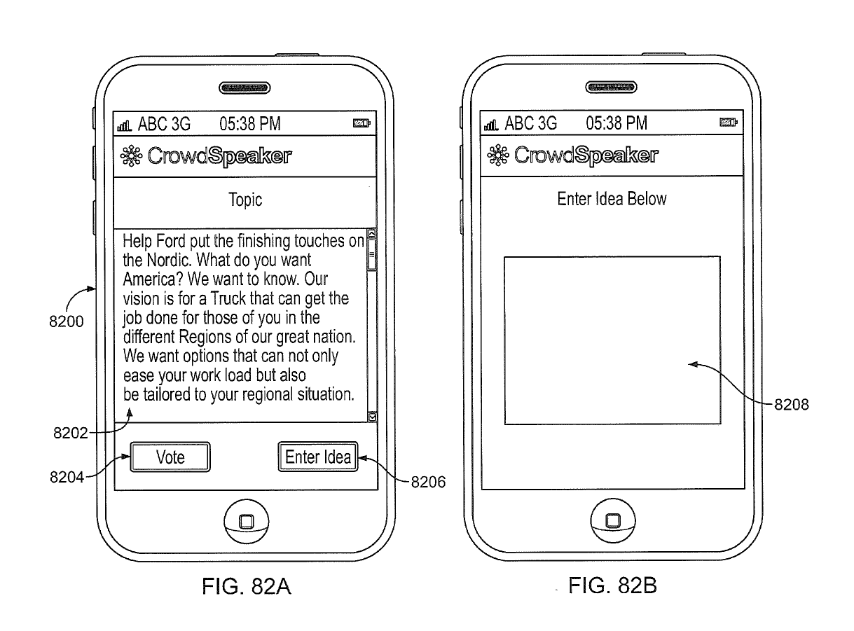

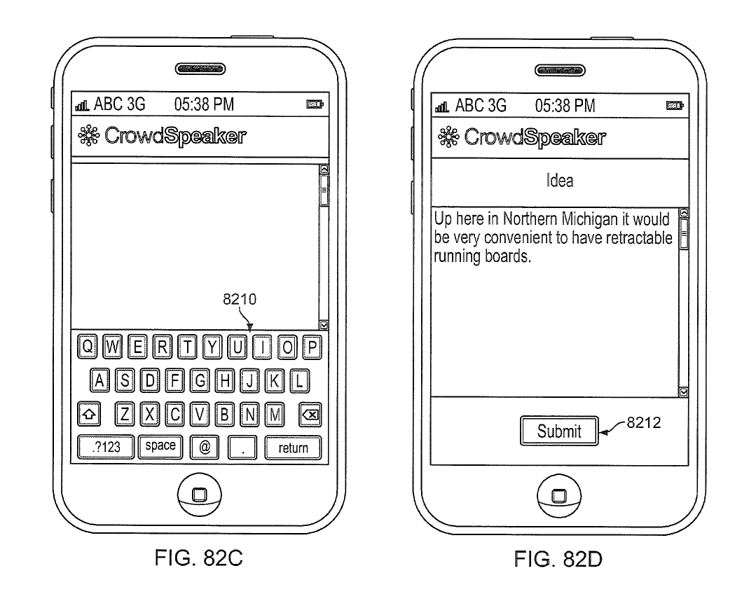

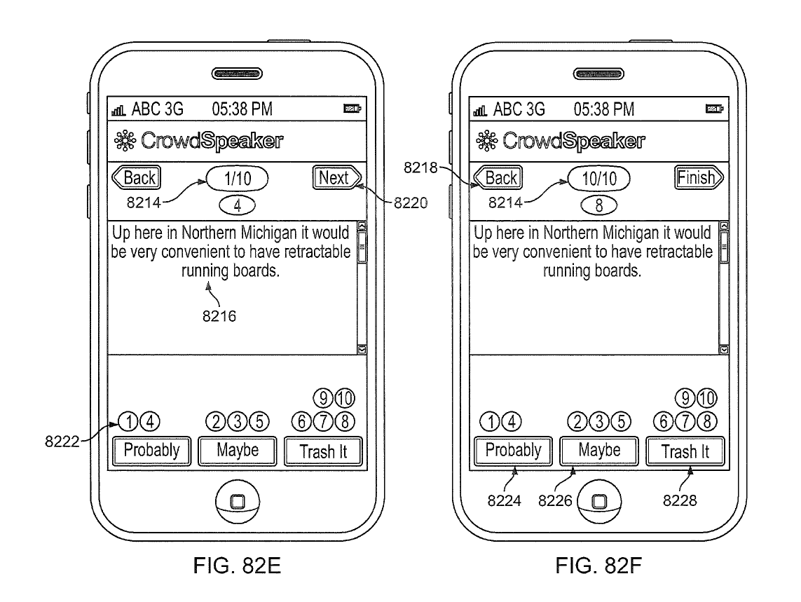

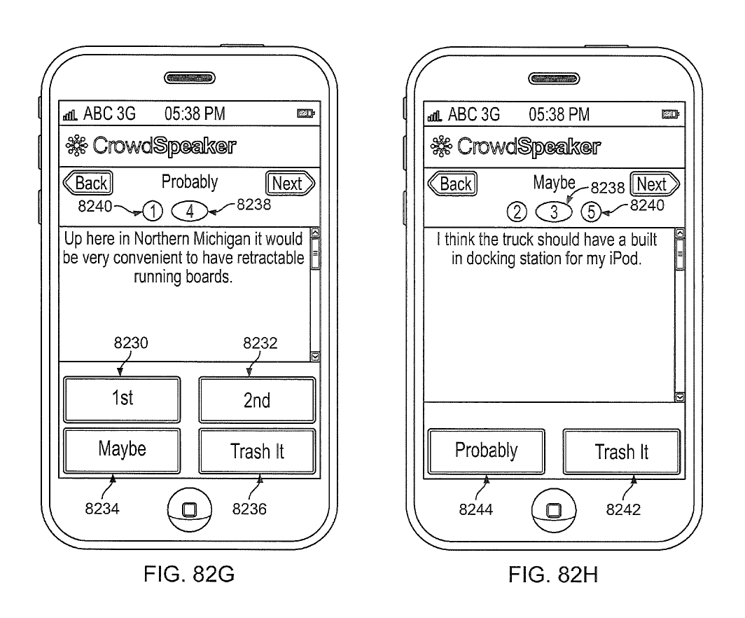

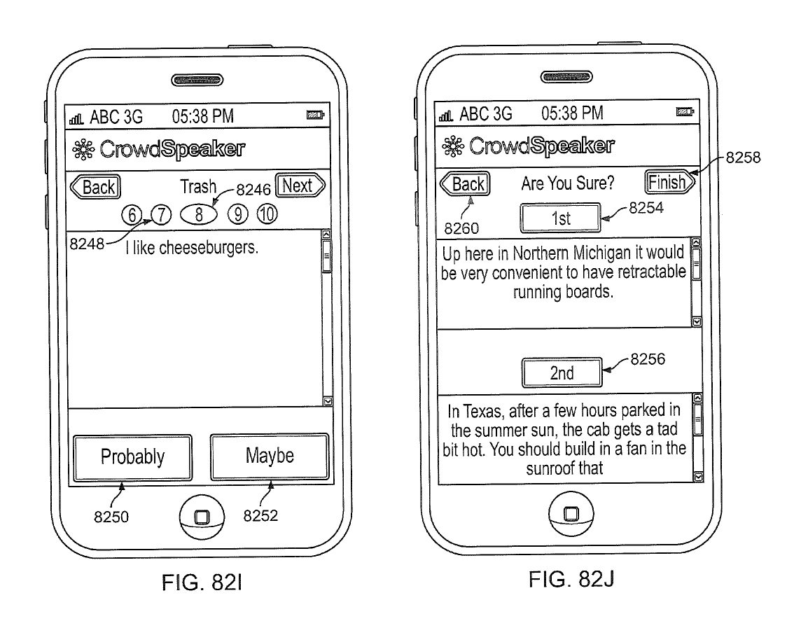

FIGS. 82A-J show an example of part of our system on a mobile interface. FIG. 82A shows a screenshot 8200 displaying information about a particular group. The topic is shown in a textbox 8202, and the participant is given the option to vote on ideas already submitted by pressing the “vote” button 8204 and/or to enter an idea by selecting the “enter idea” button 8206. If the participant selects the “enter idea” button 8206, he/she can be taken to a screen like that shown in FIG. 82B. In the screenshot in FIG. 82B, the participant can enter an idea by pressing on the textbox 8208. This could take the participant to a screen like that shown in FIG. 82C, where the participant can enter his/her idea using, for example, a touch keyboard 8210. FIG. 82D shows a screenshot of a typed out idea. The participant can submit the idea by pressing the “submit” button 8212. FIGS. 82E-I show screenshots of a two-stage voting round. In the first round, a progress label 8214 (e.g., idea 1/10) is displayed at the top of the screen. Each idea is displayed in a text box 8216. The participant can move between ideas using the “back” arrow 8218 and/or the “next” arrow 8220. As seen in the screenshots 8200 in FIGS. 82E and 82F, in the first stage of voting, the participant put an ideas into a category by using the “probably” button 8224, the “maybe” button 8226 or the “trash it” button 8228. By pressing any of the small circles 8222, the participant can edit the idea and/or review the rankings in each category. Once the participant has initially ranked the ideas using the “probably,” maybe” and “trash it” buttons, he can then sort within those categories, as seen in the screenshots in FIGS. 82G-I. For instance, FIG. 82G shows a screenshot of an idea that had been put in the probably category (e.g., it is probably a good idea, or it will probably solve the problem) using the “probably” button 8224. The participant can now rank the idea as the first place idea by using the “1^{st}” button 8230, rank the ideas in second place using the “2^{nd}” button 8232, put the idea in the maybe category by using the “maybe” button 8234 or put the idea in the trash by using the “trash it” button 8236. FIG. 82H shows a screenshot 8200 of an idea that was placed in the maybe category. The idea's rank 8238 can be changed by selecting an alternative ranking number 8240. The participant can also put the idea into a different category. For instance, the participant can put the idea in the trash category by using the “trash it” button 8242 or put the idea in the probably category by using the “probably” button 8244. FIG. 82I shows a screenshot of an idea that has been placed in the trash category. The idea's rank 8246 can be changed by selecting an alternative ranking number 8248. The participant can also put the idea into a different category. The participant can move the idea to the probably category by pressing the “probably” button 8250 or the participant can move the idea to the maybe category by pressing the “maybe” button 8252. FIG. 82J shows a screenshot 8200 of the first and second place ideas selected by the participant. The first place idea is labeled with a “1^{st}” label 8254 and the second place idea is labeled with a “2^{nd}” label 8256. The participant can submit these rankings by using the “finish” arrow 8258, or go back and choose different ideas using the “back” arrow 8260.

In some examples of our system, the participant can be asked to determine if any two ideas are essentially identical (or very similar). In some examples, if the group/crowd designates two ideas as essentially identical, the algorithm could be adjusted, for instance by linking the two ideas, as described below.

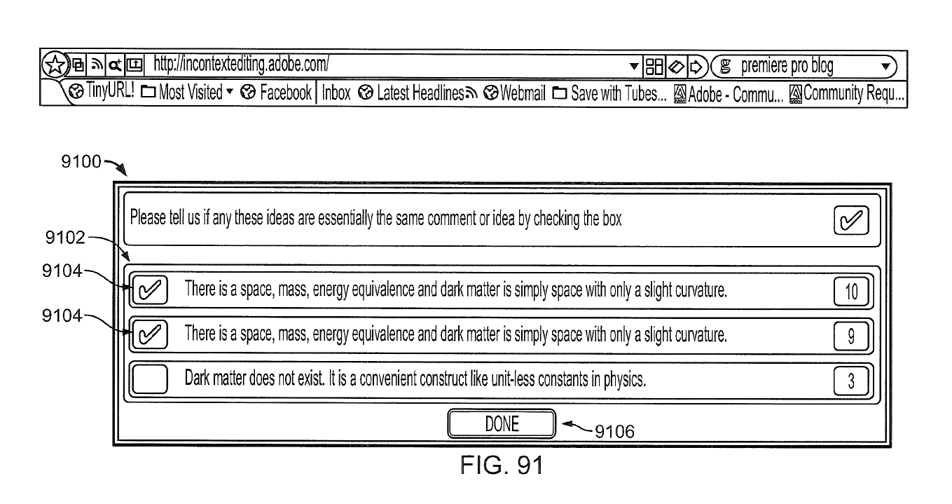

FIG. 91 shows a screenshot 9100 where the participant is asked to determine if any ideas in the list 9102 are essentially the same. A check mark 9104 appears next to an idea if the participant designates the idea as essentially identical. When the participant is finished, he/she can press the “done” button 9106 to move to the next screen.

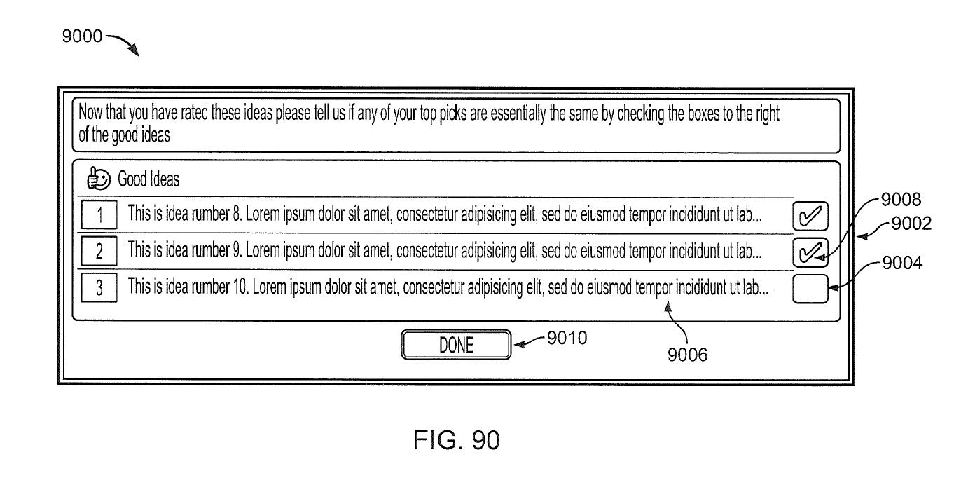

FIG. 90 shows a screenshot 9000 of a user interface where the participant is asked to determine if any ideas are essentially identical (or essentially the same or very similar). Here, the participant is only asked to determine if any of the ideas he/she placed in the “good ideas” box 9002 (e.g., the top X number of ideas) are essentially identical. The participant can indicate that an idea 9006 is essentially identical by clicking the box 9004 to the right of the idea 9006 to put a check mark 9008 in the box 9004. The check mark 9008 will appear with one click and will disappear with a second click. When the participant places a check mark 9008 next to two or more ideas, he/she indicates that those ideas are essentially identical. The participant can move to the next screen by using the “done” button 9010.

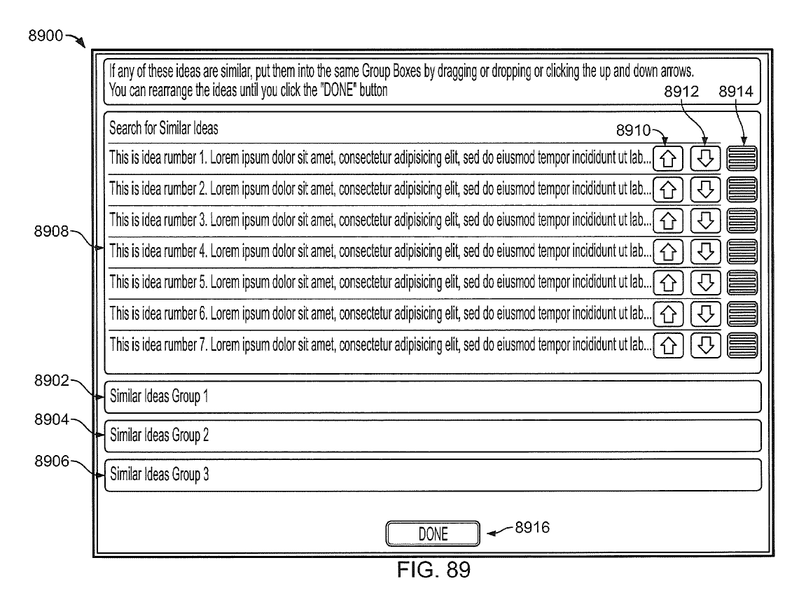

FIG. 89 shows another screenshot 8900 of a user interface where the participant is asked to determine if any ideas are essentially identical or very similar. The participant can group similar or essentially identical ideas into different boxes by sorting them into the “similar ideas group 1” box 8902, the “similar ideas group 2” box 8904 or the “similar ideas group 3” box 8906. Ideas that are not similar to each other, or have not yet been sorted, are in the main box 8908. Ideas can be sorted by using the “up” arrow 8910 or the “down” arrow 8912, or by dragging and dropping by grabbing the sort button 8914. The participant can indicate, for example, that all ideas in “similar ideas group 1” box 8902 are similar or essentially identical to each other, but different from the others in the other boxes 8904, 8906 and 8908. Likewise, all ideas in the “similar ideas group 2” 8904 are similar or essentially identical to each other, but different from the ideas in other boxes 8902, 8906 and 8908. When the participant is done sorting, he/she can press the “done” button 8916.

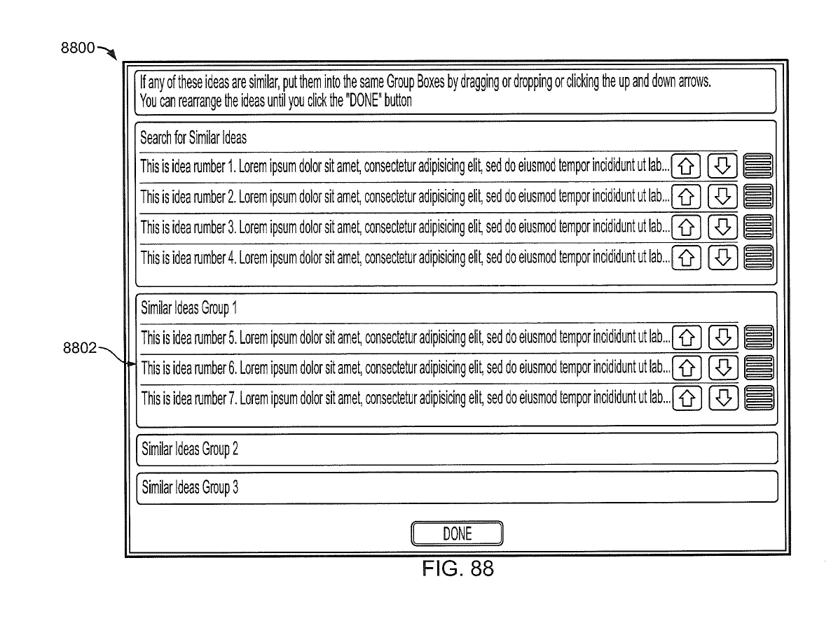

FIG. 88 shows a screenshot 8800 similar to that shown in FIG. 89. Here, the participant has sorted three ideas into the “similar ideas group 1” box 8802, indicating that those three ideas are similar or essentially identical.

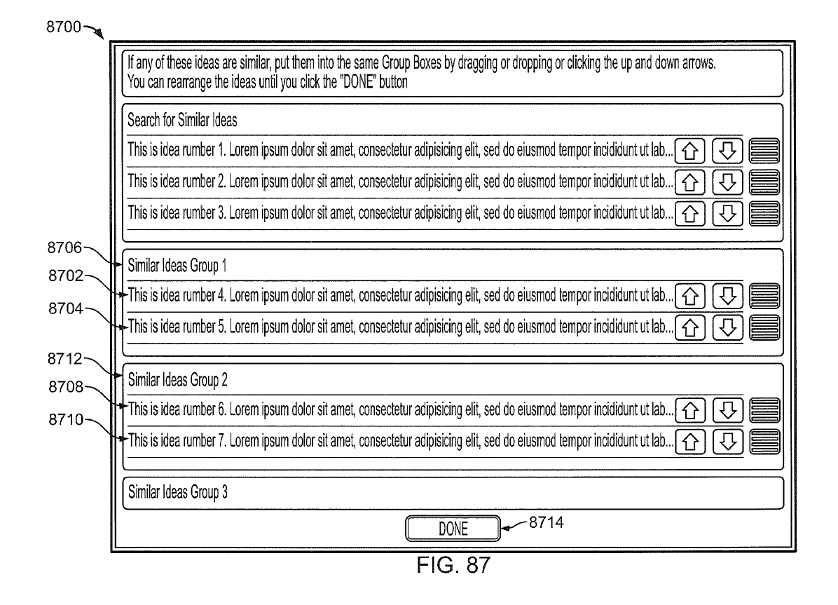

FIG. 87 shows a screenshot 8700 similar to that shown in FIGS. 89 and 88. In FIG. 87, the participant has already sorted idea [4] 8702 and idea [5] 8704 into the “similar ideas group 1” box 8706, and has sorted idea [6] 8708 and idea [7] 8710 in to the “similar ideas group 2” box 8712. The participant has therefore indicated that he/she thinks idea [4] 8702 and idea [5] 8704 are similar or essentially identical to each other (but different from idea [6] 8708 and idea [7] 8710). Likewise, he/she has indicated that idea [6] 8708 and idea [7] 8710 are similar or essentially identical to each other (but different from idea [4] 8702 and idea [5] 8704). If the participant is done sorting, he/she can use the “done” button 8714 to submit his/her sorting and move to the next screen.

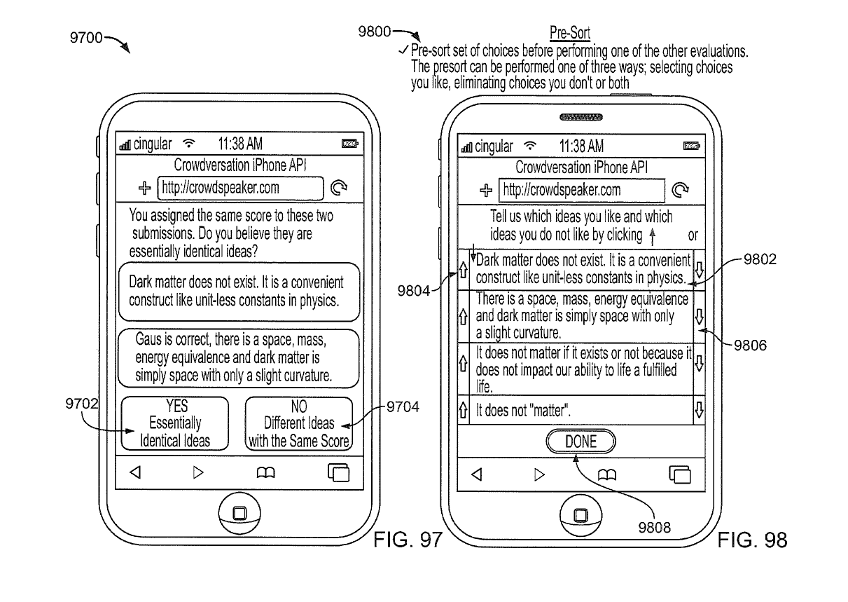

FIG. 97 shows a screenshot 9700 of a mobile user interface. In this example, the participant had previously assigned the same rank to two ideas. The participant was then prompted to determine if the two ideas were essentially identical. The participant can designate the ideas as essentially identical by pressing the “yes” button 9702, or can press the “no” button 9704, indicating that the ideas are different but should receive the same score/rank.

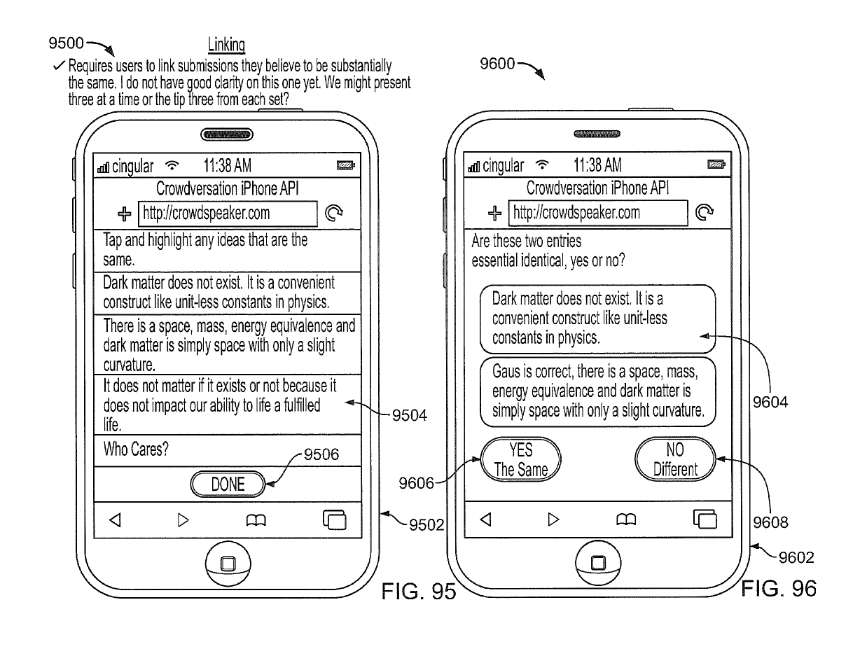

FIG. 96 shows a screenshot 9600 of a mobile interface on a mobile device 9602. The participant is presented with two ideas 9604, and asked to determine if the two ideas are essentially identical. The participant can press the “yes” button 9606 to indicate that the ideas are essentially identical, or can press the “no” button 9608 to indicate that the ideas are not essentially identical.

FIG. 95 shows a screenshot 9500 of a mobile interface on a mobile device 9502. The participant can designate two or ideas as essentially identical by selecting two or more ideas. When an idea is selected, the idea's background 9504 turns gray. The participant can use the “done” button 9506 to move to the next screen.

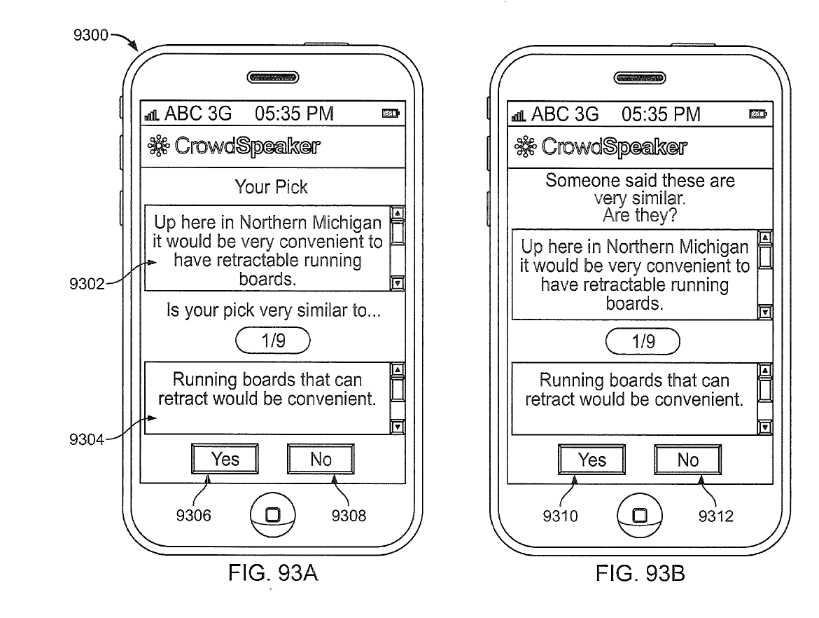

FIG. 93A and FIG. 93B show screenshots 9300 of a mobile interface. In the screenshot 9300 in FIG. 93A, a participant is asked to compare his/her first place idea 9302 (labeled “Your Pick”) with another idea 9304. The participant can designate the two ideas as essentially identical by using the “yes” button 9306, or indicate that the ideas are not essentially identical by using the “no” button 9308. In the screenshot 9300 in FIG. 93B, a participant is informed that another participant (or multiple participants) indicated that the two ideas presented are essentially identical. The participant can indicate that he/she also thinks the two ideas are essentially identical by using the “yes” button 9310 or indicate that the two ideas are not essentially identical by using the “no” button 9312.

When participants participate (e.g., using the probably, maybe, or trash-it options), some examples of our system can collect potentially valuable data. For instance, data can be extracted that can be used to help answer the following questions. How long each idea was viewed by a given participant (vs. text characteristics such as word count and complexity of words used)? Did the participant skip any ideas? What was the average time (per word—adjusted for word complexity) that the participant took to read each idea? Were there any anomalies? How did the participant sort the choices?

This sorting (if done for each idea) may provide richer data than if the participant simply picked a first and second choice. In some examples, sponsors could set up the session requiring mandatory sorting of all ideas presented. Patterns of sorting in conjunction with time can provide data distinctive of either variable in isolation. If the vast majority of participants who were shown a particular idea, trashed it rapidly, it is likely worse than a protracted decision to trash an idea. The same holds true for a “probably” or “maybe.”

In some sessions, participants in a group may share attributes in common. There may be cases such as in businesses where the sponsor may want to arrange the groupings by job titles or geography or any other number of non-random variables. These workgroups may stick together and/or vote together. The bottom line is that our system is flexible.

It is possible that near the final stages of a session (or even earlier) the top ideas become polarized. Half of the surviving ideas may be leaning one way and the other half may be leaning a different way. In some cases, we can allow the group/crowd to separate itself from certain issues (and other group/crowd members) by casting an anti-vote (a vote against or a “nay” vote) for a particular idea. In some examples, an anti-vote for an idea can also be treated as an anti-vote for the participants who voted for that idea. This could also be called an extraction as the “vote” or indication has no effect per se on the idea but rather extracts the participant who cast an anti-vote from the group that liked the idea. This could, in some versions of our system, effectively break the group into 2 or more smaller group/crowds. These group/crowds may, for instance, each have very valid (but different) ideas or priorities. The sponsor of the session may need to develop a multifaceted strategy in order to address multiple contingencies.

In the final stages of a session (or earlier for some sessions), we may wish to allow detractors the ability to attach after-thoughts or sub-ideas to ideas they dislike. In some examples, the group/crowd may make the final determination as to these after-thoughts (e.g., whether to keep them, edit them or remove them). Thus ideas may pick up “baggage” so to speak, if the group/crowd deems that these negative arguments are good.

In some cases, after a session is completed, the sponsor may allow the searching of a given session's roots (the identity of any participants and the ideas, edits, afterthought, etc., generated along the way) for anything of interest. For instance, key word or phrase searching could be available. It may be possible to then link like-minded participants whose ideas did not make it to the final round but who wish to form new groups and/or sessions.

Some examples of our system can create or manage a forum so that only good ideas get through. This could be done by limiting the number ideas allowed to be posted. For instance, this limit could be enforced by forcing all incoming posts into competition with each other. This could work, for instance, like a Group/crowd speaker session with a slower feed. In some examples, all forum members will be able to see all “passed” posts—e.g., Level 3 posts, or those posts that have passed to a third level of viewing or successfully went through 2 rounds of voting.

In some examples, forum members could also be randomly assigned a handful of Level 1 posts. These are raw, unfiltered posts, which could be clumped together with, e.g., 3 to 5 other Level 1 posts. In some examples, the participant must pick 1 best post. Using the voting methods described above, we can then pass some of the Level 1 posts on to Level 2. These posts can be distributed to a greater number of participants for a second round of voting. In some examples, if a post makes it past this 2^{nd} hurdle, it will be posted for all to see.

Some examples of our system also allow participants to dial in the level of posts they wish to see. They can go from, e.g., Level 3 through Level 1 by moving a toggle up and down. Some examples allow participants to “dial-in” sub-degrees, such as Level 1 posts that won at least 10% of their competitions or higher (or 90% or whatever).

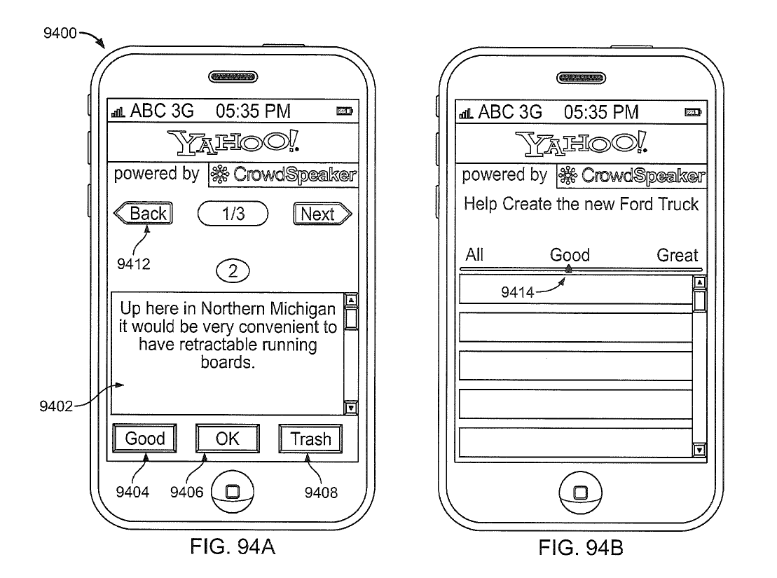

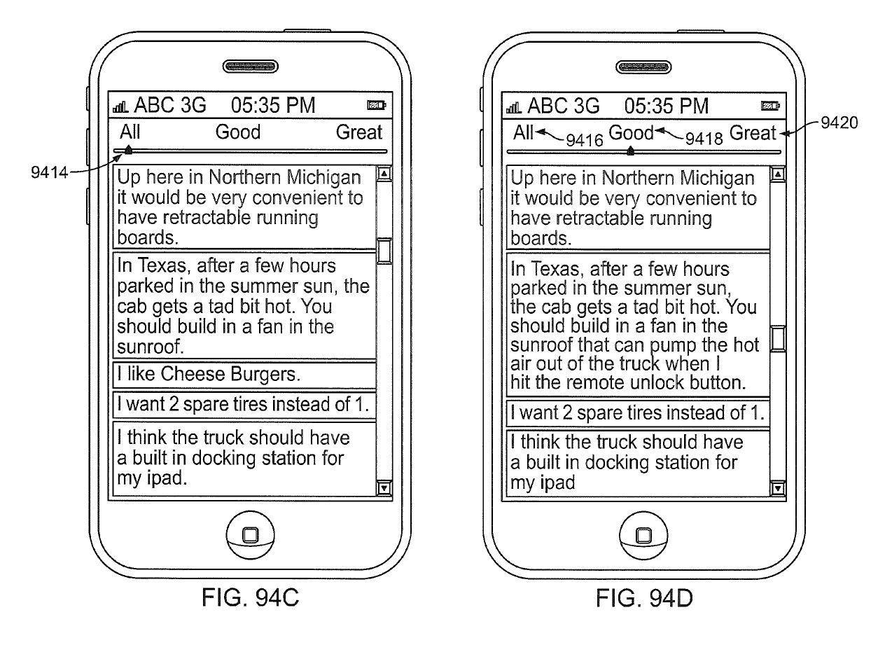

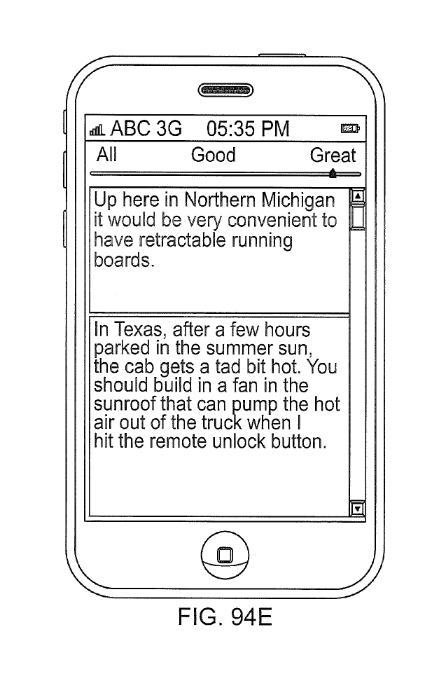

FIGS. 94A-E show screenshots 9400 of an example of our system on a mobile user interface. A participant can be shown, for example, three random postings, and can be asked to vote on them. For instance, in the screenshot in FIG. 94A, The participant is shown an idea in a text box 9402. The participant can categorize the idea as (1) good using the “good” button 9404, (2) okay using the “ok” button 9406 or (3) bad using the “trash” button 9408. The participant can move back and forth between the three random postings by using the “next” arrow 9410 or the “back” arrow 9412. In the screenshot in FIG. 94B, a participant can dial in the level of posts he/she wishes to see in the forum. For instance, by moving the toggle 9414 to the “all” position 9416, the participant can see all the posts, unfiltered. By moving the toggle 9414 to the “good” position 9418, the participant can see all the postings that have been ranked as good or better. By moving the toggle 9414 to the “great” position 9420, the participant can see only the best ideas (or those ranked as great). FIG. 94C shows a screenshot where the toggle been moved to the “all” position, so the participant can see all posts. These posts can be color-coded, for instance with the great ideas in green, the trashed ideas in red and the good ideas in white. In FIG. 94D, the toggle 9414 has been moved to the “good” position. The participant can see all the good and great ideas, which may be color-coded. For instance, the good ideas may be white and the great ideas may be green. Finally, FIG. 94E shows a screenshot where the toggle 9414 has been moved to the “great” position. Now, the participant can only see the great ideas.

Private examples of our system (e.g., used within a business) can include a combination of the public examples described above and some other features. For instance, private examples may include a “most wanted” in which a group/crowd of employees (or participants) may be asked to source (or contribute or list) their top 10 most wanted issues (e.g., the top 10 things they want fixed). From here another session could be run to source and vote on solutions. An action group/crowd with to-do lists could implement the solutions. In some instances, these to-do lists could be group/crowd edited continuously. Furthermore, a smart forum such as those described above might be used during the action phase to keep an open dialog going.

In some examples of our system, sponsors or other administrators may be able to access an administrative user interface. This interface could, for instance, provide information on the participants (e.g., the number of participants. their identities, their login information), allow the administrator to adjust the hurdle rates, allow the administrator to set up email distributions lists and contact the participants, allow the administrator to set up a new session, etc.

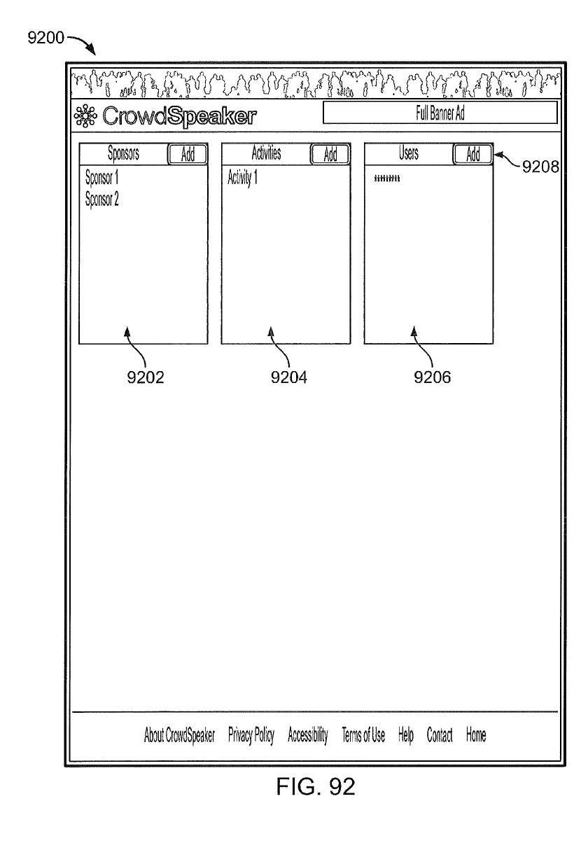

For example, FIG. 92 shows a screenshot 9200 of an administrative user interface. The administrator is able to see the list of sponsors 9202, the list of activities under the administrator's administration 9204 and the list of users 9206. The administrator can add to the lists by using the “add” buttons 9208. Activities can include individual sessions of our system.

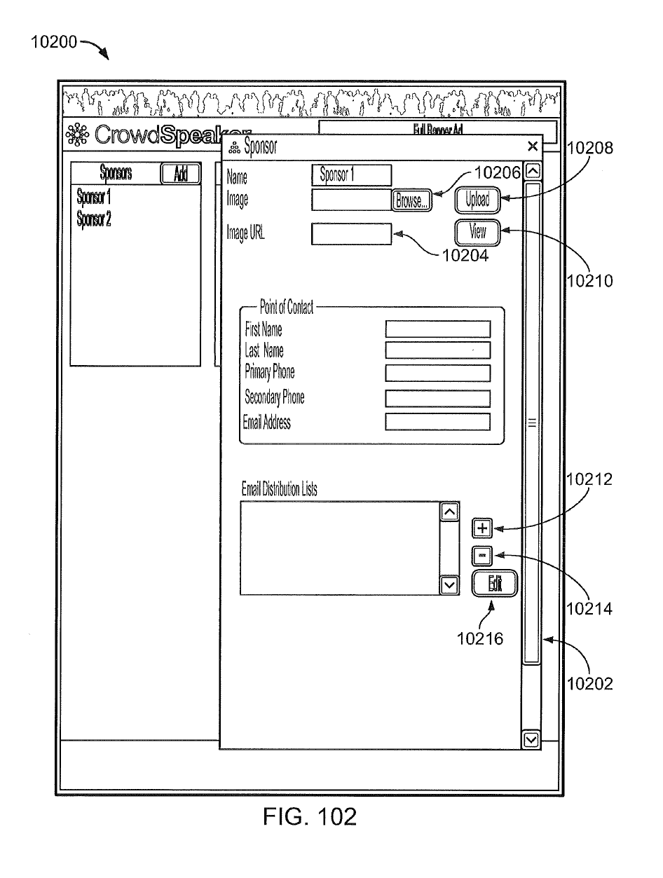

FIG. 102 shows a screenshot 10200 of an administrative user interface. In this example, the administrator selected a particular sponsor, for example Sponsor 1, from the sponsor list 9202 shown in FIG. 92, A pop-up window 10202 shows Sponsor 1's information. The administrator can enter information into the fields 10204, or use the “browse” button 10206 to select an image file. The administrator can upload new information by pressing the “upload” button 10208 or view information already uploaded by pressing the “view” button 10210. The administrator can manage email distribution lists associated with Sponsor 1. A distribution list can be added by using the “plus” button 10212, a distribution list can be deleted by using the “minus” button 10214 and/or a distribution list can be edited by using the “edit” button 10216.

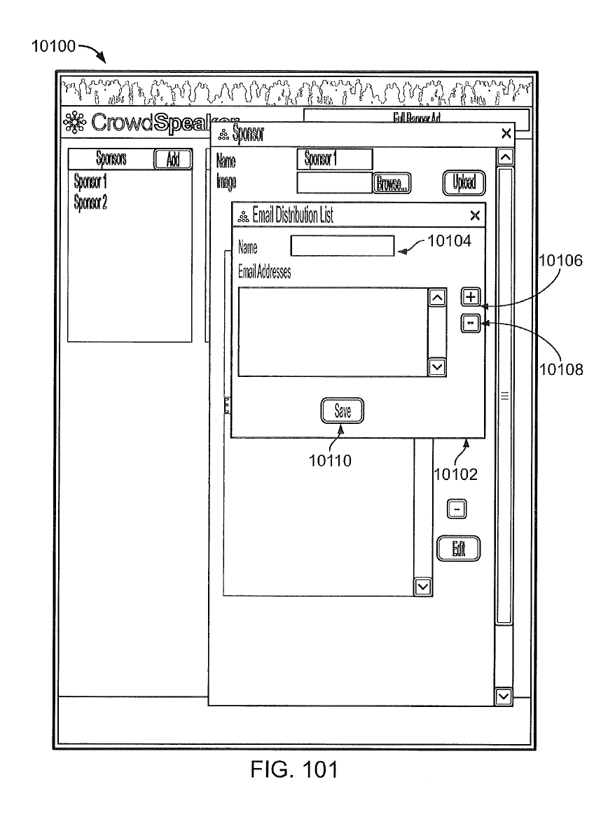

FIG. 101 shows a screenshot 10100 of an administrative user interface. In this example, the administrator used the “plus” button from the screen shown in FIG. 102. A pop-up window 10102 allows the administrator to add a new email distribution list. The administrator can name a new email distribution list by inputting a name into the name field 10104. The administrator can add email addresses to the email distribution list by using the “email plus” button 10106 or delete email addresses from the email distribution list by using the “email minus” button 10108. Changes can be saved by using the “save” button 10110.

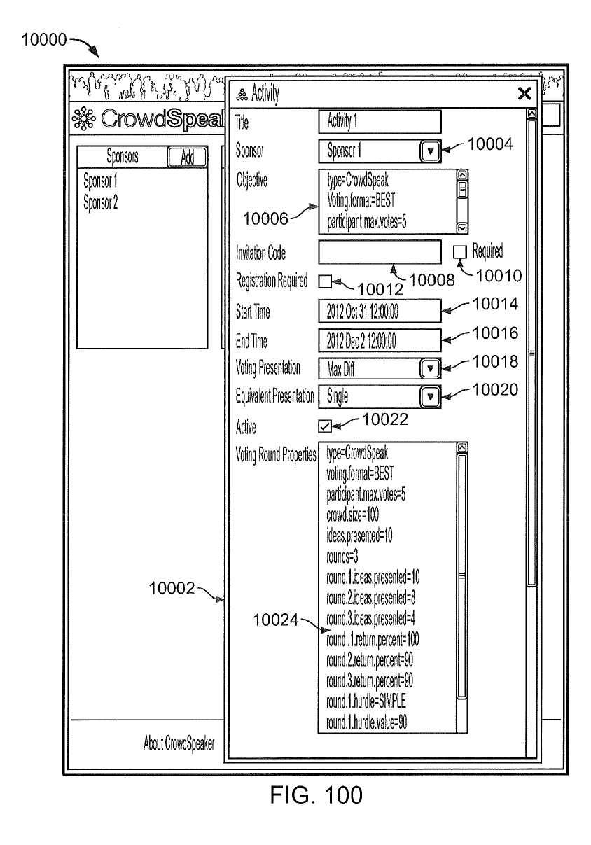

FIG. 100 shows a screenshot 10000 of an administrative user interface. In this example, the administrator selected an activity, for example Activity 1, from the activity list 9204 shown in FIG. 92. An activity can be an individual session of our system, for instance, a session aimed at determining the group/crowd's choice for song lyrics. A pop-up window 10002 shows information about Activity 1. The information can be viewed and edited by the administrator. For instance, the sponsor sponsoring the activity can be changed by using the drop-down sponsor menu 10004. The administrator can enter, view and/or alter the activity's objective by using the objective field 10006. The administrator can enter, view, and/or alter the invitation code by using the invitation code field 10008 (e.g., a code that participants need to enter to join the group), and determine whether an invitation code is required to join the group by checking or unchecking the “required” box 10010. The administrator can determine whether registration is required to participate in the activity by checking or unchecking the “registration required” box 10012. The administrator can enter, view and/or alter the start and end times by using the “start time” field 10014 or the “end time” field 10016. Presentation properties can also be selected, for instance by using the “voting presentation” drop-down menu 10018 and the “equivalent presentation” drop-down menu 10020. The “voting presentation” drop down can be used by the administrator to specify the voting format. For example, the administrator may choose to have each participant presented with n ideas, and instruct each participant to only choose the best one. Alternatively, the administrator may instruct each participant to rank all ideas from best to worst, or rank only the top 3 ideas.

The “equivalent presentation” drop down can be used by the administrator to specify the format to be used to determine which ideas the participants believe to be equivalent or essentially identical. For example, the participant can be asked to place a check mark next to ideas that are essentially identical (as in FIG. 91), or the participant can be asked to group essentially identical ideas into different boxes (as in FIG. 89).

In some examples, another person, group of people, or entity (a “partner”) may be involved in controlling or designing certain aspects of the participants' interaction with the system. For instance, a partner can be a person or entity with a large web-presence that wishes to have some control over the “experience” for their users. In some cases, the partner may be able to build its own presentation software or dictate certain presentation styles, such as “voting presentation” or “equivalent presentation,” and in those cases the “voting presentation” and/or “equivalent presentation” selected by the administrator may not be honored.

The administrator can determine whether this activity is active or inactive by checking and/or unchecking the “active” box 10022 (for instance, whether the activity is available for participants to join). The voting properties can also be entered, viewed and/or altered by using the “voting round properties” field 10024. For instance, the administrator can enter, view and/or alter how many ideas are presented in each round, how many voting rounds will be used, the hurdle rate for each voting round, etc.

In some examples of our system, the administrator can set other parameters for the activities. For instance, the administrator can set the maximum number of times that each participant can vote in a given voting round. The administrator may also be able to set the number of ideas required before starting the activity. If the intended start date for the activity is reached, and the number of ideas is less than this value, we can wait for more ideas. In other examples, if the number of ideas reaches this value before the start date, we can accept more ideas until the start date. Alternatively, the activity can start once the number of ideas is reached. The administrator may also be able to set the total number of voting rounds, and the ideal number of ideas in each competition set (although the actual number of ideas in each competition set could be altered from this number because of calculations made by the software). The administrator can specify how many participants (or what percent of the group/crowd) must submit their votes before we continue to the next round. In some examples, each competition set must be voted on to continue to the next round. The administrator can also set the type of hurdle to apply to each round, including a simple, percent, count or complex hurdle. For instance, the administrator can choose a simple hurdle, such as “all ideas that win X % of the time advance to the next round.” Or the administrator can choose a certain percentage of ideas (e.g., top 10%) or a certain count (e.g., top 5 ideas) to advance to the next round. Alternatively, the administrator could set a complex hurdle (see discussion on hurdles below). The administrator can also choose the value to apply to the selected hurdles.

In terms of variables used in an algorithm, the example could be the following:

rounds=4

The total number of rounds, including the final round which applies a hurdle but does not involve any voting.

round.x.ideas.presented=10

The goal ballot size. This actual number of ideas presented on a ballot could be less depending on calculations made by the software.

round.x.return.percent=100

The percent of group/crowd size that we expect back in this round. This will be the number of ballots we create, and each ballot must be executed to continue to the next round.

round.x.hurdle=SIMPLE

The hurdle to apply to the ideas once voting is complete for this round. Options are SIMPLE, PERCENT, COUNT and COMPLEX.

round.x.hurdle.value=50

The value to apply to the selected hurdle for this round. The unit varies based on the type of hurdle.

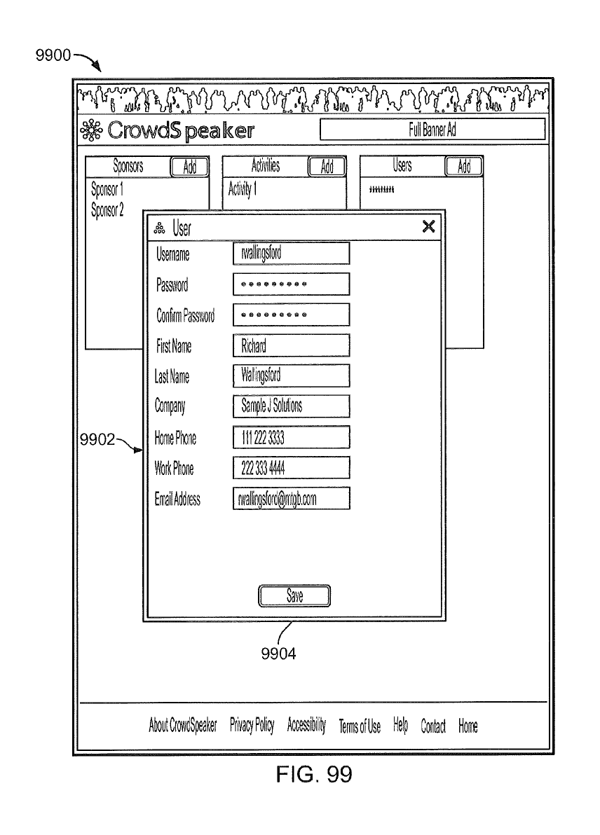

FIG. 99 shows a screenshot 9900 of an administrative user interface. In this example, the administrator selected a user from the user list 9206 shown in FIG. 92. A pop-up window 9902 shows information about the selected user. The administrator can enter, view and/or alter information about the selected user, including the user's username, password, first name, last name, company, home phone, work, phone and/or email address. The administrator can use the “save” button 9904 to save any changes made.

In some cases, in order to truly hear the group/crowd, you must let the group/crowd come to a consensus on what they wish to say. Some examples of our system can achieve this by enabling some or all of the following characteristics: allowing everyone to have an equal opportunity to express their opinion; allowing everyone to decide on which expressions are the best (whose voice should be amplified—whose should be muted); allowing everyone to have an equal opportunity to assist this “best” idea by making an addendum; allowing everyone to decide on which addendums are best; allowing everyone an equal opportunity to modify, edit or improve these best ideas and best addendums; and allowing everyone to decide on which modifications are best.

Some examples of our method allow an unlimited number of people to work through this process, potentially at a very fast speed. Some examples of our system encourage those with little time (but perhaps helpful ideas or experience) to participate, ensuring that high quality knowledge is acquired. For instance, it can ensure that the group consensus is the consensus of a group that includes individuals who are smart, savvy, experienced, talented, etc.

In some cases, to hear the group/crowd, one must first get the group/crowd to collaborate towards finding its own consensus. In some instances, to do this, the vast majority of the group/crowd must benefit from the following features:

The platform/technology should be simple to use. Few will bother to sift through countless web-pages of text, video or audio. Fewer still will bother to learn complicated methods and protocols. Some examples of our system are simple and easy to use because each group members' responsibilities are very limited and simple. Our system can distribute the work broadly to all group/crowd members in extremely easy-to-complete tasks.

The platform/technology should not waste the participant's time. The vast majority of intelligent group/crowd members will not let their time be wasted. Below is a discussion of how certain examples of our system can help ensure that a participant's time is not wasted.

A few good ideas must be separable from many bad ideas, and, for example, participants must know they are actually helping find the good ideas. Some examples of our system can ensure this. For instance, examples of our system can allow the group/crowd to rapidly (measured in minutes or less) locate the good ideas (perhaps 10% of all submitted ideas) while quickly eliminating the marginal and the poor. From here the group/crowd can separate the great ideas from the good (the best 10% of the best 10%) even faster than the initial effort. The needle cannot hide in the haystack.

Some examples of our system distribute the work evenly amongst the group/crowd members such that any one member only needs to view and choose from an extremely small fraction of the total ideas. As the bad ideas are removed, a greater percentage of the group/crowd is able coalesce around the remaining ideas. The group/crowd is only saddled with viewing a few poor and marginal ideas for a minute or so—thus the viewing and selecting process is short and painless. In some examples, as the best ideas surface, the vast majority of the group/crowd will be working on them.

An individual with a good idea must know that his idea will not be lost among all the bad ideas. That is, he must know that he won't end up like one individual screaming in a stadium of 50,000 voices. Some examples of our system can rapidly cull through a huge list of ideas and rapidly eliminate the marginal, so a good idea has a chance at being heard. Since an idea may be shared by others in a large group, the system can allow kindred ideas and the people behind them to rapidly coalesce to form a “louder” voice. In a group of thousands, an individual must share the spotlight in order have a chance at being heard. Some examples of our system can help the better ideas, addendums and edits get a larger share of that spotlight.

Intuitively most of us know that even if we have a good idea, if we share that idea with a large enough group, it will not be the very best. The bigger the group, the less likely our idea will rise to the top. The consensus opinion of the group/crowd (their voice so to speak) is a collective opinion. Thus in all fairness, any one individual group/crowd member should seldom be allowed a solo stint with the collective microphone. However, some examples of our system can allow an individual participant to receive a moment in the sun (with fair recognition for their contribution—no matter how large or small). The truly inspirational ideas can in some cases be extracted from the masses in minutes and get full glory. But with possibly thousands or millions of contributors forming ideas, the odds are strong that even the best and brightest group/crowd members will need assists along the way—and in some examples those assists can be fairly and totally recognized. If an idea is a shared one (multiple individuals come up with the same concept), the system can, in some examples, recognize that as well—and give partial credit where partial credit is due. This fairness doctrine embedded into the system can foster sharing and openness. An individual need not have the single best idea in order to be heard—any help no matter how small can be acknowledged (and perhaps paid).

The brain of a baby grows many more neural connections than it needs. The pathways that are used become bolstered while the paths less traveled get pruned in short order. Our system can use a similar process with ideas. The pruning process needs to be fast enough so that too much effort is not wasted on ideas that are not going to survive. Without the rapid culling of marginal thought (ideas), the group/crowd's efforts may be squandered with individual group/crowd members working on the “wrong” idea and merely spinning their wheels. Some examples of our system can focus the group/crowd's attention on only the best ideas of the group/crowd. As each member chooses the ideas that he/she prefers, marginal and poor ideas are instantly culled. As this culling takes place, a greater and greater percentage of the group/crowd can be deployed to work on the fewer and fewer surviving ideas. In some examples, by the end of a session, everyone is working on the same handful of winning concepts and no one's time or brainpower is going to waste.

Everyone needs an opportunity to speak, not just certain individuals. Some examples of our system have built in a feature to literally mute the overly wordy members of a group. By forcing the group to choose which ideas (or voices) they wish to hear and work on, the loudmouths of the group are silenced. Best of all, they were silenced by default—no hurt feelings and no one for them to blame. This feature is so powerful that we envision a time when even small-group communications (think city council meetings or corporate board meetings) will choose to use the system.

In combination, all of the features mentioned above (as well as others) can have the effect of allowing the group/crowd to truly communicate as a whole. With this ability, a world of possibilities opens up for groups of all sizes.

Using some examples of our system, management can sift through an ever increasing flow of data and simultaneously have qualitative data within its reach. The old axiom of warfare is that the great generals are the ones, like Patton or MacArthur, that lead from the front. As Douglas MacArthur said, “I cannot fight what I cannot see.” In today's world, the corporate “battlefield,” if you will, is scattered—there are countless front lines in terms of the geographic landscape as well as the idea-scape where most corporate contests are waged.

Using some examples of our system, the CEO or manager can lead from the front. The “lay of the land” can be comprehended—the knowledge of global, regional and local business opportunities, strategies, threats, procedures, practices, tactics and techniques. Information can be gleaned from the collective minds of the employees, suppliers and customers. The one (e.g., CEO, manager) will be able to hear the many, with nuance.

Using some examples of our system, procedures and business practices that are highly inefficient (i.e., dumb) can be identified and changed. Corporations can be able to run efficiently and profitably, and the corporate leaders can find and/or hear the people with the answers.

Similarly, examples of our system can be used in government to improve efficiency, prevent waste and help ensure our country's future. Our system can help all the respective parties to truly communicate, debate, brainstorm, come to a consensus and act. Thousands of people with vested interests lobbying hundreds of politicians with access to the pocketbooks of hundreds of millions of taxpayers can communicate effectively. Our system can sort through volumes of knowledge, and countless ideas.

Some examples of our system are designed with collaboration and the formation of the group/crowd's consensus opinion as a primary objective.

Picture a board meeting where all parties are expected to share their input. Let's say that one board member raises a concern or issue and speaks for a mere 1 minute. If there were nine other board members, and each wanted to give their 1 minute reply, it would take 10 minutes. If we wanted to allow replies to those replies, it would take 100 minutes. Now let the other nine board members bring up their own issues with time allowed for counterarguments, comments and rebuttals. And what if each member had two or three issues to raise? And what if they wanted to speak for 5 minutes? Our system could enhance the way even small groups communicate, for example by allowing all an equal chance to be heard, and enabling the participants themselves to decide whose voice to amplify, improve, build on, and coalesce around.

Some examples of our system could be applied in the advertising domain. Ad sponsors can use our system to hold a viewer's attention, credibly and sincerely endorse their products, and spend their resources effectively. Our system can capitalize on image while enabling a true company/customer partnership (including, among other things, getting ideas about what customers want, with all (or many) customers being questioned, heard, and/or included). Using some examples of our system, all (or many) customers can actively participate, creating a real company/customer partnership. Each and every customer could speak directly with the CEO (and being heard clearly), or every potential customer could debate his/her ideas and needs with each and every employee

In some situations, the answers to product questions and issues lie in fragments—bits of the solution sit isolated from each other in the minds of various customers, employees, management team members, scientists and dreamers. Some examples of our system can tap into this group/crowd and efficiently and rapidly (as in hours or days) extract only the best and most pertinent information and ideas. Furthermore, all this could be accomplished while at the same time building a consensus—a signing on of the interested parties—a signing off on the vision/strategy—a signing up of loyal customers, employees and stakeholders. Real partners can get a say, recognition, and some form of compensation.

Below we describe in more detail the simulated example of our system using numbers as proxies for ideas. In this example, 1000 is the best idea and 1 is the worst. Assume that the higher the number, the better the idea. Remember, in some examples of a real session, we won't actually know which ideas would be considered “the best” without having the participants view and then order each and every idea—then average the ordering of all the participants to get a consensus ordering (the ordering agreed upon by the group/crowd).

This example will use data from an actual test of the system.

First, determine how many different “ideas” (numbers in our case) the sponsor wants each participant to view/judge. Let's say it's 10.

Next we build a template for 1000 users with 10 views each and no two ideas ever matched more than once in competition. Each row should be thought of as a set (that is, the numbers (ideas) presented to one user or participant that includes 10 randomly assigned ideas from other users/participants).

FIG. 8 shows an example of a template, with the user/participant number in the first column, and each row representing a set of ideas presented to the user. The sets of ideas shown here are not the actual choices that will be seen by these simulated users.

Once we have all the users/participants ready to go, we randomly assign each to a number on the template (randomizing the numbers/ideas on any given list). FIG. 9 shows an example of a template with the randomized numbers/ideas assigned to each of first seven users/participants. In this example, the idea 771 900 (i.e., the 771^{st} idea) was assigned to the 1 spot in user #1's set. The idea [953] 902 was randomly assigned to the 2 spot in user #1's set, etc. In the example shown in FIG. 9, there are 10 ideas to choose from for each user/participant.

As can be seen in FIG. 9, each user has “voted” for the best idea in his/her set (as indicated by the “local winner” column” 904). That is the local winner. Notice “idea” [953] 902 was the best idea that user #1 saw and thus it was voted best. Further notice that user #2 also saw idea [953] 900 but it was not as good as idea [983] 906—so it lost. This shows the value of random sorting with no repeat competitions (i.e., no idea is ever judged twice against the same idea or pairing, in the first round of voting). Other examples of our system may allow the same pairing to some extent in the first round, depending on the needs or goals of the session. Here, 953 is pretty good (better than 95.3% of the other “ideas”—BUT—if all were riding on user #2's set, 953 would have been eliminated. Yet idea [834] 908 was passed through by user #7 (with a much lower value relative to 953), due to a random juxtaposition with easy competition.

In this example, we use a sorting method that never pairs 2 “ideas” together more than once in the first round (and controls multiple pairings in later rounds).

This way, each idea is competing with 90 other ideas even though any one user never has to compare more than 10 (or less; or more) ideas with each other. By maximizing the number of competitor ideas that a given idea is exposed to (must compete with), the fidelity of the predicted winners is high. This also helps keep the work of any individual participant to a minimum.

This system is intended to replicate the ranking order of the idea list that would result if all the participants (a thousand in our example) ranked each and every idea (1000 down to 1, best to worst) and then each of these one thousand ranking lists were averaged. This would give us a consensus ordering (the entire group/crowd's average ranking of all ideas). In the real world, such an ordering would be difficult determine to verify our results. Getting a thousand people to rank a thousand ideas would be time consuming. It is for this reason that we use numbers as proxies for ideas during our system tests and demonstrations. Numbers are an accepted and known ordering. Thus, when we test the system, we can compare the consensus ordering to the known ordering (for example: 1000, 999, and 998 should be the top 3, and if the system says 1000, 421, 8 are the top 3, then we have a major problem).

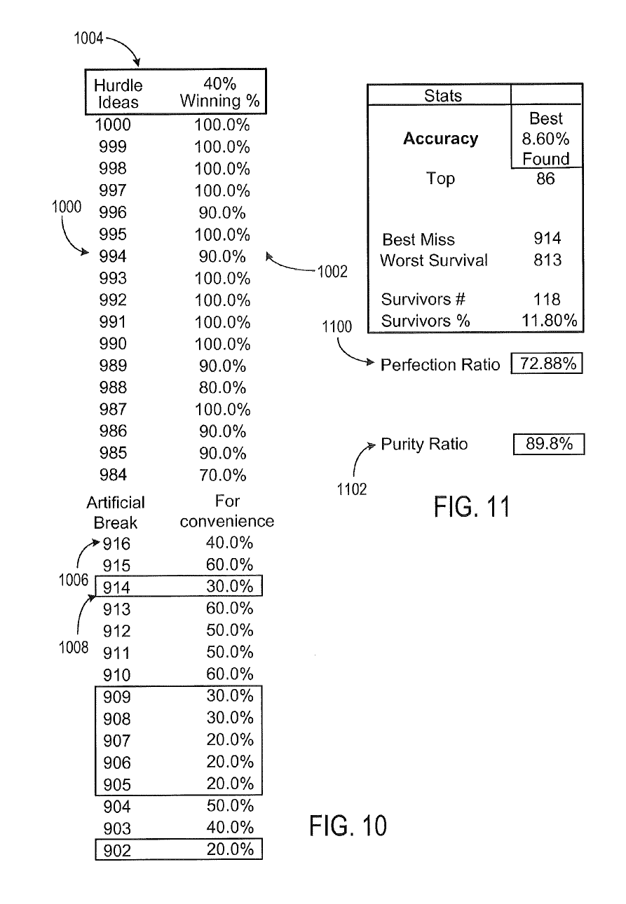

Next we can view how each “idea” fared in its 10 competitions, as seen in FIG. 10. The ideas 1000 are listed in the left hand column and the winning rates or scores 1002 are listed in the right hand column. Here, the winning rates (or scores) are the number of times a participant selected the idea as the winner divided by the total number of times the idea appeared in a set in a given round. (If these were ideas and not numbers, in most examples they could only be sorted by the Winning %, since we would not be able to determine ranking any other way (in our example, using numbers as proxies for ideas, we can sort by “idea”)).

We then set a hurdle rate 1004 for “ideas” to pass if they are to be eligible for further voting rounds. In FIG. 10 we used 40% as an example. Thus, any “idea” that did not win at least 40% of its 10 competitions does not make the cut.

In this example, all the best “ideas”, down to idea [915] 1006, passed without losing any ideas. After this, we randomly lose some ideas that were better than a few of the winners (those that won 40% or more of their sets).

In this example, this is acceptable since our ultimate goal is to filter the best 1% or less. Here we have a big margin of safety. We filtered down to 11.8% of the total ideas and the system returned the absolute best 8.6% (1000 down to 915=the top 86 out of 1000 ideas). The remaining winners were actually extremely good as well—just not perfect.

In this example, we lost idea # [914] 1008 (our “Best Miss”) but kept idea #813 (our “Worst Survivor”) (not shown in FIG. 10). That is, #914 was the highest number did not make it past the first voting round (but should have), and #813 was the lowest number that made it past the first voting round (but shouldn't have). In FIG. 10, we have highlighted ideas that won less than 40% of their competitive voting sets.

Nevertheless, 813 is still better than 81.3% of all the “ideas” AND we did get ALL of the very best 8.6%—more than we needed at this point in the process.

In this example, FIG. 11 shows accuracy statistics used to measure results from a simulation of the system algorithms. In many cases, these figures would be impossible to calculate with a real session. We would not know the true rankings unless the entire group/crowd sorted through and ranked each and every idea. However, it is illustrative for theoretical testing purposes.

The perfection ratio 1100 is the number of “ideas” higher than the best miss, divided by the number of survivors. Here, the top 86 ideas were returned with no omissions before #914. There were a total of 118 surviving ideas. 86/118=72.88%

The purity ratio 1102 is the percentage of winners that should have won that actually did win, given the total. In this example, there are 118 “ideas” that won and since 1000 is the top idea and 1000−118=882, no “idea”/number should be lower than 882. There were 12 ideas that were less than 882. Thus, there are 12/118=10.169% mistakes. 1−0.10169=89.83% of the winners should have been winners. Thus, our purity ratio is 89.83% in this example.

In round 1, we reduced a thousand ideas down to 118 good ideas and found the best 86 ideas. Next we re-run the same algorithm/method with only those idea/numbers that passed the first round (let's say we had 100 winners—for simplicity's sake). Since we have 100 “ideas” (numbers) remaining, but still a thousand participants, each idea will be judged by many more participants in this next round (i.e., a greater percentage of the group/crowd will be determining the fate of each round 2 idea (the good ideas)). Thus, the accuracy of the results will be even better. For reasons described below (see the template building discussion), in this example, we only build competitive sets of 8 “ideas” or less (vs. 10 last round).

Each idea will be in 80 unique competitive viewings (vs. 10 in the last round). Each participant will be judging only 8 “ideas.” This time, however, we do not maintain the “no 2 ideas ever compete with each other twice” rule. But the most they can overlap will be 10 out of the 80 competitions (explanation to follow when we describe how to build a template). Typically we would expect no more than 2 or 3 pairings. Higher pairings become increasingly unlikely.

But even with 10 pairings (very unlikely), the algorithm still works better than the previous round due to the fact that we have 80 competitions per idea in this round. Thus, every idea is compared, most likely, to all others (even though any individual participant only sees 8 out of the 100 ideas that remain).

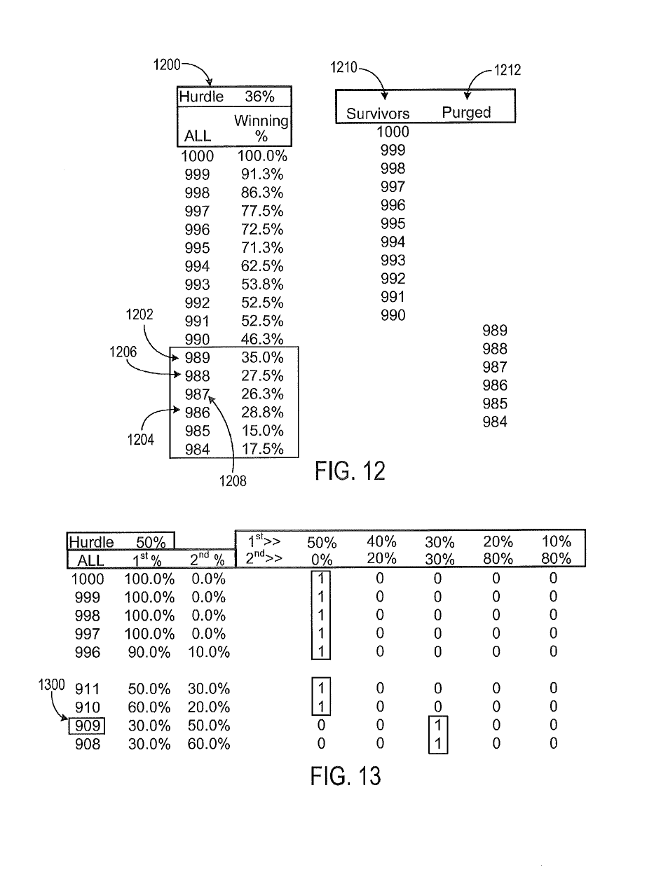

FIG. 12 shows the actual run for a second round test. Here the best 11 “ideas” were selected (we set a hurdle rate 1200 of 36% or higher), and a perfect list resulted. The list of ideas returned (i.e., those that passed the hurdle) are listed in the “survivors” column 1210 and the list of ideas that did not pass the hurdle are listed in the “purged” column 1212. All of the best ideas (highest numbers) were returned. Once again, in many situations, it cannot be known in a real situation if the predicted winners are the best, but all the simulations have returned very high perfection ratios for voting round 2 tests (over 90%).

We returned the best 11/100 or 11%, so our perfection ratio is 11/11=100%. If our hurdle rate was 28.8% wins or better, then we would have picked up idea # [989] 1202 (no problem it's the next best) and idea # [986] 1204 (a small problem as idea # [988] 1206 and idea # [987] 1208 would not have made the cut but are a tiny bit better than #986), and the perfection ratio here would be 12 best/13 total=92.3% perfection ratio. The one that was out of order was “good enough” (i.e., #986 is better than 98.6% of all numbers 1-1000 but it just happened to beat 988 and 987—a mistake, but a minor mistake). And this session was run without the use of other algorithms designed to correct such mistakes, which can be included in some examples of our system.

In this example, in each consecutive round, the “math” works better and better due to more and more competitions (i.e., fewer surviving ideas, divided by the same group/crowd number).

We also can use more complex hurdles. In fact, we have found better efficiency with more complex hurdles than with the simple “how many 1^{st} place finishes did each idea receive” method, described above.

An example of more complex hurdles works as shown in FIG. 13.

In FIG. 13, each user picks a first and second place winner. We then set the hurdle at, say, 50% for 1^{st} place and varying hurdles for second place based on how many times the idea took 1^{st}. For example, you could say that if an idea won 1^{st} place 50% of the time in any given round, it did not need to win any second places in that round to proceed to the next round. If it won 1^{st} place 40% of the time, it would need to win second place at least 20% of the time to proceed to the next round. If it won 1^{st} place 30% of the time, it would need to have also won second place at least 30% of the time to move on, etc.

For instance, consider Idea #[909] 1300 in FIG. 13: it won 1^{st} place in 30% of its competitions—thus it needed to win second place at least 30% of the time to move on. It did—it won 2^{nd} place 50% of the time. In our example, above 0=loss, 1=win.

In some examples, we can have a further variation whereby after any round of voting we can re-run the losing ideas through an interim round. This technique will result in a double elimination of sorts, giving the “best” of the losers an extra chance to qualify and pass to the following round. Combining this feature with the complex hurdle will further insure accuracy when extremely high accuracy is crucial. The tradeoff is that these features result in a little added work for the participants.

Some algorithms in some examples of our system can protect against fraud. In addition to fraud detection, some algorithms in some examples of our system also have the effect of neutralizing the actions of participants that are far-off the consensus of the group as a whole.

In some communication sessions, as the number of participants grows, so does the potential for fraud. For instance, there could be scammers, who will participate with the sole intent of getting a payoff or reward, without having to do any heavy thinking There could also be saboteurs who feel that the best way to help their idea up the ladder, so to speak, is to vote for inferior ideas in their session. They would do this in hopes of preventing other users' good ideas from making it to the next round where they would presumably compete with the saboteur's idea.

Defense #1—In some examples of our system, a lone bad-guy or two will do little to derail the success of the process.

Defense #2—In some examples of our system, rewards for just participating could be limited. For example, for sponsored (public) sessions, each and every participant could only be given coupons for discounts on products. Since most companies make money on coupon purchases, the scammer would be scamming himself. To get a real payout, one would need to get his/her idea picked as a winner—typically, a non-scamable task. This defense makes it hard for the scammer, but not the saboteur. However, even a scammer can mildly affect the score of a potential winning idea, thus detection and correction are preferable.

Defense #3—In some examples, we compare every user's options and choice to the group/crowd's selection pattern. This gives us a very good idea of who is either scamming or just way off the consensus of the group/crowd. Either way, they get identified, neutralized (their decisions are negated) and penalized (if the sponsor wishes). We use the logic that if they passed up some ideas that others loved, they probably did not really contemplate the ideas (they may not have even read through the choices).

If we see that the user's own idea scored well AND he failed this view test—the user could be labeled a potential saboteur. In some cases, someone smart enough to get an idea passed through yet not smart enough to recognize one or more good ideas, does not add up—unless it's a conscious move to game the system.

In some examples, all users could be warned in the beginning not to try to game the session. If an anomaly shows up, the user could be penalized however the sponsor wishes.

Some of the algorithms in some examples of our system can make distinctions and gradations such that we can differentiate between a probable fraud and possible fraud. Our tests show that in the first round there appears to be about a 15% chance that any fraud will go undetected (i.e., 15% of the randomly assigned sets have “ideas” (numbers) that get almost no votes). This can make comparisons and detection impossible (at least for now).

Also remember that in some examples we can't differentiate between a scammer and someone who just has a radically different view than the group/crowd. But since it is the consensus of the group/crowd that we are after, the purging of a far-from-consensus thinker helps our cause. Of course, radical and interesting may be a different story—the group/crowd decides between out-of-the-box thinking and out-of-their-mind thinking Lastly, in some examples, if most of the group/crowd is scamming, then the system degrades. So, it may be helpful to have other mechanisms and defenses such as human monitors patrolling the space. Also, the sponsors may want to have results standards and retain final judgment on whether the session met their objective.

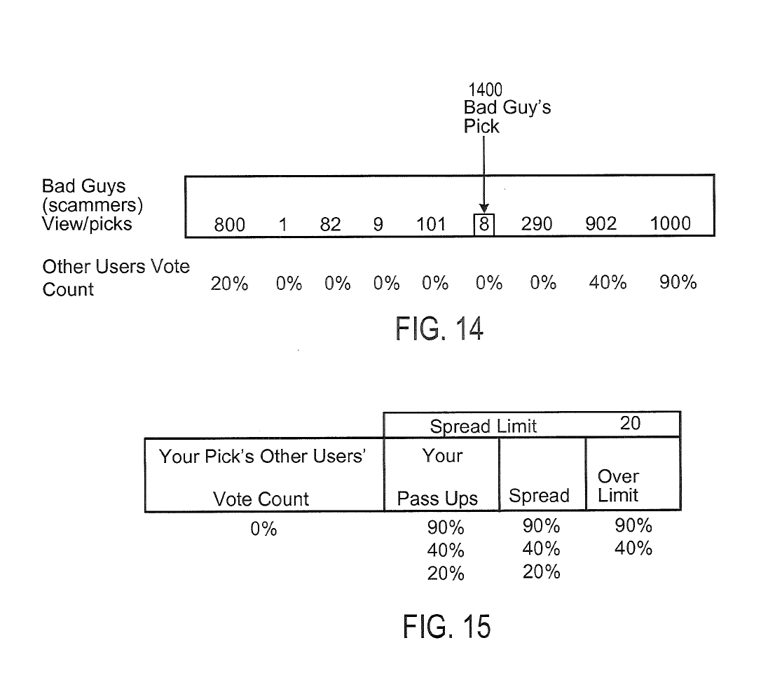

An example of a fraud detection algorithm is as follow. First, we look at every user's set and what they picked (in the following example shown in FIG. 14, our hypothetical “bad guy” picks idea #[8] 1400). In the real world, in many cases, we don't know anything about idea #8. Is it a good idea? Is it a bad idea? We don't necessarily know. Using our numbers for ideas proxy, we know that [8] 1400 is a “low” or “bad” idea. But back in the real world all we may know is that no one else voted for #8 (the other users' vote count=0% for #8).

Furthermore, in the example shown in FIG. 14, we know that our Bad Guy passed up an “idea” that was picked as best in 20% of all of its competitive sets. We also see that he passed up a 40% winner and, most notable, a 90% winner. Whatever this 90% winner is, we can say that it must be pretty good as everyone else who saw it labeled it as best. Again, using our number system we can cheat and see the idea is the 1000 (the best idea).

We can set a limit on the allowed spread between each user's pick and his “pass-ups” (in this case, as shown in FIG. 15, we pick a spread of 20%, which means that if 20% or less other users picked the number he passed up, it is ok). The theory for this is that the group/crowd knows best, in general. If the user in question was far off the group/crowd's determination of which idea is best, we can disallow his/her idea, giving the win to the next best (if we wish). We define “far off” by our spread limit (20% in the following example).

In this example, as shown in FIG. 15, our Bad Guy is allowed to pass up a 20% winner since 20% minus his choice (0%)=20%. A spread of 20% is allowed. But a spread of 40% and 90% in this example are not.

We can then, for example, apply penalty points to our user in question. The higher the pass up, the more penalty points accrue. We can then set a limit on a given level of total penalty points. If the user is over this limit, the user is labeled a potential fraud.

An easier method is a simple limit in which we just set a maximum allowed limit on the difference between a given user's pick (e.g., percentage of competitions in which the user's pick was picked) and higher scoring pass-ups (e.g., percentage of competitions won by the number that user passed up). For example, in the above illustration shown in FIG. 14, our “bad guy” picks 8, which won 0% of all its other competitions. He/she passed up a 40% winner, which is ok if we set the limit at, say, 50% (40%−0%=40%). However, passing up the 1000 (a 90% winner) is enough to trigger a “potential fraud” label (90%−0%=90%, well over our 50% spread limit).

In some examples, we have also gained more information that can be used to find other frauds. If we figured out that this participant is probably a fraud and he/she picked #8 as a winner, we could also say anyone else who picked #8 is a possible fraud (or far enough off-consensus as to be ignored). In a technique we call “guilty by association,” we now label anyone who picked #8 as a fraud (incidentally, in this test, no one else did choose #8).

This can be important, because in some situations many frauds will go undetected otherwise. Take the case of idea #18 in the set which includes the ideas: 408, 399, 18, 796, 514, 717, 767, 341, 722 and 612. Let's say a fraudster (“bad guy”) picks #18.

The problem is that looking at the “Other User Vote Count” in this example does not help us because the set has the following scores: 0%, 0%, 10%, 10%, 0%, 0%, 10%, 10$, 0%, 0% and 0%, respectively.

No other idea (number) in this set scored very high—so we don't have enough information to make the determination of fraud. The fraud does not stand out in this forest of mediocre scores.

But since number #18 was already labeled as the pick of a potential fraudster, using our “guilty by association” rule we can be quite sure that this person is also a fraud.

Caution must be taken in terms of the spread limit—too small a number, and false positives (someone labeled as a fraud, but is not) could multiply in both the fraud checker and the guilty by association filters. Nevertheless, even with some false positives, the integrity of the list of ideas that pass to higher rounds is increased using these algorithms, as the false positives will tend to be “middle of the road” ideas (e.g., in our list of 1-1000, they will be numbers that are not extremely low or extremely high).

Once a potential fraud is identified, we could then replace their pick with the group/crowd's choice (i.e., the highest ranking idea within that set). In our first example above (shown in FIG. 14), we could give the win to the idea that won 90% of the other competitions (the 1000). Thus, the 1000 would then have an edited win rate of 100%. In our second example (where we used the guilty by association technique), we can't tell which idea is the next highest (because all the other ideas won about 10% of their competitions). So, here we could simply remove the fraudster's score and leave all else the same.

At this point, we can cycle through the same logic again if we like with our new edited scores. Meaning, we could take our new scores, plug them into the competitive sets all over again, and see if we find more frauds. The amplified scores (theoretically the corrected scores) will be more likely to draw out a fraud that up to this point is still unidentified.

The fraud check algorithms have several purposes. Group/crowd members could be getting compensated for getting their ideas through to higher rounds. Making sure the winners are legitimate could be of high importance. Also, anything that we can do to weed out bad ideas may give the group/crowd a better experience in subsequent rounds. One goal of the system is to let the group/crowd quickly eliminate marginal ideas so they need not be subjected to garbage in later rounds.

Once we have identified a potential fraud, we can also cancel their votes in subsequent rounds (without their knowledge), which will have the effect of making it easier to catch the remaining “frauds at large.”

One of the main problems in attempting to short-cut the task of sorting through thousands (or millions of ideas) is that with any random sorting method, some of the “contestant” ideas may get an unusually tough competition set (or an unusually easy competition set) by sheer chance. A competition set refers to the set of ideas presented to a given user in a given voting round (here, 10 ideas are given to each participant, so those 10 ideas would constitute a competition set). For any given idea/number, nine other ideas are compared to it in a competition set. In effect, the other 9 ideas “compete” with the idea in question. You may have never heard of Tiger Woods, but after seeing that he had the best score in 10 of 10 competitions, you could still label him as “tough competition.” After he has been given this label, you may wish to cut a break to anyone unfortunate to have competed against him.

In fact, in each round of testing/voting (or competition) there is a distinct possibility that an idea (or number, in our simulations) may be competing with an inordinate number of very weak or very strong competitors, which could distort the outcome of the test. This concern is most critical at the pass/fail point of the hurdle test (to determine which ideas pass to the next round).

In some examples of our system, we may adjust the outcome for a particular idea based upon the level of competition that it has encountered (i.e., we can equalize the competition). We are in essence trying to negate any positive or negative influence that the ‘luck of the draw’ of an idea's competitors will have on the outcome of the testing.

The theoretically perfect outcome of our simulated testing would result in numbers sequenced in order from 1 to 1000. Also, we can assume that perfectly balanced and fair competition would result in an accurate measure of a score's comparative worth or value and result in it being placed in the proper position on a sequential list of winners.

Moreover, we can assume that unusually weak or strong competition could result in a score being placed either too low or too high on this scale.

Therefore, when we want to ensure that we detect and correct for possible errors due to the level of competition faced by each score, especially those at or near the passing mark, we must establish the level of competition with which each of these ideas competes.

Three exemplary methods are described below, which could be used individually or together.

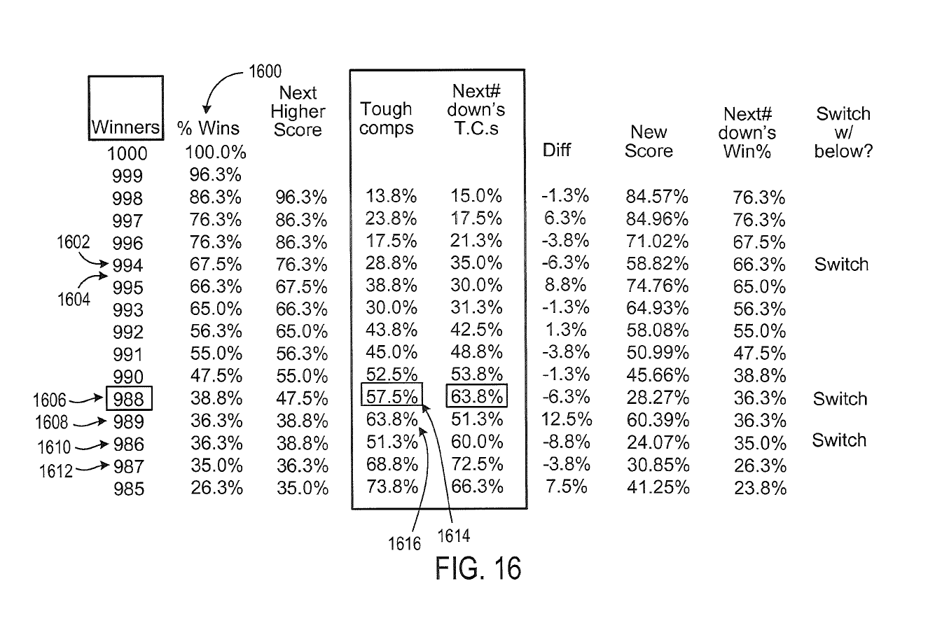

The following is an example of the Competition Equalizer Algorithm: The first example equalizes the competition. FIG. 16 shows the winning order of an actual second round of voting.

In this example, the winners are sorted by “% Wins” order (column 2) 1600. Those ideas/numbers that won more of the competitions in which they competed (or those chosen by participants more frequently) are listed higher than those that won fewer of the competitions in which they competed (or those chosen less frequently by participants). Although the winners are very close to perfectly ordered, there are a few misalignments ([994] 1602 beat [995] 1604, [988] 1606 beat [989] 1608, and [986] 1610 beat [987] 1612). Since, in the real world, the numbers would be ideas, we would often be unable to detect the discrepancy. We would however, be able to detect that idea #[988] 1606 had 57.5% “tough competitions” 1614 (to be described in a moment). #[989] 1608 won fewer competitions, but had 63.8% 1616 tough competitions (an obviously harder task). If we equalize the percent of tough competitions between the two (lower #988's total wins by 6.3% or 5 wins out of 80 competitions, in our example)—does it still beat #989? The answer here is no. Thus, in this example, 988's win over 989 appears to be due to easy competition and not superiority. So we could switch them.

“Tough competition” refers to the percent of an idea's competition sets that contained at least one competitor who scored a higher percentage of wins than the idea in question. In the case of 988, 57.5% of the competition sets that it competed in were “tough” competitions, having at least one competitor with a 47.5% (the next higher idea's win rate) score or better. We then do the same calculation for the next idea down the list. We find that 989 faced 63.8% of its competition sets with competitors that had at least 47.5% win rates. No wonder 989 won less competitions—those competitions were harder, on average, than 988's.

To confirm this, we could next run an algorithm that simply looks up all the competitions where #988 and #989 actually met up with one another (this could be called, for example, a Face-Off Algorithm). We may not use this algorithm in round one, where in this example the maximum any two ideas can meet up is once (and of course many times they don't meet up at all). In this example, in subsequent rounds they meet up sometimes and sometimes they don't. It can be quite informative if 988 won more competitions than 989 yet in each case they “faced-off,” 989 won. In the above example of 80 separate competitions, 989 actually beats 988 three out of three times. In the real world, individual preferences could cause split decisions many times—so we could set a minimum face-off win ratio such as 66.6% or 75% in order to determine superiority.

The following is an example of the Competition Profile Algorithm: Some examples of our system could use another method to test the competition. This method (used in most examples for early rounds) can involve building competition profiles for every competitor idea. In this method, we can take a comprehensive look at multiple aspects of every idea's competition. In round one, every idea goes head to head with 9 other ideas in each of the 10 competition sets in which it competes. After the voting is complete, we can measure how tough the competition was for any given idea. We can see, for instance, how many 30%'s (ideas that won 30% of their competition sets) a given idea faced, how many it beat, and how many beat it.

For example, let's say idea #990 faced an inordinate number of very tough competitors (say the 1000, 999, 998, 997, 996 each in a different competition set). The best that 990 could do would be to win all its other competitions (5 of 10 or 50%). But with this profile method we can look to every competition set that 990 competed in and ask “who did it beat” and “to whom did it lose.” Maybe 990 beat an 80% winner (an 80% er, or an idea that won 80% of its competitions) and only lost to 100% winners. If so, we probably need to adjust its score of 50% up to a higher level. If it beat an 80% er we could make it a 90% winner (i.e., better than an 80% er).

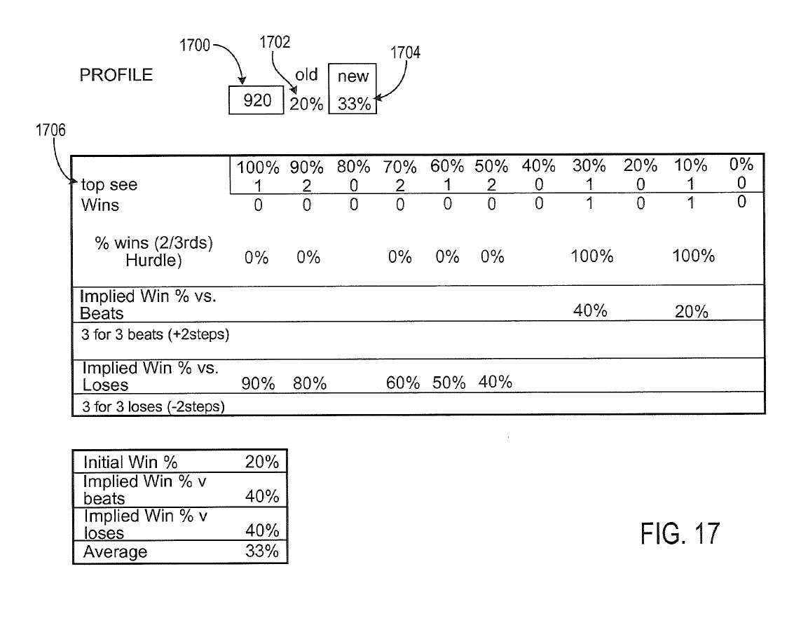

FIG. 17 shows an actual profile of idea #[920] 1700 in our example (remember, we are still using numbers as proxies for ideas where 1000 is best, and 1 is worst). This exemplary competition profile algorithm shows that 920 won only 20% 1702 of its competitions in the first round of voting (not enough to pass on to round two). #604 (not shown in FIG. 17), however, scored a 30% win rate. Passing 604 but failing 920 is not correct. The leaders (all top 10 ideas/numbers) made it through easily—in fact, the top 74 ideas made it through without an error.

After running this example of our profile algorithm (one of our three exemplary competition algorithms), we have adjusted 920's score from 20% 1702 to 33% 1704. This is more than enough to pass 920 on to round 2. By the way, #604 (not shown in FIG. 17) was downgraded to a score of 23% (a non-passing score). Thus, the algorithm in this case correctly replaced 604 with 920 on the winners list—potentially a very important benefit. The following is an explanation of how the algorithm works.

Thus, FIG. 17 is an example of a deliberate upgrading of scoring.

In charting the competition profile for a given idea, we can have a column called “top see” 1706. When we look inside any given competition set for a competing idea (number), we look at the highest scoring competitor (strongest competitor). Suppose for a given competition set in which 920 competed, the highest scoring idea (excluding itself) won 70% of all its competition sets. We call this the “top see” for that set. We then sum up how many 90% ers were top sees, how many 80% ers were top sees, etc. In some competition sets, the highest scorer (excluding the number being considered for alteration) could be a 0% winner.

We can then check to see in which competition sets our idea (920) won or lost. Thus, we know if 920 fought and beat any given score. We also know to whom 920 lost.

For each idea/number in question, we take a look at all of the competition sets in which it competed. What we know at this point is which “ideas” won each competition set and what every competitor in all the competition sets scored (how many sets those competitors won).

This gives us a general (and good) sense of our idea's “strength.” This is some of the information that we can now use to judge the number/idea 920.

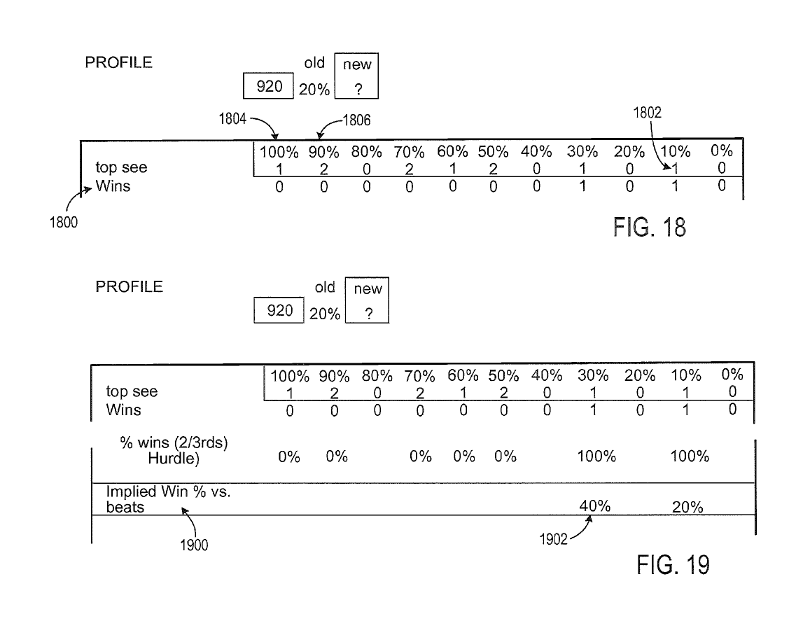

If we look at every competition set that 920 competed in, we can build the profile. We list a count of each “top see” and note if the number 920 won. FIG. 18 shows this stage, at which we know the overall winning rate for idea #920, and have built a chart with the “top sees” and whether 920 won (the “wins” row 1800).

We start by looking at every competition set in which 920 competed. One of the 10 competition sets is: 624, 571, 930, 647, 499, 286, 699, 151, 910 and 693.

Next we delete the number 920, as it is not competing with itself (and we are measuring competition strength). So, our remaining competition is: 624, 571, 647, 499, 286, 699, 151, 910, and 693.

Then can we convert the ideas to their win rates (scores) from the first voting round: 624=0% win rate, 571=0% win rate, 647=0% win rate, 499=0% win rate, 286=0% win rate, 699=10% win rate, 151=0% win rate, 910=10% win rate and 693=0% win rate.

Then we can look for the maximum score in that competition set. In this case it is 10%.

We label this a “Top See” 1802.

We can also ask if our 920 won this competition set. Here, it did. So, we also can say that 920 beat a 10% er (that is, an idea that won 10% of its competition sets). A “1” in the “wins” row 1800 indicates that 920 won once, and a “0” indicates that idea 920 did not win.

When we do this for each of the 10 competition sets, we end up with our profile shown in FIG. 18.

In this example, we can see that our 920 faced one 100% er 1804, two 90% ers 1806, etc.

We can also see who 920 lost to and who it beat.

This allows us to infer the strength of the idea 920, and to infer a score (win rate) that could be different than the actual score (win rate) it achieved. For example, if a given idea won only 20% of its competition sets, but it came up against a couple of 40% winners and beat them both, we could say that it should have been a 50% winner, not a 20%. Since it beat the 40% s, we infer a score of 50% based on who the idea actually beat. We can do the same inferring process for losses, and then we can average the original score with the inferred scores.

We can say that if 920 beat 1 out of 1 10% ers that it must at least be a 20% er. And if it also beat 1 out of 1 30% ers then it is implied to be a 40% er. We use the max score that it beat and raise its own score to the equivalent of one vote better to find the Implied Win Percent based on beats.

Thus, in this example (as shown in FIG. 19), our Implied Win Percent based on beats 1900 is 40% 1902 (very different from our starting point of 20%).

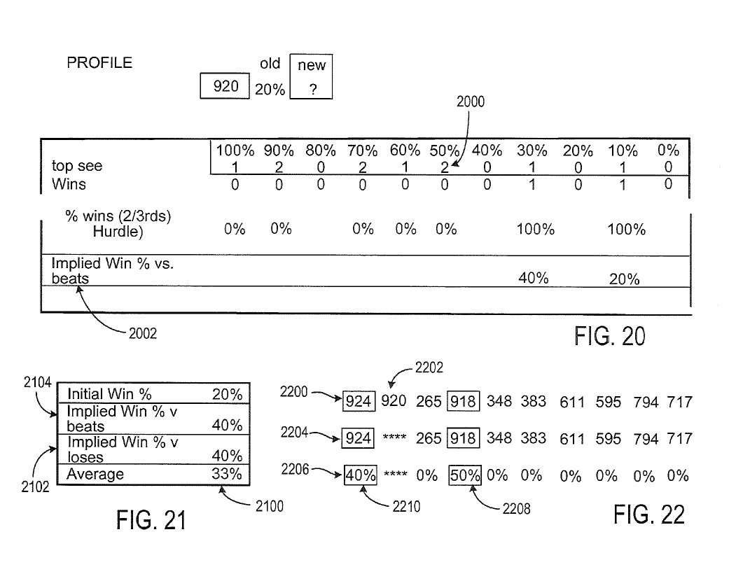

But what do 920's losses imply? This is shown in FIG. 20.

The lowest competitor that 920 lost to was a 50% er 2000 (an idea that won 50% of its competitions in the voting round). Actually, it lost in 2 sets where a 50% er was the maximum. To calculate the Implied Win Percent based on losses 2002, you can take the lowest competitor the idea lost to, and assume that the idea's score was equivalent to one score lower.

Therefore, the Implied Win Percent based on losses 2002 is 40% in this example (also very different from our starting point of 20%).

Lastly, as shown in FIG. 21, we can take the 3 pieces of information we now have and average them to get a new score 2100.

Many times the Implied Win Percent based on losses 2102 is quite different than the Implied Win Percent based on beats 2104, so we can average them in with the original score. This is just an example of this method. Other examples of our system can, for example, weight the Implied Win Percents 2102 and 2104 differently.

Regarding the Profile Method, in FIG. 22, the first row 2200 shows an entire voting set in which idea [920] 2202 appears. The second row 2204 shows the set with idea [920] 2202 removed, since 920 is not competing with itself. The third row 2206 shows the win rates for the ideas appearing in a given column.

In one of 920's competition sets (the one depicted in FIG. 22) the maximum scoring idea was a 50% er 2208, but the actual winner happened to be a 40% er 2210. This information could be important, and is captured by the fact that in our profile method, we use the maximum score versus the actual win to label our “top see.” We do this with the logic that if this 40% er was good enough to beat a 50% er, it probably is better than your average 40% er (it could also be that the 50% er is really something less—but that is a bit less likely).

Using the profile (the spectrum and distribution of “top sees”) that we defined above, some examples of our system can judge the weight of competition faced by any particular idea (number).

An Interquartile Range Method could be used. Any one individual piece of data about the other ideas a given idea had to compete against, including the mean, median, mode or range scores for the competition, fails to provide an accurate picture of the full weight of the competition that an idea faces. For that reason, we have decided in some examples of our system to use a range of scores to identify the theoretical ‘center’ of the distribution of competitive values competing with each idea.

We sometimes refer to this range as the Interquartile Range Q1 to Q3.

Q1=Quartile 1, the 25^{th} percentile of the distribution. Q3=Quartile 3, the 75^{th} percentile of the distribution.

A quartile is defined as any of three points that divide an ordered distribution into four parts, each containing one quarter of the scores. The First Quartile (Q1) is a value (not a range, interval or set of values) of the boundary at the 25^{th} percentile. It is a value below which one quarter of the scores are located. The Third Quartile (Q3) is a value of the boundary at the 75^{th} percentile. It is a value below which three quarters of the scores are located.

The Detection Phase:

In this method, the first step is to determine which distributions should be corrected due to the level of the competition they encountered. That is, which idea faced unfair competition? There are two types of triggers or criteria that will indicate the presence of ‘unfair’ or overly weak or strong competition that should be corrected for.

The median score from the competition differs from the ideal median (50%) by, e.g., more than 10%. This criterion would disclose a distribution with very high or very low overall competition.

The differences between the median and the two quartiles vary by more than, e.g., 10%. That is |(Median-Q1)−(Q3-Median)|>10%. This criterion would disclose criterion indicating a skewed distribution of wins (lopsided competition). This could be true even when the median is 50%.

The Correction Phase:

In this example, after we determine that a distribution should be corrected due to the competition encountered, we can employ the following algorithm: we average Q1 and Q3, subtract 50%, then add the original score's outcome. This becomes our new or adjusted score that compensates for different levels of competition.

Averaging the quartiles gives a good measure of the overall ‘positional weight’ (lopsidedness) of the distribution and the step of subtracting 50% (the ideal center of a normal distribution) measures how far we are either above or below the center of an ideally balanced distribution. Adding the result of these calculations can provide the proper adjustment to our original score.

### Example #1

For this example, assume that 30% is a passing score.

In this example, Detection Test (b) tells us that the difference between the median and the quartiles indicates the distribution is sufficiently skewed to warrant some adjustment (the competition test is warranted).

For example, consider competitor idea 869. Its original score (win-rate) was 30%. This would be a passing score in this example. However, Q1=20% and Q3=60%. After applying this algorithm, the new score is only 20% (New Score=(20%+60%)/2−50%+30%=20%). This score would now fail, and would not pass to the next round.

### Example #2

Again, assume that 30% is a passing score for this example.

In this example, the median is 65%. In this example, Detection test (a) indicates that the median varies by more than 10% from the perfect median score of 50%. Therefore, the score could need to be adjusted (the competition test is warranted).

For example, consider competitor idea 926. It had an original score (win rate) of 20%. This would be a failing score in this example. But here, Q1=40% and Q3=80%. The new adjusted score would be 30% (New Score=(40%+80%)/2−50%+20%=30%). This score would now pass to the next round.

Using the Interquartile Method, distributions with wins skewed on the high end of the distribution will result in positive adjustments (adding to the score) thereby increasing the original score's position because it has dealt with strong competition (the idea was competing against a lot of relatively strong ideas). Distributions with wins skewed on the low end of the distribution will result in negative adjustments (reducing the score) thereby decreasing the original score's position because it has dealt with weak competition (the idea was competing against a lot of relatively weak ideas).

Extensive testing using actual numbers has shown that this method detects and corrects for many errors resulting from extremely weak or strong competition, and it does so in the correct proportion. The resulting corrections move the scores into a range where they belong (if all competition was fair).

The few situations where this test/method is least effective are those where the standard deviations are very large, i.e., where there are large holes in the competitive wins data (for example: if a given idea/number faced no 30%, 40% or 50% as its “top sees”). Of course, in those cases, we can simply ignore the adjustments.

Cycles:

In all methods of competition testing (and fraud detection for that matter) (e.g., the Competition Equalizer Algorithm, the Competition Profile Method, and the (3) The Interquartile Range Method) we have found it can be beneficial to run through multiple cycles. This can be done by substituting the adjusted win rate scores for the original scores and re-running these tests. In the first cycle, some of the adjustments will be based on partially incorrect data. The very scores we are attempting to correct are being used to correct other scores. This circular logic can do some damage as well as good, if the tolerances are set too loose.

The first cycle should only adjust a score if the suggested correction is extreme. Extreme adjustments have a much higher probability of being correct adjustments. By only using the extreme changes for our first cycle, we can use the cleaner (more correct) information that results to run our next cycle. For each new cycle, our confidence level rises that our adjustments are correct.

In some examples of our system, the algorithms used to adjust the ideas' scores can happen automatically and immediately after the participants have made their choices—and with no involvement from the users. Thus, in some examples, this work is invisible from the standpoint of the participants.

The following is an overview of a template building method. In some examples of our system, our goal is to minimize the number of pairings of any two ideas in competition.

In some examples, it is necessary to have different templates for all combinations of users and ideas per competition set (e.g., 20 to 20 million users with any number of ideas per competition set (e.g., 2, 5, 8, 10, etc.)).

In some examples of our system, this can be accomplished using a formulaic method that can randomly distribute the input, and match them in sets of various sizes—while never pairing any two inputs more than once in round one (and minimizing pairings in subsequent rounds).

The method can be very fast and scalable to any number of users or ideas per set. It could integrate seamlessly into a process/platform.

Example of the Methodology:

1. Determine the number of participants and ideas.

2. Determine how many ideas that each participant will view/judge (the size of the competition set). This number will typically be around 3 to 10 and is limited by a factor we will outline later.

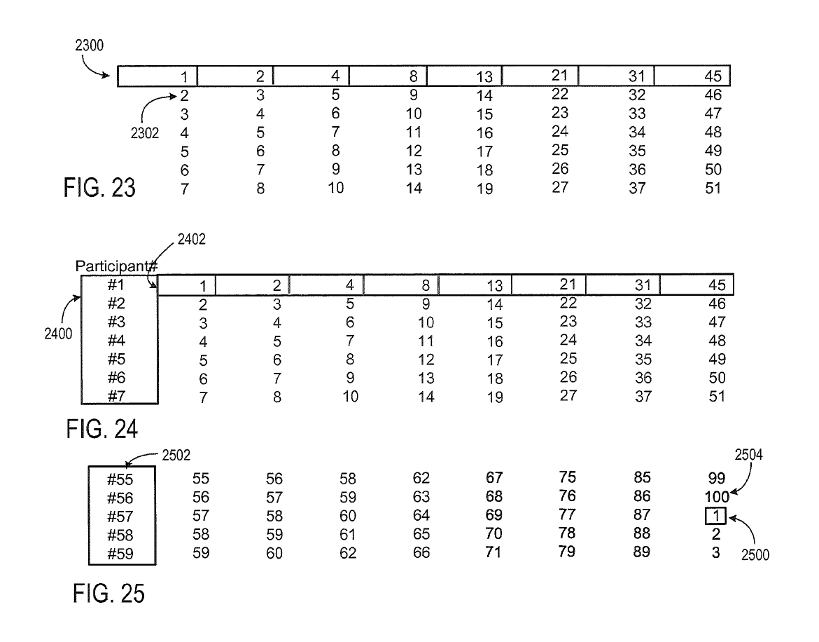

3. Build the template: For example, assume there are 100 ideas to divvy out, eight times each, to 100 participants. That is, we want each idea to be seen by 8 participants in this round. We start the first set of the template with the Mian-Chowla number sequence (up to the 8^{th} number in that sequence, as that is how many views/choices we want to give every participant/chooser). FIG. 23 shows the first set of the template in the first row 2300, with the numbers 1, 2, 4, 8, 13, 21, 31, and 45. The reason for using this sequence is that the gap between any two integers is distinct from any other two integers. Later we will explain this further. Remember that our 100 participants will each be randomly assigned a number on the template. Each will also receive a competition set (one of the rows, such as the first row 2300 in FIG. 23) of other participants' ideas to review. From their given set, they will, e.g., choose the idea with which they most agree.

To build subsequent competition sets (rows) we can then add, e.g., 1 to each number. This is shown in FIG. 23 in the second row 2302. We need all numbers displayed, of course (1-100, 8 times each). By adding 1 to the previous set's numbers, we keep the distinct “gaps” the same for every row (e.g., in the first row 2300, the gap between 8 and 13 is 5, and so is the gap between the corresponding numbers in the second row 2302 of the template (9 and 14)).

Remember that each row represents a competition set of ideas (mere numbered place holders at this early stage) that will be assigned to the participants at random. FIG. 24 shows individual participants being assigned to the rows of competition sets. For example, participant #1 2400 is assigned the competition set with the numbers 1, 2, 4, 8, 13, 21, 31, and 45 (the first row 2402).

As shown in FIG. 25, as we continue to increase each row by 1 integer, we will eventually reach the maximum number of ideas (100 in this case) and need to start the count back at idea [1] 2500. The leftmost column in FIG. 25 shows the participant number (e.g., the 55^{th} participant 2502).

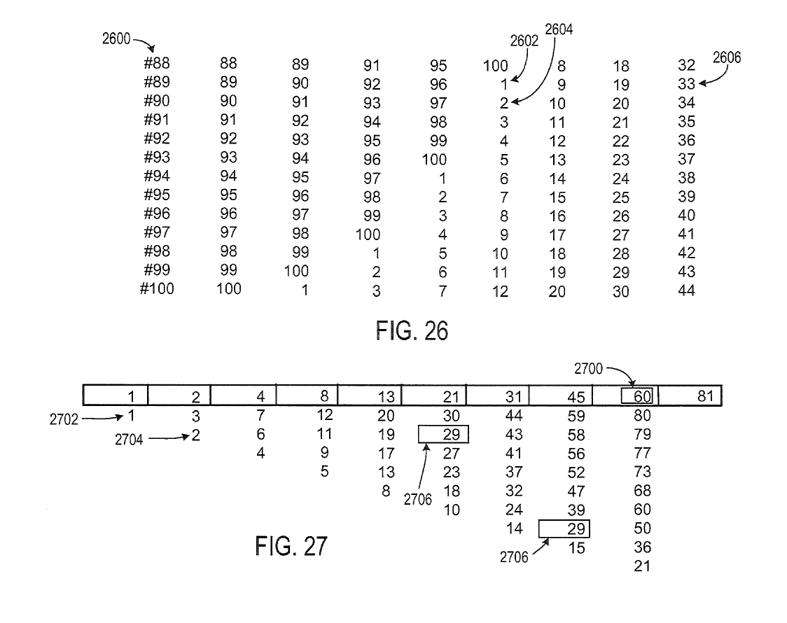

If there are only 100 ideas, then all columns except the first will eventually hit idea [100] 2504 and need to start back at 1. This is also shown in FIG. 26, which shows the sets assigned to participants #88-95 (see the leftmost column 2600 for the participant number). But in this example, no row (competition set) 2606 ever duplicates a pairing, e.g., idea [1] 2602 only competes with idea [2] 2604 one time. If any pairing is seen in any row, it will never be seen again. Furthermore, each number in the template shows up in 8 separate competitive sets. This method maximizes the number of competitive ideas that each idea competes with.

We next assign every user/participant a random user number and a random template number.

Then we scan for any users that received their own idea in their set. Since in some examples we do not want to allow “self-seers,” we can simply swap a “self-see” set with someone else's set (so that there is no voting on your own idea). This can be done until all self-seers are eliminated. In other examples, participants may be allowed to vote on their own ideas.

At this point, we are ready for the participants to make their selection(s) as to their favorite idea(s)—the voting is now possible for round one.

Using our method of template construction, any number of participants and choices can be very quickly randomized with, e.g., no duplicate pairings.

In subsequent rounds when the number of remaining ideas is a fraction of the number of participants, multiple pairings may occur—two ideas may compete with each other more than once. In some examples, we can still use our templates however to maintain very low multiple-pairing rates.

The Mian-Chowla sequence is the most efficient (lowest possible numbers sequence) that will allow us to build a template that doesn't duplicate a pairing. If you sum any pair of integers in the sequence (including one integer plus itself), you will never get the same answer twice. Take 1,2,4 in the sequence: 1+1=2, 1+2=3, 2+2=4, 1+4=5, 4+2=6, 4+4=8. The answers (2,3,4,5,6,8) are all distinct—no integer appears twice.

In mathematics the Mian-Chowla Sequence is an integer sequence defined as follows:

“Let a₁=1

Then for n>1, aₙ32 is the smallest integer such that the pairwise sum aᵢ+aⱼ is distinct for all i and j less than or equal to n.”

Conversely, this implies that all the differences (or gaps) between the elements of this sequence will also be distinct. Most importantly, subsequent rows (not the Mian-Chowla sequence) will maintain these gaps if we build them by adding 1 to each row in turn.

Using these integers it is possible to construct a template or table with a defined number of columns and as many rows as you wish such that no two integers appear together more than once.

This is true because the differences (or gaps) between the elements of the Mian-Chowla sequence maintain an ‘offset’ that prevents duplicate pairings from occurring.

If we then match these integers with our participant's ideas, we will have constructed a template that ensures that no idea competes with any other idea more than once.

There are, of course, an unlimited number of sequences for which this property holds true, but the Mian-Chowla sequence is an efficient sequence with this property because each of its members, aₙ, is defined as:

“ . . . the smallest integer such that the pairwise . . . ”

It is, therefore, the example we use for how to build our template. However, any other sequence that does not allow more than one pairing of any two ideas can be used.

In the example shown in FIG. 27, we start with a number sequence (in grey) that is close to the Mian-Chowla sequence except for a substitution of number [60] 2700 for 66. The numbers below the grey row represent the spread between every combination of the top row's integers. The second row 2702, for instance shows the gaps between 1 and every other integer in row one—the third row 2704 shows the gaps between 2 and every other integer in row one (except 1, since that gap was already shown in row 2). The key is to never have a spread between any 2 numbers that is the same spread between any other two numbers. If you do (and you build your template rows by adding 1 to every number in the first sequence) you will get a duplicated pairing.

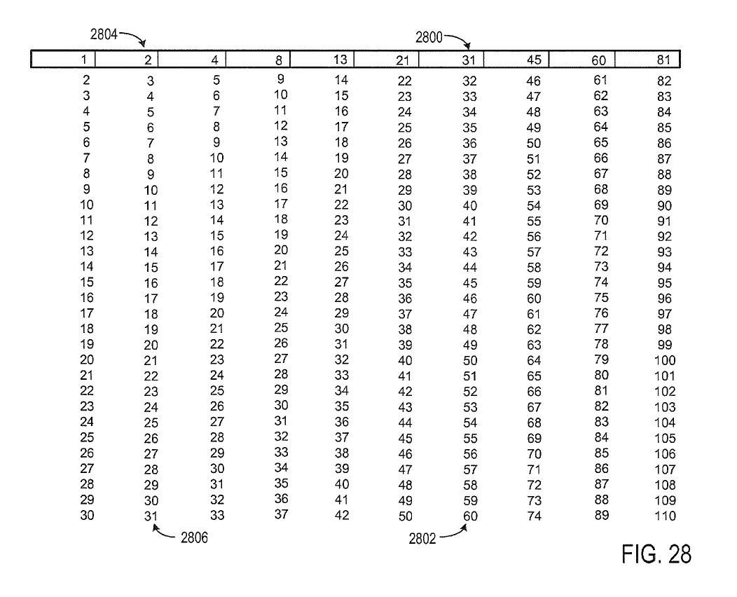

Notice that in FIG. 27 the number 29 2706. This is to show that there are two spreads that equal 29 (the 31 minus the 2 AND the 60 minus the 31). Let's call them twin spread 1 and twin spread 2. As we build the template (see FIG. 28) and add 1 to the digits in each row (competition set), we will eventually find that the high number of twin spread 1 (the column under the 31) 2800 will eventually hit the number [60] 2802 (the top number of twin spread 2). When it does, the 2 column (the low number of twin spread 1) 2804 will of course hit [31] 2806 since the spread between 2 and 31 equals 29—as does 60 minus 29. You will see if you follow down the 31 column 2800, when it hits [60] 2802, the 2 column 2804 is hitting [31] 2806. Thus, 60 and 31 will eventually pair up more than once (in both the first row and the 30^{th} row).

This is why we need all the “gaps” between any two columns to be distinct if we do not want duplicate pairings—So the columns can never catch up to one another no matter how far down the template is stretched.

Limitations on “ideas” per competition set: To build templates as have been previously described, it should be noted that there is a limit to the number of “ideas” per competition set (a limit to how many choices each participant can be shown). The limitation is a factor of the lesser of: a) the number of ideas or b) the number of participants/choosers.

The methodology is, for example, as follows:

Denote the lesser of the number of participants and the number of ideas asp.

Provide a Mian-Chowla number aₙ, the Mian-Chowla number being the nth integer in the Mian-Chowla sequence.

Form a quantity (2aₙ−1).

Solve for n to be the largest integer that satisfies (2aₙ−1)≧p.

Set the number of ideas per group to be n.

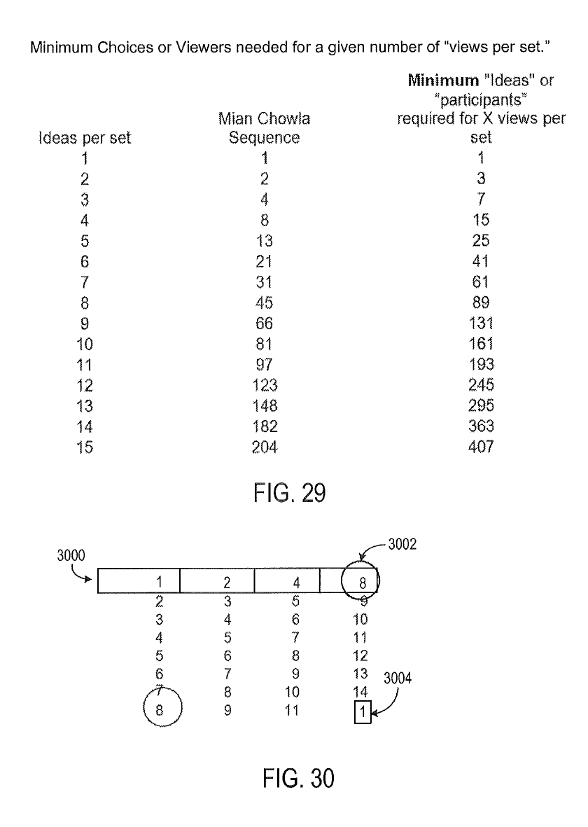

Using this method, you can obtain the results shown in FIG. 29.

An example follows.

FIG. 30 shows a template has been built with 4 “ideas” per competition set (row) 3000 and 14 ideas. When the integer in the first column hits the last number of the first row (8 in this case) 3002, the last number in the last row must not have resorted back to [1] 3004—otherwise there will be a duplicate pairing (1 and 8 would compete in both the first row and the last). This means that the last number in the last column must be one more integer than the number directly above it—in this case, one more than 14. Thus, in the example shown in FIG. 30, 15 is our minimum number of ideas needed if we want to show 4 ideas to each participant with no duplicate pairings.

We now see that if we want to show 4 ideas to each participant we need at least 15 ideas. The template in FIG. 31 shows that we can now accomplish our potential goal of no duplicate pairings by following the protocol described above.

Notice, however, that we have an uneven distribution of ideas (numbers). Idea # [1] 3100 only shows up in one set (row) yet # [8] 3102 shows up in 4 sets. This means only one person would decide the fate of idea #1 compared to 4 participants deciding on idea #8. In some examples of our system, that would not be desirable.

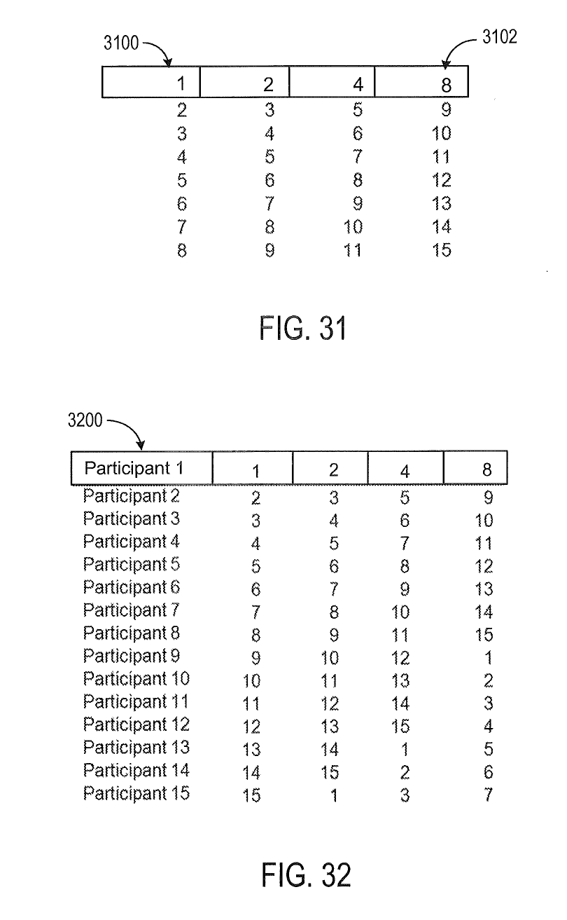

To fix this inequity, we will also need at least 15 participants to choose from 4 ideas (as well as needing at least 15 ideas). This is shown in FIG. 32, with 15 participants listed in the first column 3200 each assigned competitions sets (rows) of 4 ideas each.

In the example shown in FIG. 32, any number of participants greater than 15 will work (if we want to show sets of 4 ideas).

Another example follows.

Suppose we have 100 participants and 100 ideas. In this example, we want each participant to pick from sets of 10 ideas each. We further wish to show each idea in 10 competitive sets (logical if we have 100 participants looking at 10 views each=100×10=1000 views. If there are only 100 ideas to view, each will be seen 10 times). In this example, our goal in randomizing the views is to never have any 2 ideas matched in any set more than once. This is key in comparing each idea to as many competitors as possible (thus extracting as much information as possible from our first round of geometric reduction). Looking at our minimum table (shown in FIG. 29), we see that in order to have sets of 10, and honor the “no pairings twice” rule, we would need at least 161 ideas and at least 161 participants. Thus, we see that for this exercise we are limited to 8 views for each competitive set if we want to meet our other criteria.

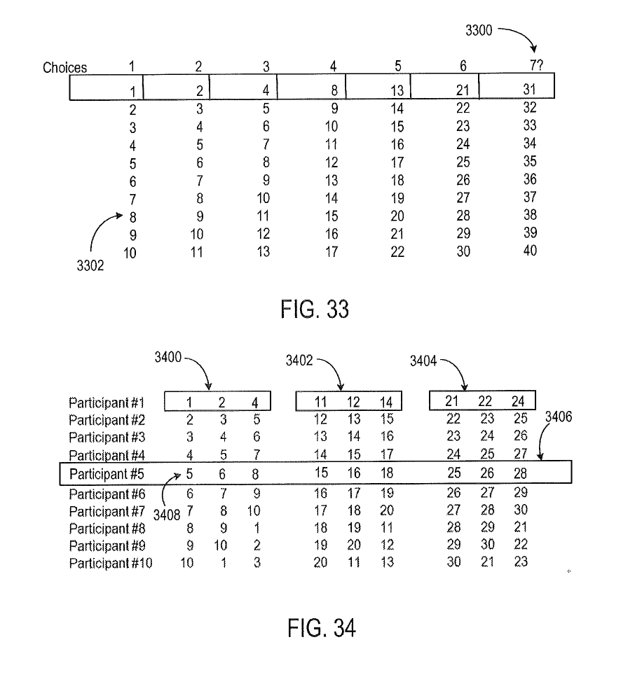

More Ideas Than Participants: There will be instances where we may wish to have a smaller number of choosers/participants than choices. For example, we may want 10 “experts” to view and decide on 30 submissions (or 100 “experts” to view and decide on 300). In this case, we might try to build one template for 10 users with 6 choices each—which appears to be the logical method at first glance, since we need 30 numbers on the template. As shown in the table in FIG. 33, 7 choices each is impossible. Since we have 30 ideas to distribute we will be out of luck with 7 columns as the template will need to fill in choices #31, 32, 33 . . . to 40 (see the last column 3300). But we only have 30 choices/ideas not 40.

But even with our 6 choice template we have another problem—some numbers (choices) in this template shown in FIG. 33 only show up once (1, 23-30), while other choices, like number [8] 3302, show up 4 times. This can seem unfair.

The remedy: For a case such as this, we can use a variation on our template. Going back to our minimum participants for X views per set table (shown in FIG. 29), we see that for 10 participants, the most we can have is 3 choices per set. However, since we have 30 choices, we can use a variant method. We can keep our 3 choices per set but we can make three separate templates. FIG. 34 shows an example of the three templates. This is done because we have 30 ideas with 10 judges (participants)—the 10 judges limits us to a 3 column template (and a 3 column template with 10 judges only takes care of 10 ideas). But since we have three times that number of ideas, we can run the exercise 3 times. Furthermore, we run it 3 times all at once. We can do this without overly stressing the judges/participants since three temples with 3 columns each, cobbled together, only equals 9 views each (close to the sets of 10 we described above for first rounds). Template 1 3400 will take care of ideas/choices 1-10, Template 2 3402 will take care of ideas 11-20, and Template 3 3404 will cover ideas 21-30. We can then patch these 3 templates together to give each participant 9 choices, as seen in FIG. 34.

The downside to this method is that each “idea” (number on the template) will only show up in 3 competition sets out of the total of 10. Notice the rectangle 3406 around Participant #5 and his/her competition set. Participant #5 sees those 9 “ideas” (potentially seamlessly, unaware that there are 3 templates). Further notice that idea [5] 3408 only shows up for participants #5, #4 and #2. With only 3 people judging each idea (even if this was 100 choosers and 300 choices, there would still only be 3 judges per idea), there is a greater possibility of error. Thus, it might be preferable in such a case to ask each participant to pick a 1^{st}, 2^{nd} and 3^{rd} choice (so that we get 3 times the information). The added information could increase the validity of the results. This method works better if the judges are of a similar mindset, since the fate of any idea in this example rests on just three judges.

Subsequent round template building process: Let's say that round one pares the total ideas (that started at a thousand) down to 100. There are still a thousand participants to do the viewing/choosing. Using the “Minimum Ideas or Participant Table” (FIG. 29), we can see that we need at least 161 ideas if we want 10 ideas per set (like round 1). We only have 100 ideas so we are limited to 8 ideas per set.

At this stage, we have a thousand choosers (participants) needing to see 8 ideas each. That's 8000 views needed and 100 ideas. 8000/100=80. This means each idea will compete in 80 sets. To build the template with more choosers than choices, our method is to build 10 separate templates.

All 100 ideas are distributed to participants 1-100 (no duplicate pairings amongst this subgroup). All 100 ideas are then distributed to participants 101-200 (no dupe pairings amongst this subgroup), with a different randomization from that which was given the participants 1-100. This is continued 10 times (in this example), i.e., until all users have a competition set to view. By using this distribution method, we can limit the amount of duplicate pairings. Here, the maximum possible pairings of any two ideas is 10 times out of the 80 sets each idea is in (1 pairing per each of the ten templates). However, most pairings are not as high as 10 out of 80. This is an acceptable situation that, in some examples, won't affect the outcome enough to matter.

In some examples of our system, we could also run a “milling” method where we have a computer program randomize each template, one at a time, checking each one for total duplicates (even inter-template). If the level is higher than desired, the last template built can be thrown out and rerun until we get a configuration to our liking. We can also pre-calculate templates for later rounds based on the ideas remaining and number of participants. In practice, however, there is often little need to do this as the limited duplicate pairings will not do any damage. Furthermore, we actually use duplicate pairings in our Face-Off method/algorithm to help correct competition inequities.

Odd combination of participants to choices: In most cases, after round 1, there will be an odd combination of participants to choices. For instance, in our example above, we assumed that 100 ideas passed through the first voting round. This was a tidy fit with our one thousand participants, as we could make an even 10 templates (1000/100). The real world will hardly ever be this smooth. In some examples, we can't precisely control the number of ideas that make it into round 2 (we can only get close). So, if we have a thousand participants and 98 ideas left, the number of templates will be fractal—10.2 in this case (1000/98). The implication will be that some ideas will be in an extra competitive set. It may turn out that idea #4, for instance, is in 81 competitions versus the average idea only getting shown 80 times. Even though we would like to have all ideas get equal coverage, it really doesn't matter in most cases as long as the hurdle is a percentage of total sets and not a straight number of wins.

The system is capable of realignment testing: In some examples, our method for voting/choosing needs to be measured for its fidelity. If there was unlimited time, we could simply ask each member of the group/crowd to go through every choice and sequence them all in their preferred order. We could then average all the orderings of each group/crowd member into a final group/crowd consensus order. This may not be possible for practical reasons, e.g., a large number of people.

The perfection ratio is the number of “ideas” higher than the best miss (highest number that did not make it past the first round), divided by the number of survivors (total number of ideas that made it past the first round). In an example where the top 86 ideas were returned with no omissions (the 87^{th} was the best miss), there were a total of 118 surviving ideas. 86/118=72.88%. Thus, our perfection ratio in this example was 72.88%

The purity ratio is the percentage of winners that should have won, given the total. There are 118 “ideas” that won and since 1000 is the top idea and 1000−118=882, no “idea”/number should be lower than 882. There were 12 ideas that were less than 118 that passed the first round. Thus 12/118=10.169% are mistakes. 1-0.10169=89.83% of the winners should have been winners. Thus, our purity ratio is 89.83% in this example.

Sector Purity is a measure of purity for different sectors of the number scale.

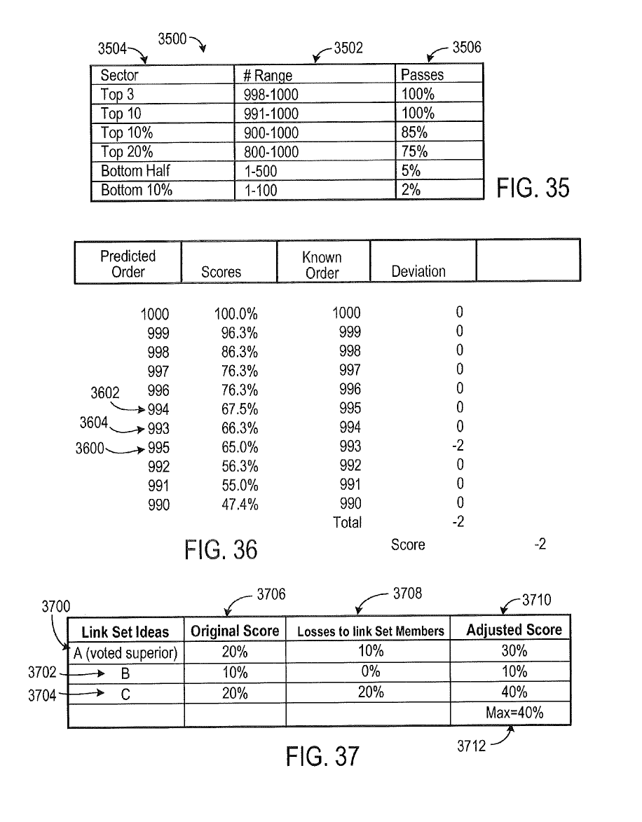

Although we may be more concerned with the top ideas (numbers in our test), we may wish to see purity at different levels. We also do not want low numbers to be inadvertently passed (i.e., to make it over a hurdle or multiple hurdles). FIG. 35 shows an example of a sector purity analysis. The table 3500 in FIG. 35 shows the numbers (“# Range” 3502) belonging to each sector 3504. The “passes” column 3506 shows the percentage of numbers in a given range that passed a hurdle (or multiple hurdles).

Order testing is the process of determining how close to the correct order the system came. How good was this example of our system in predicting which ideas (numbers) were best? Did it line them up in the right order?

In some examples, a system that can correctly reorder the sequence is more valuable than one that cannot.

Suppose we are left with the following winners (or any winners for that matter): 999, 1000, 997, 995, 996, 998

In some examples, it is preferable to be able to determine which is the best, second best, and so on.

For any sector of the sequence, we can measure the order correctness by simply subtracting the predicted order (the results of our test) from what we know to be the correct order.

FIG. 36 is an example of an actual 2-round test (with only our geometric reduction algorithm being used).

As can be seen in FIG. 36, the perfection ratio and the purity ratio are both 100% (the top 11 are all represented in our predicted order). But as also can be seen, the ordering in this example is not perfect. Idea [995] 3600 is out of sequence by 2 places. We measure this mistake by subtracting the predicted order numbers from what we know to be correct. Notice idea [994] 3602 and idea [993] 3604: we do not deduct points for those two mis-alignment as they are in the correct order GIVEN the [995] 3600 mistake (no need to double count 1 mistake). The lower the score, the better the re-order fidelity.

During the process of evaluating ideas, there may be instances where two or more ideas are virtually (or literally) identical. We think that it is critical to avoid the possibility that these “equal” ideas split/dilute the voting potential of their advocates. This dilution could effectively give lesser ideas an advantage. To remedy this potential problem, we have devised the following procedure/algorithm: a potential solution where each participant gets rewarded if they correctly label two or more ideas as “equal” (the participant may also be penalized if they are not equal).

After a participant makes his/her choice for best idea, he/she can be required to scan the remaining ideas in his/her set for equivalent ideas. Some examples of our system could display the participant's pick next to the other nine choices in turn. This could allow the users to rapidly compare all choices to their pick and designate any that are virtually identical. Next, all participants who chose any of the equalized ideas (ideas deemed to be equal to another idea) would be enlisted to confirm the proposed “equals.” The confirming group/crowd members could also label one of the equalized ideas as “mildly superior.” After this selection, a vote for one could be deemed a vote for both. Also, the superior idea could be the survivor with the inferiors becoming invisibly linked. Any rewards/credit could be shared between the sources of the equal ideas (with perhaps more credit going to the “mildly superior” idea). Lastly, in some examples of our system, “identicals” (e.g., some ideas could actually be one or two word answers and be exactly the same as others) could be automatically linked from the get-go.

In some examples of our system, after a user has chosen a winner, he can be then asked to mark as equal any of the other ideas in his set that are virtually the same as his pick(s).

If the participant did indeed mark two or more ideas as equal, the system could compile all links for the participant's pick. For example, if the participant picks #800 and #605 as virtually identical and someone else says #605 is identical to #53, then these 3 numbers could become part of a linked set (or link set).

Anyone who chooses numbers 800, 605, or 53 as the winner of their personal competition set can be asked to confirm the equalization of these ideas. There can be penalties to any eventual reward for a user that is in disagreement with the group/crowd. For example, penalties can ensue if a user equalizes two ideas and the group/crowd does not confirm, or if the user fails to equalize two ideas in his set and the group/crowd later equalizes them, or if during the confirmation phase a user's decision goes counter to the majority. The user cannot see the group/crowd's decisions ahead of time, and thus must do his best at this job.

There can be any number (including only one) of users that end up confirming a linked set (but we can enlist more help from the group/crowd if need be). Also, there can be any number of links in a set. We can limit each user's confirmation task to any number of choices (e.g., 2-10).

In some examples of our system, we will evenly and randomly distribute the choices amongst the choosers so that they may confirm that the proposed equals are indeed equal and/or designate one “slightly superior” idea.

In some examples, all the equalized ideas can then collapse (e.g., are invisibly linked) into the superior idea. That superior idea (or lead idea) can then move on and the others can ride along, garnering a percentage of any winnings

The following is an example scoring algorithm.

First, we take the original win rates (scores) for each member of the linked set.

We next search for any intra-link set losses (a loss to another member of the link-set). We then adjust the win rate: we assume that if 2 ideas are equal, and one lost to the other, that it really won that set.

We lastly take the highest score from any of the ideas of the link-set and give that score to the idea voted “mildly superior.

For example, FIG. 37 shows an example of how linked ideas can be scored using the algorithm described above. Here, the linked ideas are ideas A 3700, B 3702 and C 3704. This is the link set. The original scores for each idea are shown in the second column 3706. The losses to link set ideas are shown in the third column 3708. Finally, the adjusted scores are listed in the third column 3710. In FIG. 37, Idea A 3700 passes on to the next level with a score of 40% 3712 (the max of the adjusted scores of all link set members). An equalized idea set, many times, may not have a high enough score to pass the hurdle.

One method of using our system is by way of a synchronous implementation. This does not necessarily mean that all ideas come in at once, but that the idea submissions come in during a submission phase with a specified endpoint, which could be 5 minutes or 2 weeks or two years. After the submission phase is closed, our system can be used to parse out the submitted ideas to the participants for ranking and other tasks (a step we sometimes refer to as Human Distributed Analysis) in order to rapidly extract and distill the group/crowd's ideas and opinions.

Many times however, group communication takes the form of a constant or ongoing incoming stream of thoughts, ideas, opinions and commentary. Normal internet forum postings are just such an example. They are open ended, on-going, submissions. These can be idea initiations and responses to previous posts, and are sometimes subject matter specific.

Often in forums, the more interest a given forum attracts, the more posts it will attract. Both Twitter and Facebook are fundamentally forums. They just have very structured processes and protocols in place to organize and facilitate their individual styles of communicating.

Similar to our synchronous engine, the asynchronous version can be used in such forums and enable true, mass communication. We sometimes call the use of our system in a forum the creation of a “smart forum.”

In some examples of smart forums, participants can literally dial-in the level of quality posts that they wish (or have time) to consider. From viewing every post, down to viewing only the top X %, the users have the ability to save as much (or little) time as they wish.

In some examples of our system, the users can get to the heart of what should be heard (the knowledge of the group/crowd). They do this through our system's ability to organize, distribute and synthesize various tasks for the participants. These tasks include posting, viewing a small allocated set of random posts, and deciding on what ideas they prefer. The cumulative effect can be to discern the voice of the group/crowd. The system can also facilitate the creation of ideas by utilizing all relevant information, including pieces of ideas, and collections of ideas.

How does the asynchronous implementation work?

In an example of the asynchronous implementation of our system, as a participant attempts to engage with a smart forum (or any asynchronous example of our system) either by entering a post or merely viewing the posts of others, he/she can be presented with a set of various posts (say 5). The participant can be asked to select the posts (ideas) that are worthy of consideration and then to put those in rank order. The participant can then be prompted to mark as equal, any ideas that are effectively similar (or essentially identical).

For the smart forum user, the preceding tasks are quite simple, but the effects are dramatic (as described above).

The following logistical procedures, algorithms and functions can be combined to create an asynchronous implementation of our system.

For the limited purpose of the follow example describing an example of an asynchronous implementation of our system, the following definitions may be useful:

Submitter: Any user who submits a post to the forum stream. In some examples, submitters can also see and rank other submissions, just as a viewer would.

Viewer: Any user who simply views the forum stream but does not submit a post.

Participant: a submitter or a viewer.

Administrator (Admin.): The person or entity that sets the parameters and protocols for a given smart forum or other asynchronous implementation of our system.

Idea Set (Set, or Competition Set): The group of ideas that are presented to a given participant for ranking or for the performance of other tasks. An idea set can be of various sizes. For instance, in a 3-set there are 3 ideas presented to a participant, and 7-sets have seven ideas, etc.

Set-Allocation: The number of sets in which a given idea has been presented. That is, how many different participants have been shown a given idea? Target Set-Allocation: The number of sets in which an idea must compete, before that idea's rankings are allowed to be considered valid.

Set Group: A group of sets, linked together as a voting bloc, whereby every post allocated to the set group reaches its target set allocation within the group.

Beat Percentage: The number of ideas that were ranked lower than a given idea in all the sets in which it competed divided by the total number of competing ideas that it faced. That is, for a given idea, how many competing ideas were ranked lower in the competitive sets in which it competed.

Points: If the total set allocations and competitive set sizes for all ideas were equal in number, then a raw points system could be used to determine superiority. With asynchronously fed ideas, it can be less likely that perfect equality will be present. This is why Beat Percentages are often used.

Wins: In some forums, the administrator may wish to speed up the process and thus ask participants to merely pick a winner instead of rank some or all of the ideas in their set. In this case, we would tabulate the total amount of wins a particular post garnered.

Hurdle Rate: The number of points, beats, or wins that are necessary for an idea to pass on to a subsequent voting round or to a winner's position.

Round 1: The phase where incoming posts are compared with other incoming posts and ranked. Those posts that pass the hurdle rate may be selected for further distribution and ranking in subsequent rounds.

Round 2: The phase where a post that has passed the round 1 hurdle is compared with other posts that have done the same. This “Round” process can continue until the desired level of granulated discreet rankings has been accomplished. For example if the top 1000 posts have all beat percentages of 100%, the participants may have not reached the desired granulation. In this circumstance, more competitive rounds may be necessary.

The following example describes a possible sequence of an asynchronous implementation of our system:

1. The administrator can decide on the configurable parameters. In some examples, the administrator can choose the following:

a. How many posts each participant will be presented for review and ranking

b. How many times per day each participant will be presented with a task (e.g., a set to rank). The administrator might require a participant to do tasks each time the forum or application is engaged, entered or viewed. Alternatively, there could be a maximum amount of times per day or per hour. Alternatively the engine could be configured not to prompt user tasks for X hours since the previous prompt.

c. The Target Set Allocation

d. How many submissions are required before the first participant is presented with a set. Two submitted posts are the obvious minimum to be able to perform a comparison ranking, but the results of that ranking could be less robust than a comparison of, say, 5 posts.

In some examples, the administrator can make a best guess at the incoming traffic to the forum (e.g., how many participants will submit ideas and how many participants will view the forum) in order to set some of these parameters. In some examples, the administrator can also estimate the homogeneity of the group/crowd, as extreme divergences of opinion may necessitate greater comparative analysis and thus more work for participants. In some examples, there are other configurable parameters, such as those described below.

The target set-allocation is constrained by the number of ideas per set that the administrator wishes to have each participant view and rank. For example if every participant is a submitter, and the administrator only wants the participants to rank 5 posts each, then 5 is the maximum number of times a given idea will be seen and ranked (by 5 different participants). This constraint holds true unless the administrator is willing to accept a backing up of “work,” whereby newer incoming ideas are getting ranked later and later. A trade-off arises between the ease of use for the participants on one hand, and the confidence level of the results, on the other. Where the confidence level of the results decreases, the system's ability to reduce unwanted or worse posts necessarily decreases. This issue becomes less of a constraint as more participants enter the session/forum as viewers as opposed to submitters, as we shall see below. Let us use 5 as our hypothetical Target Set-Allocation going forward.

Next, we construct the template (the distribution of ideas to the participants). The system or administrator can design the template, or the way in which incoming ideas will be distributed to participants for consideration and ranking

As each new participant (P1, P2 . . . etc.) enters the forum, he/she can receive a randomized set of posts. The posts that get distributed can be constrained to the latest submitted post, and this could highly limit the initial sets if the administrator wishes to have participants begin voting as soon as possible. In our hypothetical case, we will assume the administrator wishes to begin as soon as a full set (of 5 in this example) is able to be filled. Also consider that since it may not be known in advance how many forum participants will show up or when they will show up, the administrator may have to estimate traffic and build sets based on that estimate.

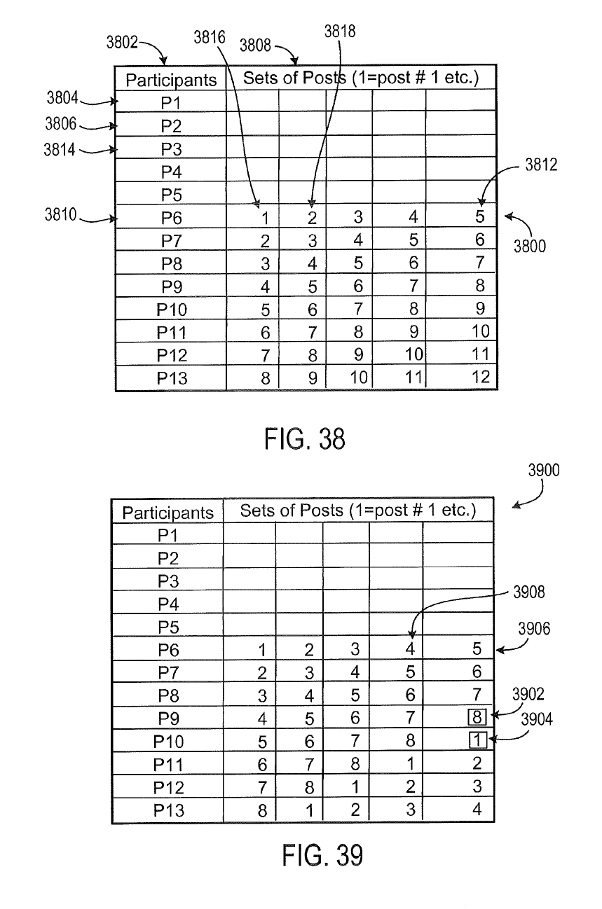

Assuming all participants are submitters, a template might be constructed as shown in FIG. 38. FIG. 38 shows an example of a template 3808, with each row 3800 representing a competition set consisting of five posts. The first column 3802 lists the participants, with P1 3804 representing the first participant, P2 3806 representing the second participant, etc.

The 6th participant 3810 is able to view and rank the first 5 submissions. As (in this example) we wish to give each ranked idea as fair and equal a chance as possible, we waited until each idea would be able to compete in a set size of 5. Thus, we needed to wait for the 6th participant 3810 and the 5th idea 3812. We could have given P3 3814 ideas [1] 3816 and [2] 3818 in a set (which would have allowed a comparison between two ideas with no participant voting on his/her own idea), but that would be less optimal. There is, however, a flaw in this arrangement of sets. For instance, post #1 3816 was placed in only one competitive set, and post #2 3818 was only placed in two sets. In fact, not until post #5 3812 do we find a post that was placed in the target set-allocation of 5 (P6-P10). This is obviously unfair and will, in this example, disqualify posts #1-4 from passing on to the next level. We may want to squeeze posts #1-4 into some extra sets somewhere. An efficient way to do this and at the same time get some ideas through 5 competitions is the template 3900 seen in FIG. 39: Notice that after post #8 3902 we have restarted the count back to post #1 3904. We could just as well restarted after idea #5 3906 but then every single set would include the same ideas. If we did the opposite and chose a very high number to start the reset, say 100, then ideas #1-4 would take too long to come under consideration.

Notice also that post #4 3908 and #5 3906 competed with each other in 4 out of their 5 sets. Notice that this pattern of repeated competitions is part of this numerical scheme. This may be less than optimal and may limit the information that could be extracted by a broader array of discreet competitions.

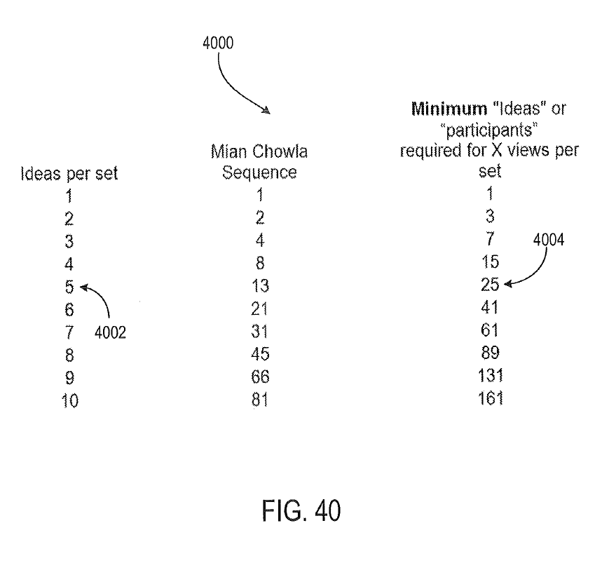

There is a most optimal method of distribution. It is the distribution scheme we used in our synchronous method. It uses the Mian-Chowla (MC) sequence to build templates for set distributions. There are mathematical limitations on how many posts and participants must be present in order to use a MC based template (as seen in FIG. 29), which is partially replicated in FIG. 40.

From the table 4000 in FIG. 40 we can see that if we wish to use 5-sets 4002 that we need at least 25 posts 4004 as well as 25 Participants 4004 to work on those posts. Because the first 5 digits in the MC sequence are 1,2,4,8,13, we must wait to begin building an MC template until at least the 14th participant has shown up (assuming 13 posts have been submitted and we don't want any participant voting on his own post).

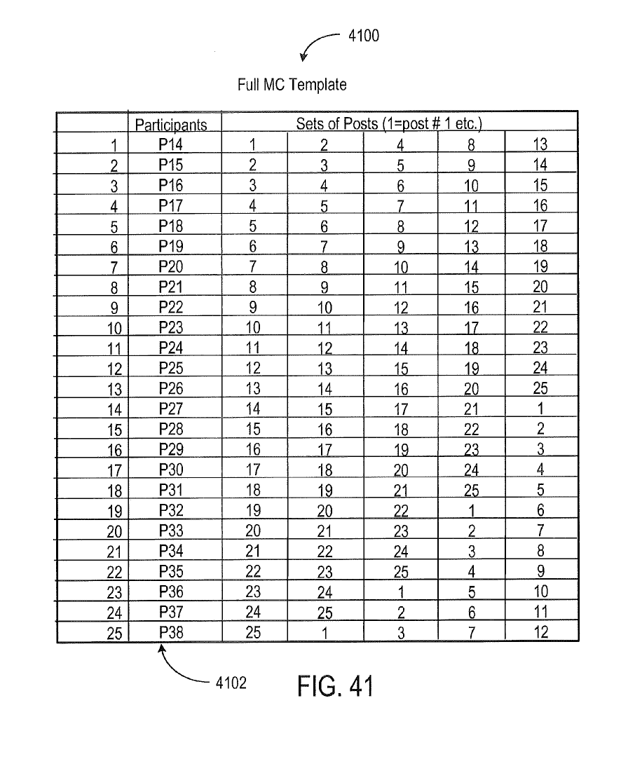

Furthermore, if we fill in the template with the next 25 ideas (the above table in FIG. 40 shows a minimum of 25 ideas and 25 participants will be necessary) we will have created a true MC template. This means that we have the maximum discreet competitions with no duplicate pairings. This in turn will produce the most comparative information and thus the most reliable results. FIG. 41 shows the full MC template 4100 for 5-sets.

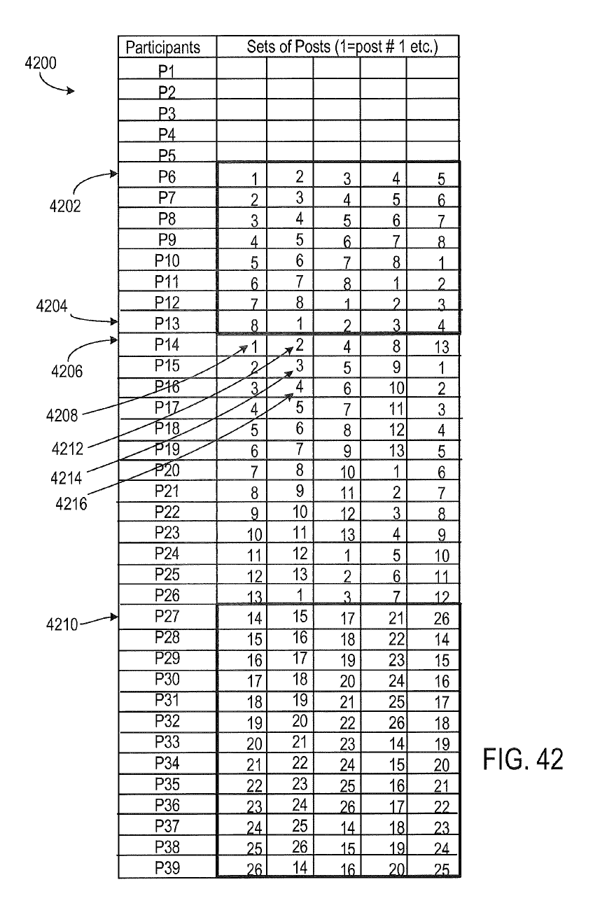

The problem with this distribution pattern (template) is that we don't reach our target set-allocation of 5 until the 38th participant 4102 has shown up and ranked his/her set. It is for this reason that we may choose a modified template scheme in order to fully process some early posts sooner than the arrival of participant38 4102. As we have said before, we may not know the precise flow of participants into the forum and we may need balance speed of results with quality of results. A template that combines the simple template shown in FIG. 39 with a modified MC template is shown in FIG. 42. The template 4200 begins at P6 4202 so as to fill the first set with 5 posts.

A simple template is used in the beginning (through P13 4204) so that if participant traffic does not materialize, at least posts 1-8 have been worked on and have reached their target set-allocation of 5 (in our example).

As traffic reaches P14 4206 we shift to a modified MC template. This template is modified in that it does not populate a set group to 25 participants, but stops at the 13th (P14-P26). It must have at least 13 participants in order to have equal set allocations (5) for every post. We also need to start over, at post #1 4208. This is because we need 13 posts to begin, since the MC sequence has 13 as its 5th integer. This restart causes the first 8 posts to be included in more set allocations (5 more), but probably will not harm the results.

Once the set group has populated 13 posts 5 times each it is complete, and we use the same scheme with posts 14-26 (starting with P27 4210), 27-39, etc. into perpetuity. From here on in, all ideas will hit the targeted set allocation of 5.

The administrator(s) could of course allocate 2 of these 5-sets (or any other permutation of set size and sets per participant) to each participant if they thought more information was necessary. They could also lower the hurdle rates.

Although not optimally randomized, the partial or Modified MC template (as started on P14) is the most optimal for a given (shortened) Set Group as will be seen in the test results to follow. This can be seen by the fact that some ideas necessarily compete with each other more than once, due to space constraints. Notice posts [1] 4208 and [2] 4212 compete twice as do [2] 4212 and [3] 4214, [3] 4214 and [4] 4216, etc.

Of course any ordering scheme could be used, if fact the asynchronous implementation can allow for automatic variability of template construction/implementation as participant traffic patterns and flow change in real-time.

In order to test the results of this example of our system, in some implementations we use the same algorithm used for the synchronous voting that achieved geometric reduction. In this example, we use numbers as proxies for post/idea quality (with 1 being low and 13 being high), and assume homogeneity of the participants' opinions. We can later introduce variances to this model whereby the participant population has preferences and where there are fraudulent voters or off-consensus thinkers. How the system handles these types of problems was described in the synchronous implementation example. For now let's view the mathematics behind the two template options we use—Simple and Modified Mian-Chowla (Mod MC). Modified MC is just one of many possible randomized template patterns. Most of the randomized patterns are superior to the Simple template but all are inferior to Mod MC. For example, in a Randomized Template, instead of starting the first set with the Mian-Chowla sequence of 1, 2, 4, 8, and 13, the system randomly chooses 5 digits from 1-13 and places them in set 1. Then, like Modified Mian-Chowla or Simple Templates, the Randomized Template increments the next set by 1. For example, if set 1 was [3 9 10 11 4], then set 2 would be [4 10 11 12 5], etc. The Randomized Template results in fewer duplicate pairings that the Simple, but more than the Mian-Chowla Template.

However, we still need to use the Simple if we insist on starting as soon as possible due to the fact that with a limited number of inputs, there are only so many ways to order them.

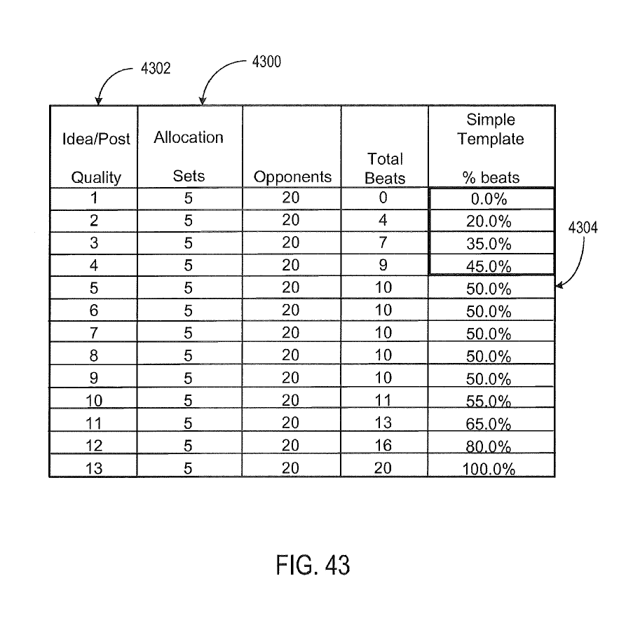

FIG. 43 shows the test results of discreetly ranking 13 different posts with the following assumptions: Each post is discreet, participants have similar opinions, and each post/idea is placed in a 5-set (as indicated by the “Allocation Sets” column 4300)

Using an Excel model to randomly adjust the “quality” of the incoming posts, we randomly assigned a quality score 4302 from 1 to 13 to each post, with a higher number indicating a higher quality post. The posts sequence number is not the same as quality score. For example Post #1 might have the best (13) quality score. The Excel model then discreetly ordered each set to simulate participants ranking. It assigned “beats” or “points” to each post, for every competing post that it ranked above. In the first simulation we set the quality scores in an unrealistic sequence (1,2,3 . . . 13), meaning the flow of posts came in sequentially better for each of the posts. We did this to see how a simplistic case scenario would work.

Notice that posts with middling quality (5-9) were indistinguishable, each coming in with 50% beat rates 4304. The Mod MC template gives much more granulation than this

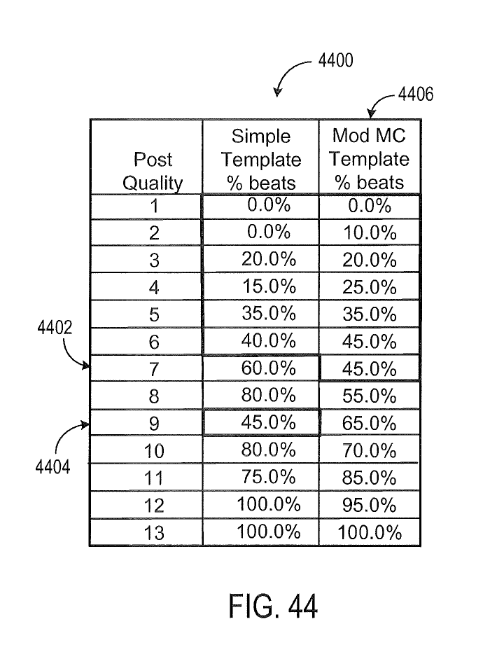

We also ran simulations where we randomized the quality levels of the incoming posts. FIG. 44 shows a table 4400 of an example of the results. In a real world situation we may not be able to see “post quality”—all we will know is that some posts scored higher than others. But our model allows us to cheat in a sense, as well as to allow us to calculate the probabilities of success and be able to dial-in tolerances confidently.

We set a hurdle rate of 50% beats. Posts that received less than 50% beats did not pass the hurdle.

Notice that the Simple Template results in this case are flawed in that the system would have ranked the post with a 7 quality-rank 4402 ahead of a 9 quality-ranked post 4404. We could still use this method if we were trying to distill the top 3 ideas. They comfortably made it past the hurdle (we would of course need to run numerous randomizations to make sure we were comfortable with the failure probabilities).

The Mod MC template (shown in the third column 4406) returned an almost perfectly discreet and correct rank order (although the posts with quality levels at 6 and 7 were indistinguishable).

We ran hundreds of tests, with various randomized inflowing post quality. We defined failure as a lesser quality post passing the hurdle when a higher quality post did not. These failures did not necessarily cause system failure, but they run the risk of retaining lower quality posts over better quality posts. The results were as follows:
Simple Template=45% fail rate (45/100 trials)
Randomized Template=2.57% fail rate (9/350 trials).
Modified Mian-Chowla Template=1.14% fail rate (4/350 trials). (The 4 failures, by the way, were minor and most probably would not have jeopardized the results).

In the alternative, we could use the “pick a winner” choice model (where the participant is simply asked to pick the best idea/post) instead of discreet ordering (where the participant ranks each idea/post from best to worse). Or, we can use the—“trash some ideas/posts then discreet order the rest” method (where the participant rejects a few ideas and then places the rest in order from best to worst). “Pick a winner” is faster for the user, but not nearly as reliable as discreet ordering for the asynchronous mode.

When posts compete for points in a discreet ranking (ranking all ideas from best to worst), we gather a lot of comparative data. So far we have shown methods where posts/ideas are given scores based on how many other posts they outranked. We have not, however, used all the data that was gathered. Consider a 5-set of the following posts (where the higher number equates to higher quality): 13,12,7,8,9. Determining a rank for the #13 post of compared to the other four posts (it was better than each of its competitor posts) ignores the information gleaned from which other posts #13 beat. Had they been 1,2,3 and 4, the score would have still been the same even though beating the lower quality ideas is an easier task.

One remedy for this issue would be to use the competition adjustment algorithms that were outlined for the synchronous implementation. For example, after posts/ideas have been ranked, we could use their scores to determine the level of competition in each set. We could determine how tough the competitors were that a given post faced, lost to, or beat. We could then extract more comparative data.

With the synchronous engine, after the first round of ranking is tabulated, we are often able to simply redistribute the winning ideas back to the original participants for a second round of voting. The goal in that case can be to further filter the remaining ideas. After the first round of voting, fewer ideas remain but the participant group size often remains the same, resulting in a greater percent of the participants working on a smaller group of ideas. The asynchronous engine does not necessarily have the luxury of being able to redistribute. Often, the only participants that can be conscripted to vote are those that happen to show up. Of course, participants that engage the forum multiple times per day can be prompted more than once to rank sets. Also, most forums have a greater number of viewers than submitters, which makes the ranking task easier. For now, let us consider the worst case scenario (all participants are submitters) before entertaining our options when viewers are plentiful.

Because we use discreet ranking (ranking each idea from best to worst), the Round 1 results may garner enough data and granulation such that the administrator is confident enough to stop here. No further rankings may be necessary. If, however, the decision is made to generate even more robust data, multiple voting rounds might be preferred. If we wish to use Mod MC templates for Round 2 ranking, the logistics would be as follows:

The top 4 posts from Set Group 1 (13 posts total) could be earmarked for Round 2 voting, as would the top 4 posts from Set Groups 2 and 3. In some examples, a wildcard post could also pass to Round 2. It would be the next highest ranking post from any of the 3 Set Groups and may be necessary because we need a minimum of 13 posts for a Mod MC template. With a Mod MC template for Round 2 (R2), the resulting scores could be very nuanced and have a high confidence level. The problem is that this method necessitates many participants and as such is best suited for high traffic forums and/or forums with a high viewer to submitter ratio. The soonest that participants could start voting on Round 2 level posts would be Participant 53. By Participant 65, we would have the first R2 level posts selected (i.e., we would have double filtered some posts).

An alternative could be used for lower traffic forums. For instance, the top X posts (say 4) from Set Group 1 could be given to Set Group 2 participants as a second set to rank. In some examples, each participant would get the same posts, as there would only be 3 to 5 in total (the winners from set group 1's rankings). The best 1 or 2 posts could be selected and, for instance, could eventually compete in a Round 3. When enough R2 winning posts are available, the next Set Group could be bifurcated such that half of the participants get R1 winning posts from the previous Set Group while the other half is allocated R2 winning posts for ranking in R3 (perhaps the final ranking)

Most popular forums will have many more viewers than submitters. Asynchronous implementations of our system run far more efficiently the greater the viewer/submission ratio. More viewers may mean more workers on a given number of tasks. Unlike submitters, viewers do not add work. They increase manpower.

All the logistics and templates discussed so far can still be utilized, but as viewers increase, we can simply alleviate burdens where needed. Instead of having participants deal with two sets, such as the case when we need to rank R2 level ideas, we can simply allocate incoming workers (i.e., viewers) to do that task. We would probably not want to show favoritism to viewers over submitters by giving them R2 level posts while submitters toil with R1 level (unfiltered/lower quality posts). We could, at a minimum, intermix these sets.

Once all excess sets are allocated, a further influx of viewers could be used to increase the reliability of the results. This could be done by shifting the target set allocations higher. More discreet rankings equal higher quality data, higher confidence levels, and thus often leads to better results.

As excess viewers enter the forum, their sets can be built by calculating which posts have been allocated to the fewest sets. In the case of a tie (post #1 and post #2 both have been allocated to 10 competitive sets), a choice could be made to allocate the oldest post. There could, of course, be time constraints imposed as we may not want to allocate an extremely out-of-date post to an incoming viewer.

Twitter is an example of a multi-forum. It is technically a broadcast medium with countless stations, if you will, whereby every individual user effectively becomes a broadcast channel of sorts. These channels can also be considered forums of one, where individuals post their thoughts. Each post can create a true forum where many people submit their own posts as commentary on the initial post. The amount of content in this type of medium can expand at exponential rates. Various examples of our asynchronous system can be used in these multi-forums, in some cases turning multi-forums into smart forums. In the discussion below, we use the examples of Twitter and Facebook to discuss how some examples of our system can be used in multi-forums.

Some examples of our system can enable the participants to filter the posts from an individual's post stream or the response posts to an initial post. Our system can also be used in “topic” sections of multi-forums, such as in Twitter's #Hashtag system.

There is another form of filtering that our system could perform in multi-forums. When a user logs into a multi-forum (e.g., Twitter or Facebook), the user is presented with numerous posts from individuals that he/she is “following” (in the case of Twitter) or “friends” with (in the case of Facebook). Some examples of our system can filter the posts, presenting only the higher quality or more relevant posts. Unlike in a typical forum, in these multi-forums, every user/participant may follow different individuals, and some participants might follow many different individuals while others might follow only a few. Because of these differences from a typical forum, some examples of our asynchronous system in these multi-forums operate differently.

When divvying up the work of filtering, we must take into consideration that for every given post, we may not always assign work to the next available participant. In the case of multi-forums, we may sometimes only assign the work to the next available participant who is also following the particular submitter whose post we are trying to allocate. That way, in some examples, the participant only votes on the ideas submitted by people he/she is following or is friends with. For a given participant, consider every post from everyone he/she is currently “following.” We will call that group of posts a participant's “post-base.” If a post is queued up to be allocated to (i.e., put into a competition set and given to) Participant #1 (P1), but that post is not part of P1's post-base, some examples of our system may hold that post on-deck until an allocation is possible (e.g., until a participant comes along that is following the individual who submitted the post).

We could display the pre-filtered posts from each individual's historical post feeds. For example, if President Obama has posted 50 tweets in the last 7 days, and those that follow him have used our engine to select the top 3 posts, then these tweets could be the ones that display first in a given participant's stream of tweets (if that participant followed President Obama). Similarly, the highest ranked posts from each person followed could also be displayed first (or exclusively). The same method could be used for Facebook.

Furthermore, a participant may be able to dial-in the level of posts he/she wishes to see. For example, if every Facebook user's content is filtered by his/her friends, we could then let participants choose or dial-in the quality level of posts they wish to view (e.g., just show the best of each of your “friends” comments, the top 10%, or the posts that passed at least one voting round). The ability to dial-in the level of posts is an option that the session administrator may choose when setting up the engine parameters.

Participant 1's (P1) best posts may not be as equally good as Participant 2's (P2) best post. In fact, P2's best post (or tweet) could be of lesser value than P1's worst post (think Steven Hawking's tweets compared to a 5^{th} grader's tweets). Therefore, some examples of our system can compare poster to poster, tweeter to tweeter, one Facebook friend to another.

Even though we all don't follow the same people, comparisons between posters or tweeters can still be made with some alterations to our asynchronous engine.

Like in a normal forum, we can organize incoming posts into sets of 5 (any size over 2 is possible), and have incoming participants rank these sets and perform other simple tasks.

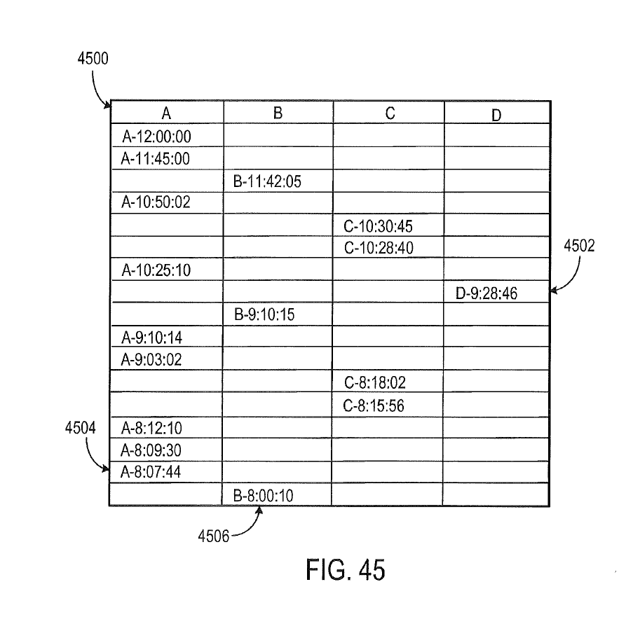

In some examples of our system, as posts flow into the multi-forum, they get queued up into a preferred order for set building (we will typically use sets that include 5 posts). In the simplified example shown in FIG. 45, there are four submitters (A-D) submitting various numbers of posts at various times. Each incoming post is designated with a combination of the submitter's name (A-D) 4500 and time stamp 4502.

In some examples, once the number of incoming posts passes an administrator-designated minimum, incoming participants will be given sets to rank. Although we would prefer to use some form of a Mian-Chowla based template for set building, it is highly unlikely we will be able to do so. In some examples, it is unlikely that the next available participant will be able to accept all (or any) of the next on-deck posts due for allocation (the next ideas that need to be ranked). This is due to the fact that most participants on Twitter or Facebook will only be following or friending a small fraction of the universe of submitters (all people posting or submitting ideas). Thus, set allocations can be built specifically for each incoming participant. We can also take into consideration that a given post must reach the Target Set Allocation (i.e., in this example, each post must be compared with competing posts in 5 separate set competitions) as quickly as possible without compromising the fidelity of the output. High fidelity output is correlated with a low number of duplicate competitive pairings between posts. In some examples, it would also be preferable to have no duplicate competitive pairings with the same participants (let alone specific posts). For example, for the posts shown in FIG. 45, we might match A-8:07:44 4504 vs B-8:00:10 4506 in a set. After that, we would strive not to match those two posts together in any other sets. Furthermore, we would also, secondarily, try not to match any of A's posts with B's posts.

We could keep a database that tracks, for any given post, every other post that it has competed against. If we used 5 sets of 5 posts, then every post/submission would have 20 (5 sets×4 competitor posts) pairings. If possible, repeated pairings would be kept to a minimum. An alternative would be to track discrete matchups (how many unique ideas the given idea was compared with) and have a minimum hurdle before a post's ranking can qualify for final ranking. This way, if a post hit its Target Set Allocation but did not reach the minimum number of discreet pairings, it could be placed in more sets until the desired number of pairings had been reached.

Another variable that an administrator might want to manage is the Ranker's Following Number (RFN). Suppose a tweet from Tweeter A was allocated to a given set. Further suppose that the set was allocated to a participant that was only following 3 individuals (the RFN for that participant would equal 3). Now consider the same tweet allocated to someone following 300 individuals (the RFN for that participant would equal 300). The question arises as to whether a given post would have an advantage if it were allocated to a participant that was following a limited number of individuals (a low RFN). The engine could be constructed in such a way as to keep a database on the rankers for every post. Furthermore the engine could be instructed to maintain an equal distribution of RFN levels (within given tolerances) for all posts. As a rudimentary example—if post #1 was allocated to Participant #13 who had a RFN of 3, then Post #1 could be disallowed from being allocated to another participant with a RFN of less than X (say 15).

Another option could be to measure the User Following Number distribution ratio for the entire multi-forum (the percentages of users following certain numbers of posters/tweeters, as described below) and then try to match that distribution with the RFNs (to a given degree) with the set placements for all given posts. For example, if it was found that Twitter had a distribution ratio whereby 20% of the users followed approximately 100 individuals, 60% followed 200 and 20% followed 300, we could try to allocate 1 set (with a given idea) to a participant with a RFN of 100, 3 sets to a participant with a RFN of 200 and 1 set to a participant with a RFN of 300. In some examples, we would need a broad participant base for this option.

One distribution sequence may be as follows:

1—Set a minimum RFN of X (e.g., 15) needed to consider allocating a set to a participant. That is, participants with RFNs less than 15 are not given competition sets for ranking.

2—Use 5-sets (each post will be compared to others posts in sets of 5).

3—Have a Target Set Allocation of 5 (each post needs to be in 5 competitive sets before we consider the rankings it has accumulated).

4—Accumulate all the submitted posts within the last X hours (the Target Time Frame).

5—Divide the Target Time Frame into relatively equal periods of time called Time Blocks (TBs). For example, every post submitted from 8:00 am to 8:10 am could be TB1, 8:10-8:20 could be TB2, etc.

6—Once the ideas from a TB begin to get allocated to participants for voting, we try to finish this group before allocating the next TB. That is, have each post in TB1 fully allocated to the number of sets equal to the Target Set Allocation and ranked before we start allocating posts from TB2.

7—Consider posts within the same time block to have the same post-time. In other examples, each post can have its exact time of posting.

8—Set-building and placement:
a. Denote P1 as the next participant available to rank a set.
b. From TB1, allocate as many posts as possible to P1 up to the set size of 5. Only posts that are in P1s post-base are eligible.
c. If and when there are no available candidates left to allocate to P1 (e.g., only 3 posts were put in P1's set and we need to get to a set size of 5), pull an alternate post from P1s post-base as follows:
   i. Define an In-Process-Post (IPP) as a post that has been allocated at least once.
   ii. Any IPPs get allocated first. There can be a waiting period, defined by the administrator, whereby a post that gets allocated cannot be allocated again for a specified period of time. This rule can have the effect of lowering the number of duplicate pairings from occurring. The waiting period methods can be various, although we will describe one preferred variation below.
   iii. Next allocate the oldest post (within an administrator defined limit)
d. Note that three important things have happened so far:
   i. Any post from TB1 that could be ranked, was ranked. Even if P1 was only eligible to rank one available post from TB1, it would have been ranked against other posts from P1's post-base.
   ii. Older posts from P1s post-base got “work-on” and may eventually hit the Target Set Allocation.
   iii. P1's work potential was maximized (given the set size we utilized).
e. This process repeats with the arrival of every new participant, with the following sequencing overlay:
   i. Once a post gets allocated, we may aim to have that post/idea reach the Target Set Allocation (5 in this example) expediently so it can qualify for a ranking
   ii. Another goal may be to minimize duplicate pairing, if possible, which will help the ranking results be of high quality/fidelity. In a normal asynchronous forum, we can do this by choosing from a variety of placement schema called templates. A placement defines the participants that vote on a given idea, and the other ideas with which that idea is compared). With multi-forums, we often cannot control the exact post placements because some participants don't “follow” certain submitters. Instead we can attempt to vary post placement by having various waiting periods between placements.

One option is as follows:

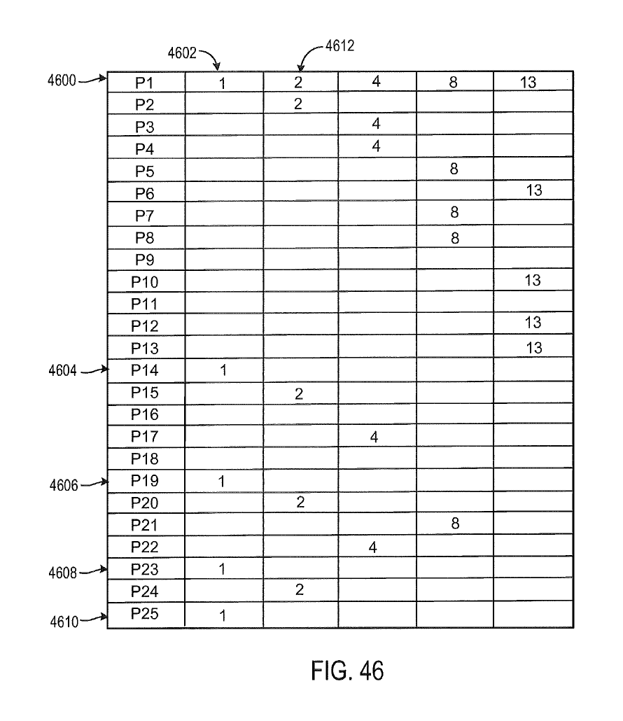

In a Mian-Chowla based template with a set size of 5, there are discreet spacings between the first appearance of a post and the next appearance in a competition set. In fact, each place setting in the set has its own spacing sequence. They are precisely placed to prevent or minimize duplicate pairing. The template for a full Mian-Chowla (MC) 5-set is shown in FIG. 46 (where P1 4600 is the first participant to view a post):

Notice that the 1^{st} idea (denoted by the [1] 4602 in Row P1) does not show up again until 13 sets later (for P14 4604), then 5 sets after that (for P19 4606), then 4 sets after that (for P23 4608), and finally 2 sets after that (for P25 4610).

The 2^{nd} placed idea 4612 has spacings of 1, 13, 5, 4. In fact, each of the placements have the same cycle of spacings—1, 13, 5, 4, 2, then back to 1—they each simply start with a different digit in this loop.

This spacing is unique for each MC template and each Modified MC template, and each is as efficient as possible for the given template parameters. For the reasons described above, in a multi-forum we cannot always control placement—so instead of spacing with the 1, 13, 5, 4, 2 cycle, we can time-delay each post's set placement based on this cycle.

To start, P1 is given a competition set with ideas #1, #2, #3, #4 and #5. The #1 post's next placement could be delayed for 13 minutes (note that any ratio of 1, 13, 5, 4, 2 cycle can be used). The #2 post's next placement could be delayed 1 minute. The #3 post's next placement could be delayed 2 minutes. The #4 post's next placement could be delayed 4 minutes. The #5 post's next placement could be delayed 5 minutes.

The delay for each post's second, third, etc. placement in a competition set can follow the 1, 13, 5, 4, 2 (and back to 1) cycle, based on their starting delay. This schema is designed to efficiently separate posts that have competed with each other so they don't compete again. This method is not foolproof due to the fact that when the delay is over, the next available participant may not be able to rank the queued-up post. This could knock our stagger system off track, and posts that have competed before may again compete. In some examples, there can be a further method to compensate for this, as explained below.

As described above, as the competition sets are created, a database can be built cataloging every competitive pairing for a given post. We can use this data to veto a proposed set allocation if it will result in a duplicate pairing. For instance, the system can make a new competition set, and check it against the database to see if any of the ideas have previously competed before. In some examples, if the ideas have competed against each other before, the system can “cancel” that set and generate a new one. Furthermore, we can build extra sets in order to complete an administrator designated target amount of discreet pairings. For example, post/idea #5 was compared to a total of 20 other posts, but 11 of those “competitors” were repeats, such that there were only 9 discreet comparisons or “pairings.” We may have set a target of at least 10 discreet pairing. The system could then allocate this post into another set in an attempt to find more discreet competitive posts.
f. All else being equal, the oldest posts can get allocated first. In this example, in a given Time Block, the post-times are all equalized. If a post does not get fully allocated before another Time Block forms, it can have priority over any post in that later Time Block.
g. All else being equal, the posts with the lowest set allocations would be considered next. That is, the posts/ideas that have been placed in the fewest competition sets can be given priority for placement. In some examples, the posts with the lowest set allocations could have zero allocations, since once a post becomes an In-Process Post it could be in the delayed placement sequencing mode, as described above.
h. In some examples, an administrator may be allowed to limit the number of allocations per submitter. A submitter may be posting an inordinate amount of content, in which case the administrator could set a maximum number of postings to be considered per hour (or any time frame) from any particular submitter.

9—In some examples, if a post does not reach its target set-allocation in the administrator's designated maximum time frame, it does not get filtered/processed/ranked. See below for an explanation of how participants could be signaled as to a given posts level of processing.

10—Further voting rounds could be used if greater granulation is needed. These rounds could be initiated if the top X % or top Y number of all submitted posts are not distinguishable from each other (e.g., in a case where the top 1000 highest ranking posts all beat 95% of their competitor posts, or they all ranked the same). The participants could have a hard time weeding through those top 1000 ideas and more differentiation could be needed. The method for distributing further rounds could be the same as explained for voting rounds 2 and above in a typical forum, with the exception that the template schema could be built on the fly—just as it was for round one in multi-forums. In some examples, if a multi-forum had far more viewers than submitters, it could be easy to allocate voting round two posts without having to increase (from 1) the number of sets allocated to each participants.

Because in some examples we do not know how and when submitters will post and followers will view, the engine can be configured to alter the rules (e.g., lessen the restrictions) if these restrictions begin to impede the goals of the session. For instance, if the rule to minimize duplicate pairings starts to cause a significant (user-defined) slowdown in the average time it takes an incoming post to reach the target set-allocation, then this restriction could be waived.

Our system can have many possible types of filters in multi-forum environments. For example, in Twitter and Facebook modality, there could be a Following Filter, a String Filter, a Hashtag Filter and/or a Full Feed Filter.

Note that unfiltered posts are not necessarily bad posts—there just were not enough data points to make a determination. In some examples, it may then be desirable to have indicators on each post (for viewing only, not while ranking is happening) indicating whether or not the idea was filtered/ranked, how many rounds it was ranked in, and how it ranked. For instance, an idea that was not filtered/ranked can have no icon. An idea that was ranked as a poor idea can have a red icon. An idea that was ranked as an okay (but not good or great) idea can have an orange icon. An idea that was ranked as good in one voting round can have a green icon. If the idea was ranked as great because it passed through two voting rounds, it may have a double green icon (e.g., two green icons). If it was ranked as best because it passed three voting rounds, it may have a triple green icon.

In both regular forums and multi-forums, participants can view filtered posts from high ranks to low, or the participant can see the level he/she requests (as shown in FIG. 29). For example, the participant can select to only see ideas that have passed through two rounds of voting.

Some synchronous and asynchronous examples of our system may have extraction or muffler capabilities. That is, a participant may be able to self-separate from or into a subgroup. The participant (let's call him P1) may be able to communicate the following to the engine: “This idea received a high ranking, but I disagree. Therefore, identify those participants (denoted at XPs) who ranked this idea highly, and please don't ever consider their votes when filtering posts for me.” After that, for example, the system could disregard those other participants' (XPs') votes when determining the rank of an idea to be displayed to P1. Thus, if P1 chooses to filter his feed and see only great ideas, the system could eliminate or diminish the impact of those other participants' (XPs') votes in determining which ideas are great. This could be especially important for asynchronous examples of our system (including forums and multi-forums) because we do not always have the ability to use antivotes (post-session extraction) as we can in synchronous sessions.

The ability to use extraction may be limited depending on the makeup of the participants (how many participants wish to be extracted and from which other participants). The system can be configured to extract on a best effort basis. That is, for instance, the system may be able to diminish or eliminate the impact of certain votes as much as possible while retaining high quality and fidelity, and not overwhelming the system. In some examples, the end result may be that not all of the XPs' votes are disregarded completely. In some examples, the system can also signal to individual participants, via icon or other indicator, which posts were filtered/selected by a given/high percentage of their XPs. Even if the ability to be extracted exists, in some examples, participants may prefer to have XP highly ranked posts appear, as long as they are signaled.

FIG. 47 is block diagram of an example computer system 4700. The system 4700 could be used, for example, to perform processing steps necessary to implement the techniques described herein.

The system 4700 includes a processor 4710, a memory 4720, a storage device 4730, and an input/output device 4740. Each of the components 4710, 4720, 4730, and 4740 can be interconnected, for example, using a system bus 4750. The processor 4710 is capable of processing instructions for execution within the system 4700. In one implementation, the processor 4710 is a single-threaded processor. In another implementation, the processor 4710 is a multi-threaded processor. The processor 4710 is capable of processing instructions stored in the memory 4720 or on the storage device 4730.

The memory 4720 stores information within the system 4700. In one implementation, the memory 4720 is a computer-readable medium. In one implementation, the memory 4720 is a volatile memory unit. In another implementation, the memory 4720 is a non-volatile memory unit.

The storage device 4730 is capable of providing mass storage for the system 4700. In one implementation, the storage device 4730 is a computer-readable medium. In various different implementations, the storage device 4730 can include, for example, a hard disk device, an optical disk device, or some other large capacity storage device.

The input/output device 4740 provides input/output operations for the system 4700. In one implementation, the input/output device 4740 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 4760. Other implementations, however, can also be used, such as mobile computing devices, mobile communication devices, set-top box television client devices, etc.

Although an example processing system has been described in FIG. 47, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Below is a description of some examples of our system. This description is largely taken from our earlier filed patent application, U.S. patent application Ser. No. 12/473,598.

Some examples of our system include a computer system and algorithmic methods for selecting a consensus or a group of preferred ideas from a group of participants or respondents. While much of the description explains the methodology of this invention, the invention is best practiced when encoded into a software-based system for carrying out this methodology. This disclosure includes a plurality of method steps which are in effect flow charts to the software implementation thereof. This implementation may draw upon some or all of the steps provided herein.

The participants may vote on a set of ideas that are provided to the participants, or may themselves generate a set of responses to a question, or may even generate the question itself. The ideas may include anything that can be chosen or voted on, including but not limited to, words, pictures, video, music, and so forth.

The participants repeatedly go through the process of rating a subset of ideas and keeping the highest-rated of all the ideas, until the subset is reduced to a targeted number, or optionally repeated until only a single idea remains. The last remaining idea represents the consensus of the group of participants. There are several specific aspects that pertain to this selection method, several of which are briefly summarized in the following paragraphs.

One specific aspect is that the first time the ideas are divided into groups, the group may explicitly exclude the idea that is generated by the participant, so that the participant is not put in a position where he/she may compare his/her own idea to those generated by other participants.

Another aspect is that the first time the ideas are divided into groups, the groups may be formed so that no two ideas are included together in more than one group. In other words, a particular idea competes against another particular idea no more than once in the initial round of rating.

Another aspect is that the participants may rate their respective groups of ideas by ranking, such as by picking their first choice, or by picking their first and second choices, or by picking their first, second and third choices. They may also vote in a negative manner, but choosing their least favorite idea or ideas from the group.

Another aspect is that for each round of rating, there may be a threshold rating level that may optionally be adjusted for competition that is too difficult and/or too easy.

Another aspect is that a particular participant that votes against the consensus, such as a saboteur or other evil-doer, may have his/her votes discounted. This aspect, as well as the other aspects summarized above, is described in greater detail in the remainder of this document.

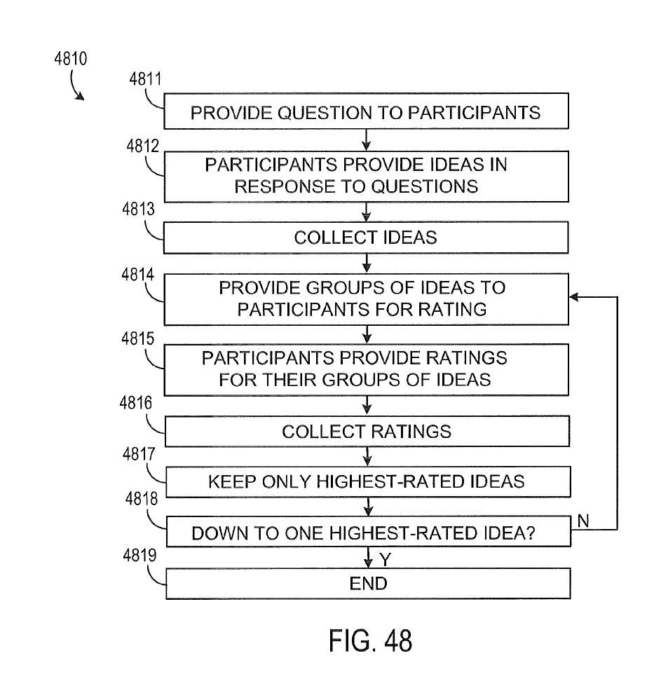

A flowchart of some of the basic elements of the method 4810 for selecting a consensus is shown in FIG. 48.

In element 4811, a question may be provided to a group of participants or respondents. The question may be multiple-choice, or may alternately be open-ended.

In element 4812, the participants provide their respective responses to the question of element 4811, which may be referred to as “ideas”. Their answers may be selected from a list, as in a multiple-choice vote or a political election, or may be open-ended, with a wording and/or content initiated by each respective participant.

In element 4813, the ideas generated in element 4812 are collected.

In element 4814, the ideas collected in element 4813 are parsed into various groups or sets, with a group corresponding to each participant, and the groups are distributed to their respective participants. The groups may be overlapping (i.e., non-exclusive) subsets of the full collection of ideas. In some embodiments, each group explicitly excludes the idea generated by the particular participant, so that the participant cannot rate his/her own idea directly against those generated by other participants. In some embodiments, each group is unique, so that no two groups contain exactly the same ideas. In some embodiments, the groups are parsed so that no two ideas appear together in more than one group. In some embodiments, the number of ideas per group is equal to the number of times a particular idea appears in a group. The mathematics of the group parsing is provided in greater detail below.

In element 4815, the participants rate the ideas in their respective groups. In some embodiments, the ratings include a ranking of some or all of the groups. In some embodiments, the ratings include selecting a first choice from the ideas in the group. In some embodiments, the ratings include selecting a first and second choice. In some embodiments, the ratings include selecting a first, second and third choice.

In element 4816, the ratings from or all or most of the participants are collected and tallied. In some embodiments, each idea is given a score, based on the average rating for each group in which the idea appears. The mathematics of the ratings tallying is provided in greater detail below.

In element 4817, the highest-rated ideas are kept in consideration, and may be re-parsed into new groups and re-distributed to the participants for further competition. The lower-rated ideas are not considered for further competition. The cutoff may be based on a rating threshold, where ideas scoring higher than the threshold are kept and ideas scoring less than the threshold are discarded. In some embodiments, the threshold may be absolute. In some embodiments, the threshold may be relative, based on the relative strength of the ideas in competition. In some embodiments, the thresholds may be adjusted based on the relative strength of the competition. The mathematics behind these threshold aspects is provided in greater detail below.

In element 4818, if only one idea is kept from element 4817, then that idea is the consensus and we are finished, so we proceed to element 4819 and stop. If more than one idea is kept from element 4818, then we return to element 14 and continue.

In some embodiments, the elements 4811-4819 in method 4810 are carried out by software implemented on one or more computers or servers. Alternatively, the elements may be performed by any other suitable mechanism.

At this point, it is worthwhile to describe an example, with mathematical discussions following the example.

In this example, a company asks a group/crowd of 1000 customers to give advice on “what our customers want”. As incentive, the company will give product coupons to all participants and will give larger prizes and/or cash for the best ideas. The participation will be through a particular website that is configured to deliver and receive information from the participants. The website is connected to a particular server that manages the associated data.

In this example, “what our customers want” is analogous to the question of element 4811 in FIG. 48.

Each participant types in an idea on the website. This is analogous with elements 4812 and 4813 in FIG. 48.

The server randomly mixes and parses the ideas for peer review. Each participant is randomly sent 10 ideas to rate through the website. For this example, each idea is viewed by 10 other users, but compared to 90 other ideas. This is analogous with element 4814 in FIG. 48.

In this example, there are two constraints on random mixing and parsing of the ideas. First, the participant's own idea is not sent to the participant, so that the participant does not have the opportunity to rate his/her own idea. Second, no idea is paired with any other idea more than once. This avoids the potential for a particularly good idea being eliminated by repeatedly being paired with one or more extremely good ideas, while a mediocre idea is passed along by being luckily paired with 9 bad ideas.

Each participant views the 10 ideas from other participants on the website, and chooses the one that he/she most agrees with. The participant's selection is also performed through the website. This is analogous with elements 4815 and 16 in FIG. 48.

The company specifies a so-called “hurdle rate” for this round of voting, such as 40%. If a particular idea wins 40% or more of the 10 distinct competitive sets that include it, then it is passed on to the next round of competition. If the particular idea does not win more than 40%, it is excluded from further competition and does not pass on to the next round of competition. Note that the company may also specify a certain desired number of ideas (say, top 100) or percentage of ideas (say, top 10%) to move on to the next round, rather than an absolute hurdle rate (40%). Note that the hurdle rate may be specified by the operator of the website, or any suitable sponsor of the competition. The server tallies the selections from the participants, and keeps only the highest-rated ideas. This is analogous with element 4817 in FIG. 48.

For this example, we assume that the server keeps the top 100 ideas for the next round of competition. The server re-randomizes and parses the 100 ideas into sets of 8 this time, rather than the set of 10 from the first round of competition. Each idea is seen by 80 participants in this round, compared to 10 in the initial round. In this round, each idea may be in competition with another particular idea more than once, but never more than 8 times in the 80 competitions. The probability of multiple pairings decreases with an increasing number of pairings, so that having two particular ideas paired together 8 times in this example is possible, but is rather unlikely. The random sets of 8 ideas are sent to all the initial 1000 participants through the website.

The company or sponsor specifies the hurdle rate for an idea to pass beyond the second round of competition. For this example, the second hurdle rate may be the top 5 ideas. The participants vote through the website, the server tallies the votes, and the top 5 ideas are selected, either to be delivered to the company or sponsor, or to be entered into a third round of competition.

In this example, through two relatively simple voting steps in which each participant selects his/her favorite from a list of 10 and 8 ideas, respectively, the company and/or sponsor of the competition learns the best ideas of the group/crowd of participants. Any or all of the competition may be tailored as needed, including the number of voting rounds, the number of ideas per set, the hurdle rates, and so forth.

The following is a more detailed explanation of some of the internal tasks performed by the server, as in elements 4814-4817 of FIG. 48.

For this explanation, we will use numbers as proxies for ideas. We assume 1000 users, each generating an idea, for a total of 1000 ideas. For this example, we denote each idea by an objective ranking, with 1000 being the best idea and 1 being the worst. In practice, actual ideas may not have an objective ranking, but for this example, it is instructive to assume that they do, and to watch the progress of these ideas as they progress through the rating system.

First, we determine how many different “ideas” (numbers in our case) we want each participant to view/judge. In this example, we choose a value of 10.

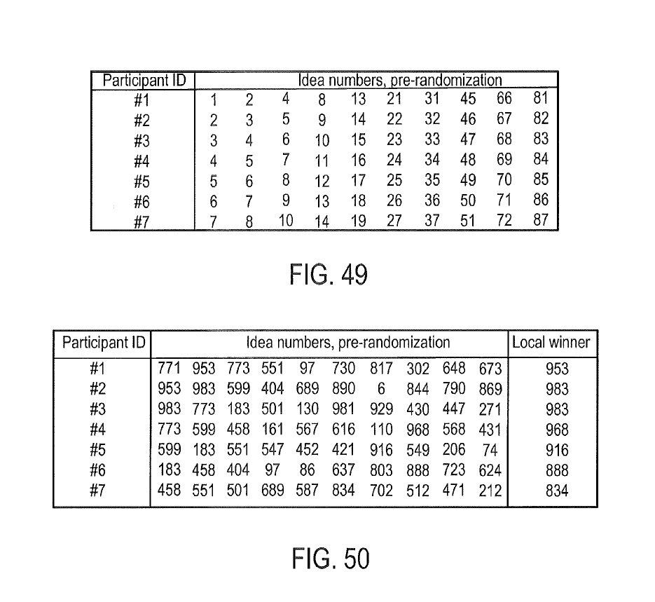

Next we build a template for 1000 users with 10 views each and no two ideas ever matched more than once. An example of such a template is shown in FIG. 49; instructions on how to generate such a template are provided below. Note that this is just a template, and does not represent any views seen by the users.

Then, we randomly assign each of the 1000 participants to a number on the template. These assignments are shown in FIG. 50; in this case #771 is assigned to the 1 spot, #953 to the 2 spot, and so forth.

Each participant receives his/her 10 ideas and then votes for his/her favorite idea out of the 10. This “first choice” is denoted in the rightmost column in FIG. 50 as “local winner”, and is shown for each participant.

For user #1, “idea” 953 is the best idea out of the 10 presented to user #1, and therefore user #1 rates it highest. For user #2, idea 983 is the best idea out of the 10 presented to user #2, and even beat out idea 953, which is user #1's first choice. This shows a benefit of random sorting with no repeat competitions. Specifically, idea 953 may be pretty good, beating out 95.3% of the other “ideas”, but if all were riding on user #2's set, 953 would have been eliminated. For user #7, idea 834 passed through, due to a random juxtaposition with easy competition.

For this initial voting round, we use a sorting method that never pairs two “ideas” together more than once. This way, each of the 1000 ideas competes with 90 other ideas even though any one user never has to compare more than 10 ideas with each other. This helps keep the fidelity of the winners high, while at the same time helps reduce the work of individual users.

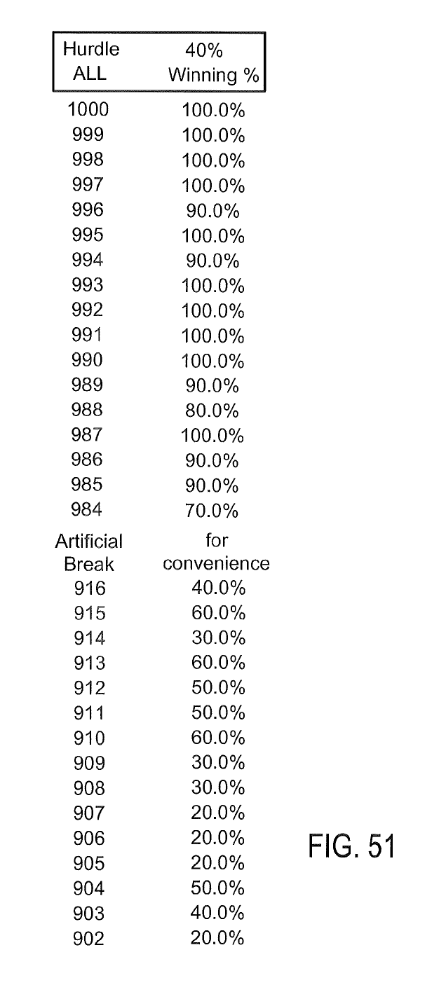

To demonstrate how effectively these “ideas” pass through the ranking system, we sort them by ranking and examine their winning percentage. This is shown in tabular form in FIG. 51. We then set a so-called “hurdle rate”, such as 40%, and pass only “ideas” that win at least 40% of their 10 competitions.

For the best “ideas” (those with high numbers in this example), we expect to see high percentages of victory for the competitions in which they occur. For the particular hurdle rate of 40%, the top 86 competitors, numbered from 1000 down to 915, all passed with at least 40% of the first-choice votes of the competitions. For ideas numbering 914 and down, we randomly lose some ideas that were better than a few of the worst winners.

Considering that the goal of this parsing is to filter the best 1% or less of the 1000 ideas, there may be a considerable margin of safety. In this example, the users filter 11.8% of the total ideas and the return the absolute best 8.6%, which may be significantly larger than the 1% or less that is desired.

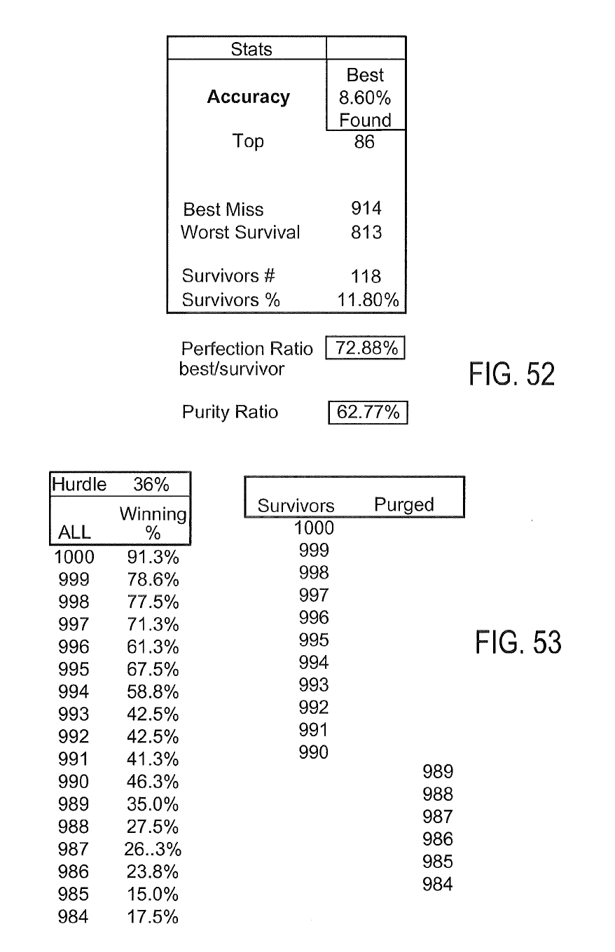

FIG. 52 is a tabular summary of the results of FIG. 51, for the initial round of voting. The best idea that is excluded by the initial round of voting is idea 914, denoted as “Best Miss”. The worst idea that is passed on to further rounds of voting is idea 813, denoted as “Worst Survivor”. Note that FIG. 52 provides an after-the-fact glimpse of the accuracy statistics of the initial round of voting; in a real voting session these would not be known unless the entire group of participants sorted through and ranked all 1000 ideas.

For the second round of voting, we include only the ideas that exceeded the hurdle rate of the initial round of voting. For simplicity, we assume that there were 100 of these ideas that exceed the hurdle rate of the initial round of voting. Note that we have 1000 participants but only 100 ideas to vote on, which implies that the fidelity of the second-round voting results may be even better than in the first-round, as a greater percentage of the participants vote on the remaining ideas.

For this second round of voting, we parse the 100 ideas into competitive sets of 8 ideas, rather than the 10-idea sets used in the initial round of voting, and distribute them to the initial 1000 participants. The rationale for this parsing choice is provided below.

Each of the 100 ideas appears in 80 unique competitive viewings for the second round, compared to 10 unique competitive viewings for the first round. This is an increased number of competitions per idea, even though any individual participant sees only 8 of the 100 ideas.

For the second round and any subsequent rounds, we may no longer enforce the “no two ideas ever compete with each other twice” rule. However, the most they can overlap is 8 out of the 80 competitions in the second round. Typically we expect no more than 2 or 3 pairings of any two particular ideas in the second round, with higher pairings become increasingly unlikely. For one or more voting rounds near the end of the session, in which the voting pool has been thinned to only a handful of ideas, the entire group of participants may vote directly on the entire voting pool of ideas.

FIG. 53 is a tabular summary of the second-round voting results. For a hurdle rate of 36%, the 11 best ideas are retained for subsequent voting or for delivery to the survey sponsor. Subsequent voting rounds would return the highest-ranked ideas. As the last round of voting, for a sufficiently low number of ideas, such as 3, 5 or 10, it may be desirable to have all participants vote on all the ideas, without regard for any duplicate pairings.

The preceding explanation, as well as the numerical results of FIGS. 49-53, is merely exemplary and should not be construed as limiting in any way. Two particular aspects of the above explanation are presented in greater detail below, including an exemplary set of instructions for generating a template, and an exemplary guide for selecting how many ideas are presented to each participant in a given round of voting.

As an alternative to having the participants choose only their favorite idea, i.e. a first choice, the participants may alternatively choose their first and second choices, or rank their top three choices. These may be known as “complex hurdles”, and a “complex hurdle rate” may optionally involve more than a single percentage of competitions in which a particular idea is a #1 choice. For instance, the criteria for keep/dismiss may be 50% for first choice (meaning that any idea that is a first choice in at least 50% of its competitions is kept for the next round), 40%/20% for first/second choices (meaning that if an idea is a first choice in at least 40% of its competitions and is a second choice in at least 20% of its competitions is kept for the next round), 30%/30% for first/second choices, 20%/80% for first second choices, and/or 10%/80% for first/second choices. The complex hurdle rate may include any or all of these conditions, and may have variable second choice requirements that depend on the first choice hurdle rate.

The following three paragraphs provide a rationale for choosing the number of ideas to include in a group for each participant, based on the number of participants and the constraint that no two particular ideas should appear together in more than one group. Based on this rationale, each idea may be compared with a maximum number of other ideas for a given round of voting.

The rationale includes a known sequence of integers, known in number theory as the Mian-Chowla sequence. The following description of the Mian-Chowla sequence is taken from the online reference wikipedia.org:

In mathematics, the Mian-Chowla sequence is an integer sequence defined recursively in the following way. Let a.sub.1=1. Then for n>1, a.sub.n is the smallest integer such that the pairwise sum a.sub.i+a.sub.j is distinct, for all i and j less than or equal to n. Initially, with a.sub.1 there is only one pairwise sum, 1+1=2. The next term in the sequence, a.sub.2, is 2 since the pairwise sums then are 2, 3 and 4, i.e., they are distinct. Then, a.sub.3 can't be 3 because there would be the non-distinct pairwise sums 1+3=2+2=4. We find then that a.sub.3=4, with the pairwise sums being 2, 3, 4, 5, 6 and 8. The sequence continues 8, 13, 21, 31, 45, 66, 81, 97, 123, 148, 182, 204, 252, 290, 361, 401, 475, and so forth. This sequence is used because the difference between any two numbers in the sequence is not repeated, which becomes useful in the construction of templates, described in detail below.

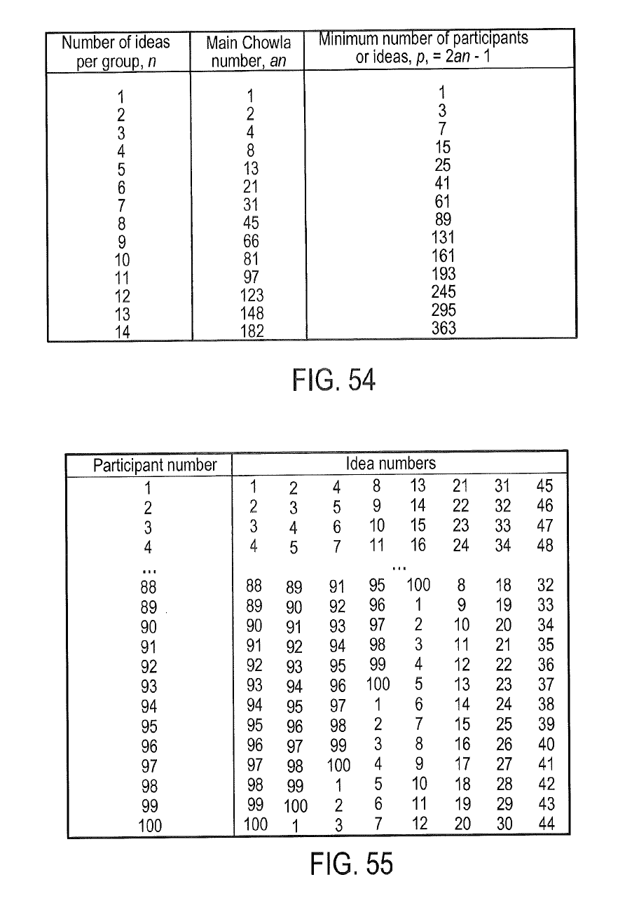

For a given number of participants and a given number of ideas, we denoted the quantity p as the lesser of the number of participants and the number of ideas. We choose the number of ideas n in a group to be the largest integer n that satisfies (2a.sub.n−1).gtoreq.p. For instance, for 100 participants and 100 ideas total to be voted upon, p is 100, (2a.sub.8−1) is 89, which satisfies the above equation, and (2a.sub.9−1) is 131, which does not satisfy the above equation. Therefore, for 100 ideas distributed among 100 participants, we choose 8 ideas per group. Several numerical examples are provided by FIG. 54.

The preceding rationale provides one exemplary choice for the number of ideas to be included in each group that is distributed to the voting participants. It will be understood by one of ordinary skill in the art that other suitable numbers of ideas per group may also be used.

The following is an exemplary set of instructions for generating a template. It will be understood by one of ordinary skill in the art that any suitable template may be used.

Due to the large and unwieldy number of combinations that are possible, it may be beneficial to have the server dynamically generate a suitable template for a particular number of ideas per group and a particular number of participants. In some embodiments, this dynamic generation may be preferable to generating beforehand and storing the suitable templates, simply due to the large number of templates that may be required.

The following is a formulaic method that can randomly scatter the ideas and parse them into groups or sets of various sizes, while never pairing any two ideas more than once. The method may be run fairly quickly in software, and may be scalable to any number of users or ideas per set.

First, we determine the number of ideas to include in each group of ideas that is voted upon. This may be done using the rationale described above, although any integer value up to and including the value prescribed by the rationale will also provide the condition that no two ideas are paired together more than once.

Typically, the first round of voting uses the rationale described above, with the constraint that no two ideas compete against each other more than once. For subsequent rounds of voting, this constraint is relaxed, although a template generated as described herein also reduces the number of times two ideas compete against each other.

For illustrative purposes, we assume that we have 100 participants and 100 ideas total for voting, and that we use 8 ideas per group for the initial round of voting. Each of the 100 ideas has a corresponding number, 1 through 100, which has no particular significance of its own, but is used in the template as a placeholder for identifying a particular idea.

For the first participant, we assign 8 ideas corresponding to the first 8 numbers in the Mian-Chowla sequence: 1, 2, 4, 8, 13, 21, 31 and 45.

For each subsequent participant, we increment by one the idea numbers of the previous participant. For instance, for the second participant, we increment by one the idea numbers of the first participant: 2, 3, 5, 9, 14, 22, 32 and 46. For the third participant, we increment by one the idea numbers of the second participant: 3, 4, 6, 10, 15, 23, 33 and 47.

Once idea #100 is reached, we start back at #1. For instance, for participant #56, the idea numbers are: 56, 57, 59, 63, 68, 76, 86 and 100. For participant #57, the idea numbers are: 57, 58, 60, 64, 69, 77, 87 and 1. As another example, for participant #97, the idea numbers are: 97, 98, 100, 4, 9, 17, 27 and 41. For participant #98, the idea numbers are: 98, 99, 1, 5, 10, 18, 28 and 42. For participant #99, the idea numbers are: 99, 100, 2, 6, 11, 19, 29 and 43. For participant #100, the idea numbers are: 100, 1, 3, 7, 12, 20, 30 and 44.

Mathematically, starting back at #1 is equivalent to an operation in modular arithmetic. For instance, 101 equals 1+101 mod 100, or 1 plus 101 modulo the number of ideas in the plurality. For the purposes of this application, the “1” may be neglected, and the modulus definition may include sequences such as 98, 99, 100, 1, 2, rather than the strict mathematical modulo sequence of 98, 99, 0, 1, 2. Since the idea numbers are merely placeholders to be later paired up with ideas, we ignore any representational differences between 0 and 100, and choose to use 100 because we normally begin a count with the number 1 rather than 0.

FIG. 55 is a tabular representation of the distribution of idea numbers among the participants, as described above.

If there are more participants than ideas, we continue assigning idea numbers in the recursive manner described above.

Note that there are two particularly desirable features of this distribution of idea numbers among the participants. First, each particular pair of idea numbers appears together in at most one participant's group of ideas. Second, each particular idea shows up in exactly 8 participants' groups of ideas. If the number of participants exceeds the number of ideas, some ideas may receive more entries in the template than other ideas. Any inequities in the number of template entries may be compensated if the “winners” in each voting round are chosen by the percentage of “wins”, rather than the absolute number of “wins”.

Next, we randomly assign the participant numbers to the true participants, and randomly assign the idea numbers to the true ideas. This randomization ensures that that a particular participant receives a different set of ideas each time the process is run.

Finally, we scan each of the entries in the template to find entries in which a particular participant receives his/her own idea in his/her group. Because we don't want to have a participant rate his/her own idea, we swap idea sets with other participants until there are no more cases where a particular participant has his/her own idea in his/her group.

The above formulaic method for randomly scattering the ideas and parsing them into groups of various sizes may be extended to any number of participants, any number of ideas, and any number of ideas per group. For an equal number of participants and ideas, if the number of ideas per group is chosen by the rationale described above, any two ideas are not paired more than once.

There may be instances when there are more participants than ideas. For instance, if the initial round of voting has equal numbers of ideas and participants, then subsequent rounds of voting may likely have more participants than ideas, because some ideas have been eliminated. For more participants than ideas, the templates may be constructed for the particular number of ideas, and may be repeated as necessary to cover all participants. For later rounds of voting, in which the number of ideas may be manageable, such as 2, 3, 4, 5, 8, 10 or any other suitable integer, the templates may not even be used, and the entire small group of ideas may be distributed to all participants for voting. In this manner, the entire group of participants may directly vote for the winning idea to form the consensus.

There may be instances when there are more ideas than participants. For instance, a panel of 10 participants may vote on 30 ideas. If there are significantly more ideas than participants, such as by a factor of 2, 3 or more, then it may be beneficial to first form multiple, separate templates, then join them together to form a single template.

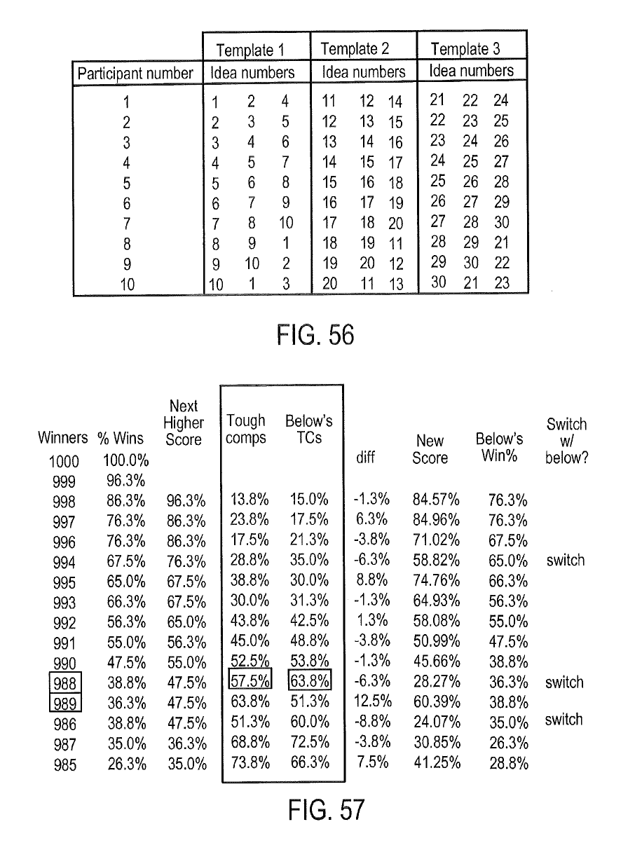

Using the example of 10 participants and 30 ideas, we find the largest number of ideas per group for 10 participants, based on the rationale above and the tabular data in FIG. 54. This value turns out to be three ideas per group. It may be more efficient to increase the number of ideas per group because each participant may readily handle more than 3 choices, so we choose to make three templates—one for idea numbers 1-10, one for idea numbers 11-20 and one for idea numbers 21-30—and stitch them together afterwards. FIG. 56 is a tabular representation of a stitched-together template. For the exemplary stitched-together template of FIG. 56, there are 9 ideas per group, with each of the 30 total ideas appearing in 3 groups.

Because there may be so few groups containing a particular idea, it may be beneficial to have each participant pick his/her first and second ranked choices, or top three ranked choices.

The following is an example of an algorithm to guard against fraud. Such an algorithm may be useful to foil any potential scammers or saboteurs who may deliberately vote against good ideas in the hopes of advancing their own ideas.

A simple way to guard against fraud is to compare each participant's choices to those of the rest of the participants after a round of voting is completed. In general, if a participant passes up an idea that is favored by the rest of the participants, or advances an idea that is advanced by few or no other participants, then the participant may be penalized. Such a penalty may be exclusion from further voting, or the like. Once a fraud is identified, his/her choices may be downplayed or omitted from the vote tallies.

Mathematically, an exemplary way to find a fraud is as follows. For each idea, define a pass ratio as the ratio of the number of wins for the idea, divided by the total number of competitions that the idea is in. Next, calculate the pass ratios for each idea in the group. Next, find the differences between the pass ratio of each idea in the group and the pass ratio of the idea that the participant chooses. If the maximum value of these differences exceeds a particular fraud value, such as 40%, then the participant may be labeled as a fraud. Other suitable ways of finding a fraud may be used as well. Once a fraud is identified, the fraud's voting choices may be suitably discounted. For instance, of the group of ideas presented to the fraud, the fraud's own voting choice may be neglected and given instead to the highest-ranking idea present in the fraud's group of ideas. In addition, the fraud's choices may be used to identify other frauds among the participants. For instance, if a probable fraud picked a particular idea, then any other participant that picked that particular idea may also by labeled as a fraud, analogous to so-called “guilt by association”. This may be used sparingly to avoid a rash of false positives.

Due to the random nature of the idea parsing, in which ideas are randomly grouped with other ideas, there may be instances when an idea is passed on to future voting rounds because it has unusually weak competition, or is blocked from future voting rounds because it has unusually strong competition. This random nature is most problematic for ideas that would otherwise rate at or near the hurdle rates, where just a small change in voting up or down could decide whether the idea is passed along or not. The following is a description of four exemplary algorithms for compensating for such a random nature of the competition.

A first algorithm for compensating for the random nature of the competition is described as follows.

We define a quantity known as “tough competition percentage” as the fraction of an idea's competition groups that contain at least one competitor that scored a higher percentage of wins that the idea in question. The “tough competition percentage” is calculated after a particular round of voting, and may be calculated for each idea.

If a particular idea is paired up with unusually strong competition in the various idea groups that contain it, then after the round of voting, its “tough competition percentage” may be relatively high. Likewise, unusually weak competition may produce a relatively low “tough competition percentage”.

Given a “win percentage” defined as the ratio of the number of groups in which a particular idea wins the voting, divided by the number of groups in which a particular idea appears, and given the “tough competition percentage” defined above, we may perform the following calculations, shown schematically in FIG. 57.

Rank the ideas by “win percentage”, as in the second column. Calculate the “tough competition percentage”, as in the fourth column. From the “tough competition percentage” in the fourth column, subtract the “tough competition percentage” of the idea below the idea in question, listed in the fifth column, with the difference being in the sixth column. Add the difference in the sixth column to the “win percentage” in the second column to arrive at a so-called “new score” in the seventh column. If any values in the seventh column are ranked out of order, then switch them.

In addition to this first algorithm described above and shown schematically in FIG. 57, there may be other algorithms that help compensate for unusually strong or unusually weak competition. A second algorithm for compensating for the random nature of the competition is described as follows.

We define a so-called “face-off ratio” as the number of times a particular idea beats another particular idea, divided by the number of groups that contain both of those two ideas. If a “face-off ratio” of an idea with the idea that is ranked directly adjacent to it exceeds a so-called “face-off ratio threshold”, such as 66% or 75%, then the two ideas may be switched. This “face-off ratio” may not be used in the first round of voting, because two ideas may not be paired together more than once.

A third algorithm for compensating for the random nature of the competition is described as follows.

After a particular round of voting, each idea has a “win percentage”, defined as the ratio of the number of groups in which a particular idea wins the voting, divided by the number of groups in which a particular idea appears.

For each group in which a particular idea appears, we find the maximum “win percentage” of all the ideas in the group, excluding the “win percentage” of the idea in question. We denote this as a “top see win percentage” for the group, for the idea in question. If the idea in question won/lost the voting for the group, then we denote this as beating/losing to a group with a particular “top see win percentage”. We repeat this for each of the groups in which a particular idea appears. We then find the highest “top see win percentage” that the idea beat and increment it by (1/the number of ideas per group), find the lowest “top see win percentage” that the idea lost to and decrement it by (1/the number of ideas per group), and average those two numbers with the “win percentage” of the idea in question to form a “new score” for each idea. If the “new score” of a particular idea differs from its “old score” by more than a particular threshold, such as 6%, then we change its “old score” to the “new score” and repeat the previous steps in the algorithm at least once more.

A fourth algorithm for compensating for the random nature of the competition is described as follows.

After a particular round of voting, each idea has a “win percentage”, defined as the ratio of the number of groups in which a particular idea wins the voting, divided by the number of groups in which a particular idea appears.

Tally the “win percentages” of all the other individual ideas that appear in all the groups in which the particular idea appears. Find the highest win percentage from every competitive set that includes the particular idea and denote as “top sees”. From these tallied “top sees”, find Q1 (the first quartile, which is defined as the value that exceeds 25% of the tallied “top sees”), Q2 (the second quartile, which is defined as the value that exceeds 50% of the tallied “top sees”, which is also the median “top see” value), and Q3 (the third quartile, which is defined as the value that exceeds 75% of the tallied “top sees”).

Note that if the competition is truly random, and if the groups are truly randomly assembled, then a fair median “top see” for all the other individual ideas that appear in all the groups in which the particular idea appears would be 50%. If the calculated Q2 differs from this fair value of 50% by more than a threshold, such as 10%, then we deem the competition to be unfair and proceed with the rest of this fourth correction algorithm.

Similarly, if the difference between (Q3−Q2) and (Q2−Q1) exceeds a threshold, such as 10%, then we see that the distribution may be skewed, and also deem the competition to be unfair and proceed with the rest of this fourth correction algorithm.

We define a “new score” as the idea's original “win percentage”, plus (Q1+Q3−50%). The ideas may then be re-ranked, compared to adjacent ideas, based on their “new scores”. The re-ranking may occur for all ideas, or for a subset of ideas in which at least one of the two triggering conditions above is satisfied.

Alternatively, other percentile values may be used in place of Q1, Q2 and Q3, such as P90 and P10 (the value that exceeds 90% and 10% of the tallied “win percentages”, respectively.) In addition to the four algorithms described above, any suitable algorithm may be used for adjusting for intra-group competition that is too strong or too weak.

In some embodiments, it may be useful to periodically or occasionally check with the participants and ensure that they agree with the status of the session for their voting. For instance, an agenda may be written up by a group of participants, posted, and voted on by the all the participants. The full agenda or individual items may be voted on the group, in order to provide immediate feedback. Such approval voting may be accomplished in discrete steps or along a continuum, such as with a toggle switch or any suitable mechanism. This approval voting may redirect the agenda according to the overall wishes of the participants.

In some embodiments, two or more ideas may be similar enough that they end up splitting votes and/or diluting support for themselves. These ideas may be designated as so-called “equals”, and their respective and collective votes may be redistributed or accumulated in any number of ways. For instance, some participants may be asked to identify any equals from their sets. Other participants who voted on these ideas may be asked to confirm two or more ideas as being “equal”, and/or may choose a preferred idea from the group of alleged “equals”. The votes tallied from these “equals” may then be combined, and the preferred idea may move on the next round of voting, rather than all the ideas in the group of “equals”.

In some embodiments, a credit or debit card may be used to verify the identity of each participant, and/or to credit a participant suitably if the participant's idea advances to an appropriate voting stage.

In some embodiments, there may be some participants that are desirably grouped together for voting. These participants may be grouped together by categories such as job title, geographic location, or any other suitable non-random variable.

In some embodiments, it may be desirable to deal with polarizing ideas and/or polarized participants. For instance, a combined group of Democrats and Republicans may be voting on a particular group of ideas, where some ideas appeal to Democrats but not Republicans, and vice versa. For the polarized situations, the participants may optionally separate themselves into smaller subgroups, by casting a so-called “anti-vote” for a particular idea or ideas.

In some embodiments, a participant may attach an afterthought, a sub-idea and/or a comment to a particular idea, which may be considered by the group of participants in later rounds of voting. Such a commented idea may accumulate “baggage”, which may be positive, negative, or both.

In some embodiments, it may be desirable to test the voting and selection systems described above, as well as other voting and selection systems. Such a test may be performed by simulating the various parsing and voting steps on a computer or other suitable device. The simulation may use numbers to represent “ideas”, with the numerical order representing an “intrinsic” order to the ideas. A goal of the simulation is to follow the parsing and voting techniques with a group of numbers, or intrinsically-ordered ideas, to see if the parsing and voting techniques return the full group of ideas to their intrinsic order. If the full order is not returned, the simulation may document, tally and/or tabulate any differences from the intrinsic order. It is understood that the testing simulation may be performed on any suitable voting technique, and may be used to compare two different voting techniques, as well as fine-tune a particular voting technique.

As an example, we trace through the voting technique described above. We start with a collection of participants and ideas, in this case, 10,000 of each. We calculate the number of ideas per group for 10,000 participants, then form a template based on the number of ideas per group, and the total number of ideas and participants. We may use the template described above, based on the Mian-Chowla sequence of integers, or may use any other suitable template. We then parse the ideas into subgroups based on the template, and randomize the ideas so that the numbers no longer fall sequentially in the template. We then perform a simulated vote for each participant, with each participant “voting” for the largest (or smallest) number in his/her group of ideas. We may optionally include deliberate errors in voting, to simulate human factors such as personal preference or fraud. We then tally the votes, as described above, keep the “ideas” that exceed a particular voting threshold, re-parse the “ideas”, and repeat the voting rounds as often as desired. At the end of the voting rounds, the largest (or smallest) number should have won the simulated voting, and any discrepancies may be analyzed for further study.

In some embodiments, it may be desirable to edit a particular idea, suggest an edit for a particular idea, and/or suggest that the author of an idea make an edit to the particular idea. These edits and/or suggested edits may change the tone and/or content of the idea, preferably making the idea more agreeable to the participants. For instance, a suggested edit may inform the idea's originator that the idea is unclear, requires elaboration, is too strong, is too wishy-washy, is too vulgar, requires toning down or toning up, is too boring, is particularly agreeable or particularly disagreeable, is incorrect, and/or is possibly incorrect. In some embodiments, these edits or suggested edits may be performed by any participant. In some embodiments, the edits are shown to the idea's originator only if the number of participants that suggested the same edit exceeds a particular threshold. In some embodiments, edits to an idea may only be performed by the originator of the idea. In some embodiments, edits may be performed by highlighting all or a portion of an idea and associating the highlighted portion with an icon. In some embodiments, the group of participants may vote directly on an edit, and may approve and/or disapprove of the edit. In some embodiments, severity of suggested edits may be indicated by color. In some embodiments, multiple edits to the same idea may be individually accessible. In some embodiments, the ideas may be in video form, edits may be suggested on a time scale, and edit suggestions may be represented by an icon superimposed on or included with the video.

There are some instructive quantities that may be defined, which may provide some useful information about the voting infrastructure, regardless of the actual questions posed to the participants.

The “win percentage”, mentioned earlier, or “win rate”, is defined as the ratio of the number of groups in which a particular idea wins the voting, divided by the number of groups in which a particular idea appears.

The “hurdle rate” is a specified quantity, so that if the “win percentage” of a particular idea exceeds the hurdle rate, then the particular idea may be passed along to the next round of voting. The “hurdle rate” may optionally be different for each round of voting. The “hurdle rate” may be an absolute percentage, or may float so that a desired percentage of the total number of ideas is passed to the next voting round. The “hurdle rate” may also use statistical quantities, such as a median and/or mean and standard deviation; for instance, if the overall voting produces a mean number of votes per idea and a standard deviation of votes per idea, then an idea may advance to the next round of voting if its own number of votes exceeds the mean by a multiple of the standard deviation, such as 0.5, 1, 1.5, 2, 3 and so forth. The “hurdle rate” may also apply to scaled or modified “win percentages”, such as the “new scores” and other analogous quantities mentioned earlier.

Note that for this application, the term “exceeds” may mean either “be greater than” or “be greater than or equal to”.

A “template” may be a useful tool for dividing the total collection of ideas into groups. The template ensures that the ideas are parsed in an efficient manner with constraints on the number of times a particular idea appears and how it may be paired with other ideas. Once the template is in place, the slots in the template may be randomized, so that a particular idea may appear in any of the available slots in the template.

A “perfect inclusion” may be the defined as the ratio of the number of ideas that scored higher than the highest-scoring idea that fails to exceed the hurdle rate, divided by the total number of ideas.

A “perfection ratio” may be defined as the ratio of the “perfect inclusion”, divided by the “win percentage”.

A “purity ratio” may be defined as the ratio of the number of ideas with a “win percentage” that exceeds the “hurdle rate”, divided by the number of ideas with a “win percentage” that should exceed the “hurdle rate”.

The “purity ratio” may be different for different values of “win percentage”, and may therefore be segmented into various “sector purity ratio” quantities.

An “order” test may be performed, in which the actual ranking of an idea is subtracted from the expected ranking of the idea.

In addition to the methods and devices described above, there are two additional quantities that may be used to enhance or augment the ratings that are given to the ideas. A first quantity is the amount of time that a person spends performing a particular rating. A second quantity is a so-called “approval” rating, which pertains more to the style or type of question being asked, rather than to the specific answer chosen by the group. Both of these quantities are explained in greater detail below.

There is much to be learned from the amount of time that a person spends deliberating over a particular rating. For instance, if a person gives a positive rating to a particular idea, and does it quickly, it may indicate that the person has strong support for the idea. Such a quick, positive reaction may show that there is little or no opposition in the mind of the participant. In contrast, if the person gives the same positive rating to the idea, but takes a long time in doing so, it may indicate that the person does not support the idea as strongly. For instance, there may be some internal debate in the mind of the participant.

This rating evaluation time may be used as a differentiator between two otherwise equivalent ratings. For many of these cases, the evaluation time is not weighted heavily enough to bump a rating up or down by one or more levels. However, there may be alternative cases in which the evaluation time is indeed used to bump up or down a particular rating.

For positive ratings, a quick response may be considered “more” positive than an equivalent slow response. In terms of evaluation times, a positive response with a relatively short evaluation time may be considered “more” positive than the equivalent response with a relatively long evaluation time. In other words, for two responses that receive the same positive rating, a quick response may rate higher (more positive) than a slow response.

Likewise, for a neutral response, a quick response may also be considered more positive than a slow response. In other words, for two equivalent neutral responses, the response with the shorter evaluation time may be considered more positive than the response with the longer evaluation time.

The logic behind the positive and neutral ratings is that deliberation in the mind of the evaluator shows some sort of internal conflict. This conflict may be interpreted as a lack of wholehearted, or unquestioning support for the idea under evaluation.

For negative responses, in which the participant disapproves of a particular idea by giving it a negative rating, the same type of internal conflict argument may be made. For negative responses, a quick rating may show that the participant is highly critical of the idea, since there is little internal debate. A slower negative response may show internal conflict for the participant. These are consistent arguments with the positive and neutral cases, but they lead to inverted weighting for the negative ratings.

Specifically, because a quick negative rating shows little opposition in the mind of the participant, a quick negative rating is “more negative” than a slow negative rating. In other words, for two equivalent negative ratings, the rating having the longer evaluation time is more positive than that having the shorter evaluation time.

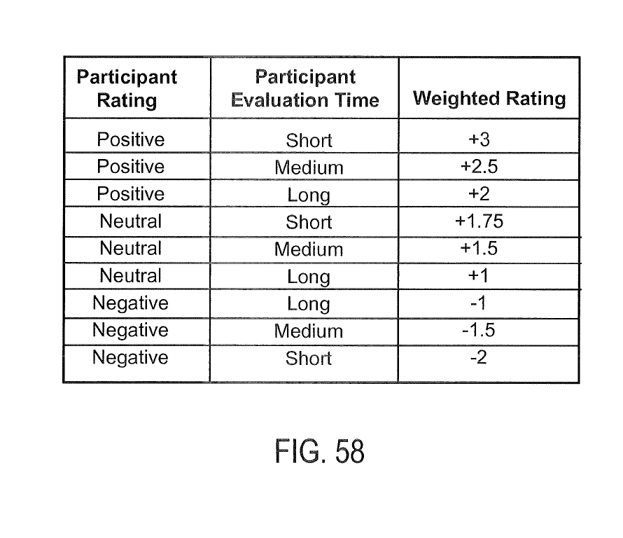

These cases are summarized in the exemplary table of FIG. 58. There are three possible ratings that can be given to a particular idea—positive, neutral or negative. In other examples, there may be additional rating levels, such as highly positive or highly negative. In still other examples, there may a numerical scale used, such as a scale from 1 to 10, 1 to 5, or any other suitable scale. The numerical scale may include only discrete values (1, 2, 3, 4 or 5, only) or may include the continuum of values between levels.

For each rating level, the evaluation time of the participant is noted. As with the rating levels themselves, the evaluation time may be lumped into discrete levels (short, medium, long), or may recorded and used as a real time value, in seconds or any other suitable unit. For the example of FIG. 58, the evaluation time is taken as a discrete value of short, medium or long.

The initial participant rating of positive/neutral/negative is weighted by the participant evaluation time of short/medium/long to produce the weighted ratings of FIG. 11. In this example, the weighted ratings have numerical values, although any suitable scale may be used. For instance, an alphabetical scale may be used (A+, A, A−, B+, B, B−, C+, C, C−, D+, D, D−, F), or a text-based scale may be used (very positive, somewhat positive, less positive), and so forth.

The weighted ratings may be used to differentiate between two ideas that get the same participant rating. The weighted ratings may also be used for general tabulation or tallying of the idea ratings, such as for the methods and devices described above.

If the evaluation time is to be grouped into discrete levels, such as “short”, “medium” and “long”, it is helpful to first establish a baseline evaluation time for the particular participant and/or idea. Deviations from the baseline are indicative of unusual amounts of internal deliberation for a particular idea.

The baseline can account for the rate at which each participant reads, the length (word count and/or complexity) of each idea, and historical values of evaluation times for a given participant.

For instance, to establish a reading rate, the software may record how long it takes a participant to read a particular page of instructions. The recording may measure the time from the initial display of the instruction page to when the participant clicks a “continue” button on the screen. The reading rate for a particular participant may optionally be calibrated against those of other participants.

To establish a baseline for each idea, the software may use the number of words in the idea, and optionally may account for an unusually large or complex words. The software may also optionally use the previous evaluations of a particular idea to form the baseline.

In some cases, the software may use any or all factors to determine the baseline, including the reading rate, the idea size, and historical values for the evaluation times.

Once the baseline is determined, a raw value of a particular evaluation time maybe normalized against the baseline. For instance, if the normalized response time matches or roughly matches the baseline, it may be considered “medium”. If the normalized response time is unusually long or short, compared to the baseline, it may be considered “long” or “short”.

If a particular response is well outside the expected values for response time, that particular weighted rating may optionally be thrown out. Likewise, if the reading rate is well outside an expected value, the weighted ratings for the participant may also be thrown out. In many cases, the values of the “thrown out” data points are filled in as if they were “medium” response times.

The discussion thus far has concentrated on using the time spent for evaluations as weighting factors for the ratings. In addition to evaluation time, another useful quantity that may be gathered during evaluations is a so-called “approval level”.

In some cases, the approval level may be used to judge the particular questions or topics posed to the participants, rather than the answers to those questions.

For instance, we assume that there is an agenda for the questions. Once an answer for a particular question is determined by consensus from the participants, the agenda dictates which question is asked next. The agenda may also include topics for discussion, rather than just a list of specific questions.

As evaluations progress, the participants can enter an “approval level”, which can be a discrete or continuous value, such as a number between 0% and 100%, a letter grade, such as A− or B+, or a non-numerical value, such as “strongly disapprove” or “neutral”.

The approval level may be used to approve/disapprove of the question itself, or of a general direction that the questions are taking. For instance, if a particular train of questions is deemed too political by a participant, the participant may show his dissatisfaction by submitting successively lower approval ratings for each subsequent political question.

The collective approval ratings of the participants may be tallied and displayed in essentially real time to the participants and/or the people that are asking the questions. If the approval rate drops below a particular threshold, or trends downward in a particular manner, the question-askers may choose to deviate from the agenda and change the nature of the questions being asked.

For example, consider a first question posed to the group of participants. The participants may submit ideas of their own and rate them, or may vote on predetermined ideas, resulting in a collectively chosen idea that answers the question. The participants submit approval levels for the first question. The question-asking person or people, having received an answer to the first question, ask a second question based on a particular agenda. The participants arrive at a consensus idea that answers the second question, and submit approval levels for the second question. If the approval rate is too low, the question-askers may choose to deviate from the agenda to ask a third question. This third question is determined in part by the approval levels for the first and second questions. The asking, rating, and approving may continue indefinitely in this manner. The approval levels, taken as single data points or used as a trend, provide feedback to the question-askers as to whether they are asking the right questions.

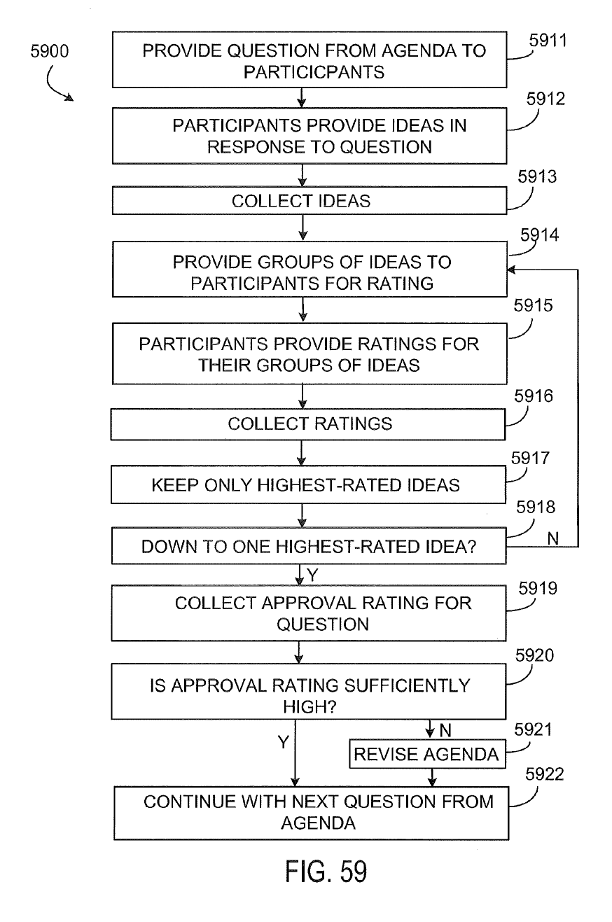

FIG. 59 shows an exemplary flowchart 5900 for the approval ratings. In element 5911, a question is selected from a predetermined agenda and provided to the participants. Elements 5912-5918 are directly analogous to elements 4812-4818 from FIG. 48. In element 5919, the software collects approval ratings corresponding to the question from the participants. If the approval rate is sufficiently high, as determined by element 5920, the questions proceed according to the agenda, as in element 5922. If the approval rate is not sufficiently high, then the agenda is revised, as in element 5921, and a question is asked from the revised agenda.

Other implementations are within the scope of the following claims.

What is claimed is:

1. A voting machine and network connecting like voting machines, configured to rapidly manage ranking of mass narrative user inputs and to interactively rank such user input comprising:
a network for interconnecting input terminals;
a plurality of input participant terminals, said terminals including data encryption of data of signals transmitted to and from the network;
said terminals include participant verification capability to ascertain that the identity of the participant can be verified to a predetermined level of security;
said terminals each configured to:
enable participants who belong to a group of participants to provide indications of relative values of ideas that belong to a body of ideas,
deriving a rank ordering according to the relative values of at least some of the ideas of the body based on the indications provided by the participants,
the participants being enabled to provide the indications in two or more rounds, each of at least some of the participants providing the indications with respect to sets of fewer than all of the ideas in the body in each of the rounds, and
between each of at least one pair of successive rounds, updating the body of ideas to reduce the role of some of the ideas in the next round;
ranking the ideas according to highest cumulative relative values.
distributing the highest ranked ideas to the terminals of the participants and receiving inputs from the participants at said terminals, where the participants rank the ideas;
after a predetermined number of rounds,
transmitting a listing of highest ranking ideas to at least some of said terminals.

2. The voting machine and network of claim 1 in which the indications provided by the participants comprise explicit ordering of the ideas based on their relative values.

3. The voting machine and network of claim 1 in which a second group/crowd group of participants is enabled to provide indications of relative values of ideas that belong to a second body of ideas, and ideas that are high in the rank ordering of the group/crowd group and in the rank ordering of the second group/crowd group are treated as communications in a conversation between the group/crowd group and the second group/crowd group.

4. A voting system of terminals connected to a network, comprising:
a network for interconnecting input terminals;
a plurality of input participant terminals, said terminals including data encryption of data of signals transmitted to and from the network;
said terminals include participant verification capability to ascertain that the identity of the participant can be verified to a predetermined level of security;
said terminals each configured to:
expose through a user interface facilities by which a user can administer an activity to be engaged in by participants who belong to a group/crowd group of participants to enable the administrator to obtain a rank ordering of ideas that belong to a body of ideas, and
implement the activity by exposing the ideas to the group/crowd group of participants, enabling the participants to provide indications of relative values of ideas that belong to the body of ideas, and
process the indications of the relative values of ideas to infer the rank ordering,
the ideas being exposed to the participants in successive rounds, each of at least some of the participants providing the indications with respect to fewer than all of the ideas in the setting each of the rounds, and
update the body of ideas before each successive round to reduce the total number of ideas that are exposed to the participants in the successive round.

5. The voting machine and network of claim 4 in which the user can administrate the activity by defining the ideas that are to be presented the participants.

6. The voting machine and network of claim 4 in which the user can administrate the activity by defining the number of rounds.

7. The voting machine and network of claim 4 in which the user can administrate the activity by defining the number of participants.

8. The voting machine and network of claim 4 in which the user can administrate the activity by specifying the identities of the participants.

9. The voting machine and network of claim 4 in which the user can administrate the activity by specifying metrics by which the values are to be measured.

10. The voting machine and network of claim 4 in which the user can administrate the activity by specifying the manner in which the ideas are presented to the participants.

11. The voting machine and network of claim 1 in which calculating the score for an idea comprises calculating a corrected score by averaging a first quartile and a third quartile score, subtracting fifty percent, and adding the original score.

12. The voting machine and network of claim 1 in which assigning ideas to subsets comprises:
numbering each idea,
generating a series of Mian-Chowla numbers for a first subset,
assigning ideas each numbered as one of the respective Mian-Chowla numbers in the series to a first subset,
incrementing each number in the series of Mian-Chowla numbers for subsequent subsets, and assigning ideas each numbered as one of the respective Mian-Chowla numbers in the incremented series to the subsequent subsets.

13. An asynchronous voting machine connected to a computer server, comprising:
a plurality of linked voting terminals capable of receiving rating voting responses to a massive number of ideas flowing into the various terminals in an asynchronous manner as these ideas are being created by voters;
the number of ideas being numbered 1 to N, N being the last idea, the voting machine performing the following tasks,
a. said terminals receive voter input in the form of ideas;
b. the server receives and stores said input of ideas and tallies the ideas until a predetermined minimum number of ideas have been entered into the terminals;
c. the voting computer server electronically distributes at least said minimum number of ideas, divided into idea sets, to voters at a plurality of terminals,
d. asynchronously, a next group of voters to access said terminals votes and/or submit more ideas,
e. an idea set is distributed to each voter at a terminal until each of the minimum number of ideas has been equally distributed;
f. when said minimum number of ideas are divided so that the number of ideas has a substantially equal and fair probability of being viewed and voted on by a generally equal number of voters;
g. voters at terminal input rankings of the ideas from the idea set received;
h. once a predetermined target set allocation is reached the rank votes are allowed to be tabulated by the sever;
i. the voting computer server has a predetermined threshold win rate against which said voter ranking for each idea are compared; and
j. the ideas which exceed said predetermined number as considered winning ideas and are segregated by the server in a first subgroup of ideas which exceed said predetermined number.

14. The voting machine of claim 13 wherein, voting continues as new ideas are distributed to terminals as new ideas are inputted.
